SEQUENCE LISTING (100 sequences)

SEQ ID NO: 1 - DNA, 426 bp, Streptomyces microflavus
  misc_feature (1)..(426): orf4251; Methyltransferase domain family; GouA
gtgatcccctactccacgttccagttactccggaccgtcgaggaccgggagcgagcactgacggaagccgtacgcgccatgaggccaggtgccacagtccacatcgatgtcagcagcaacttcgacctgcgggagagcagcgactggcagcgggtactgtccgccccctgcgaagaagtgagcaggcagcccgtcgaggaatgggaacgaacaaggtcccacccagaccacatcctcatcgacaaaaccttccgaacagacagaagcgttctcctccggttcacggagcattggacccacctgcgggcactcgatctcgaagccgctctactgcgtgccgggttgattctggaacaggtcgaccacggctacggcgggggcgcatcaccccaccgccggatctaccacgcccgccgacctctctga

SEQ ID NO: 2 - protein, 141 aa, Streptomyces microflavus
  MISC_FEATURE (1)..(141): orf4251; Methyltransferase domain family; GouA
MIPYSTFQLLRTVEDRERALTEAVRAMRPGATVHIDVSSNFDLRESSDWQRVLSAPCEEVSRQPVEEWERTRSHPDHILIDKTFRTDRSVLLRFTEHWTHLRALDLEAALLRAGLILEQVDHGYGGGASPHRRIYHARRPL

SEQ ID NO: 3 - DNA, 462 bp, Streptomyces microflavus
  misc_feature (1)..(462): orf4252; major facilitator transporter; GouB
gtggcgggcctggccaacgcgtgtttcgccctggcggcgatcggcagtggagtgctcgtctccggaggatcgctgggcaactgggtgcgcagccacacaccaggagtcctcatcgccggtttcgctgtgcagacggtgttcggacttaccgcgagtcagaccgtcttagccgttgccctctacacgctggtcggtgtgctcagcggcggggacaccgtgctgcagagcgaggtgcaggatcgctggcgaagtgtcgggtcctcccaggcgttcgccattttcggtgcggtgtccggaccttcccaactggtcggctccttggtcatcgcttttctgctcctgcacttctcgatcaccgctgtctacgtcggaacgattgtgattctgggattcggttcggcgctccttctggtcatggcgagagcgaagtcgatcaatcccgtggaagaagtcgtcccgtaa

SEQ ID NO: 4 - protein, 153 aa, Streptomyces microflavus
  MISC_FEATURE (1)..(153): orf4252; major facilitator transporter; GouB
MAGLANACFALAAIGSGVLVSGGSLGNWVRSHTPGVLIAGFAVQTVFGLTASQTVLAVALYTLVGVLSGGDTVLQSEVQDRWRSVGSSQAFAIFGAVSGPSQLVGSLVIAFLLLHFSITAVYVGTIVILGFGSALLLVMARAKSINPVEEVVP

SEQ ID NO: 5 - DNA, 516 bp, Streptomyces microflavus
  misc_feature (1)..(516): orf4253; 3-hydroxyisobutyrate dehydrogenase; GouC
gtgcgggacctgcacacccggatgcgggacacccacggacacacgctggtggatgccgcgctcagccgccgcggcggtgttgtgcgcgagggttcgctgtccctgttcgtcggggcaggagacgaggccttcgccgtagcccggccggtcttcgaccgctacgccgacaacgtcgtccacgccggagacgtcggtgccggcatgacggtcaagctttgcaacaactggctgctctacgcgaaccggcactccgcactccaggccatccgaacgggccgtcagctcggcgtggatccggctgtgctcacggacgcgctcgcctcttccaccggatccagctgggcactgtcccactactccgacctggacgaagccatcgtcaccgggcggggcgcaccagcggtcatccgggacaggacagcttcggagcttggcatggcgaagcagatggcggcacaggacggtgaggtgcccaccagcctccaggagaccttcgcccttctggacgtgatgtag

SEQ ID NO: 6 - protein, 171 aa, Streptomyces microflavus
  MISC_FEATURE (1)..(171): orf4253; 3-hydroxyisobutyrate dehydrogenase; GouC
MRDLHTRMRDTHGHTLVDAALSRRGGVVREGSLSLFVGAGDEAFAVARPVFDRYADNVVHAGDVGAGMTVKLCNNWLLYANRHSALQAIRTGRQLGVDPAVLTDALASSTGSSWALSHYSDLDEAIVTGRGAPAVIRDRTASELGMAKQMAAQDGEVPTSLQETFALLDVM

SEQ ID NO: 7 - DNA, 357 bp, Streptomyces microflavus
  misc_feature (1)..(357): orf4254; hypothetical protein
gtgacggtcccgcaggacgaacgcctgtccgcgcaggacgccttcggcgtccaccgccgcgagacagcggaccgccccttcagagcggcggaggcgcagtccggcggctctccgttccgccacagccgcctcggactggccaacgacggcgcgagcgaagtcgaactcacacggatctgcggcctccacacgcagagcgcgccccgcagcccgcagatggttgcggacggtggggctgtaaccccctcgggggtcacagccctcacgtatgtccagcatgcgggtgtgtcggcacgccacgtctccacccacctcagcgagtgcagctacttcgccgaaacacggatccatgggtaa

SEQ ID NO: 8 - protein, 118 aa, Streptomyces microflavus
  MISC_FEATURE (1)..(118): orf4254; hypothetical protein
MTVPQDERLSAQDAFGVHRRETADRPFRAAEAQSGGSPFRHSRLGLANDGASEVELTRICGLHTQSAPRSPQMVADGGAVTPSGVTALTYVQHAGVSARHVSTHLSECSYFAETRIHG

SEQ ID NO: 9 - DNA, 141 bp, Streptomyces microflavus
  misc_feature (1)..(141): orf4255; CoA-binding domain-containing protein; GouD
gtgaactctttcgattttgaaggaagtgtcgttccgggcatcgaccgcttcatggctggcttcggcgctcaggccgtcggttacgggcagttccgctggcaacaggattggcgggaagaccctgccgggaggttcgggtga

SEQ ID NO: 10 - protein, 46 aa, Streptomyces microflavus
  MISC_FEATURE (1)..(46): orf4255; CoA-binding domain-containing protein; GouD
MNSFDFEGSVVPGIDRFMAGFGAQAVGYGQFRWQQDWREDPAGRFG

SEQ ID NO: 11 - DNA, 915 bp, Streptomyces microflavus
  misc_feature (1)..(915): orf4256; hypothetical protein; GouE
gtgcagcagtcgcccgcgtacgcccgtgcggtcggcgagtcggggcggtacgtccttgtggtgatgggccaccggggggtgttcccgctgcagctcggctcggacgtgtgcacagcgctcggcggcgaccggccgctcctcgcggacggcaccggccccctgcccctggttcctctggtggccgcggccgcagaggccaccgggctccccgtctacctccctctggtggacgcttcgctcgccgaggcaggagttgtggaggcgttcagcgtgtgggagcggccacccaattcactgatcgactggtcgctcgacggcgccgacctatgggatcgcgtaaccgagcgcggtggttcacagtggagcaggaaacagcggctcatcgagcgggacggcctgattctgtccttcggccggtcgggcgaggcggccgccgaggaggtcctgcggatcgatgaccgctcgtggaagtctgcccacaggcagaacatgcgtgcgcgagagggccaggacaagttgtacgccgggctgatcgggtcaggggtgctcacggctacgttcctgcgggacggcgaccgctctgtcgccttccggcttgactcccgcgtcaaaggccgcctgacctgcttgaagtggtcgtatgacgagtcttaccggcgatactcacccggtgtccatttgctcacgcaggggctgcgccaggagtggtgcgggcgcggcatagaggtggtcgatctgcacgggagtcccgactcactgaaggacctgctgtgcaccgaccgggtgagccgcgtggacctctggtacggcgacccgctggccggcgcgcgccgtgcggccgagcggaccggcttcgacaggcggatgagggcggtccgtgacggtgggaaggggttacgccatgccttcgagtga

SEQ ID NO: 12 - protein, 304 aa, Streptomyces microflavus
  MISC_FEATURE (1)..(304): orf4256; hypothetical protein; GouE
MQQSPAYARAVGESGRYVLVVMGHRGVFPLQLGSDVCTALGGDRPLLADGTGPLPLVPLVAAAAEATGLPVYLPLVDASLAEAGVVEAFSVWERPPNSLIDWSLDGADLWDRVTERGGSQWSRKQRLIERDGLILSFGRSGEAAAEEVLRIDDRSWKSAHRQNMRAREGQDKLYAGLIGSGVLTATFLRDGDRSVAFRLDSRVKGRLTCLKWSYDESYRRYSPGVHLLTQGLRQEWCGRGIEVVDLHGSPDSLKDLLCTDRVSRVDLWYGDPLAGARRAAERTGFDRRMRAVRDGGKGLRHAFE

SEQ ID NO: 13 - DNA, 981 bp, Streptomyces microflavus
  misc_feature (1)..(981): orf4257; DegT/DnrJ/EryC1/StrS aminotransferase; GouF
gtggaacggcccgacagaggtgccacgggcttcgccggtcccgccgggtacgtcaccgtcggtgaagccgtcgcggaactgacccgtcgcatggcccagcccgcggtcgagttcaccgcctccggtaccgccgctctcgaagcggcactggaggtgctgggcatcggacggggcgatgaagtggttgtgcctgacgtgggatgtcactcggtggccgccgccgtcgtgcgacggggagcgatcccggtgttcacgggagtgggggaggccctgacgctcgatccccggggggtttccctggcctgcggcccacgcacccgcgctgtcgttgccgtgcatcagtacggactgccctgtgatgtgcccggcatcatggaggcggtggggccggacatcccggtgatcgaggatgtcgcccagacgtgggggtcggcggtgggcggtgccccggcggggtcgctcgggaccatcgccgtcatttctttcggttcgaccaagccggtggcgctcggcgcgggcggggcgctcttcgggccggcctcactgatcggcggagcggtctcccgcggcgatggagcggaccggcagctgcttcgccctcccagcgccgctcggttccccgcccccctgctcgcccatcttcccaaagccttggaaagggctgaccggctgctggccttgcgtcgggcagcggtggaaacctttctccgtgggccgctggcccaggagttacgtctgcctccgacgccacccggctcctcctccggatggacccgcacccctctgtatccgatcgcccccgcgacctcggtcacggccgaacacatggagcggctggaggcgtgtcacggcccggttcagcgcatgcacgcgacgccgccgtcggcgctgccgatgttccgcggaagcacaacgcgtgtgacaggcggcggccgtcggctcaccgaacccctactcgtgaagatgggatcaccacgatga

SEQ ID NO: 14 - protein, 326 aa, Streptomyces microflavus
  MISC_FEATURE (1)..(326): orf4257; DegT/DnrJ/EryC1/StrS aminotransferase; GouF
MERPDRGATGFAGPAGYVTVGEAVAELTRRMAQPAVEFTASGTAALEAALEVLGIGRGDEVVVPDVGCHSVAAAVVRRGAIPVFTGVGEALTLDPRGVSLACGPRTRAVVAVHQYGLPCDVPGIMEAVGPDIPVIEDVAQTWGSAVGGAPAGSLGTIAVISFGSTKPVALGAGGALFGPASLIGGAVSRGDGADRQLLRPPSAARFPAPLLAHLPKALERADRLLALRRAAVETFLRGPLAQELRLPPTPPGSSSGWTRTPLYPIAPATSVTAEHMERLEACHGPVQRMHATPPSALPMFRGSTTRVTGGGRRLTEPLLVKMGSPR

SEQ ID NO: 15 - DNA, 1194 bp, Streptomyces microflavus
  misc_feature (1)..(1194): orf4258; DegT/DnrJ/EryC1/StrS aminotransferase, cytosinine-like synthase; GouG
atgactgcaaggaacctgacgacccgagcgggcgtcatcaaccctcaccagctcttcgacctttctcaggaggacatcgactccttcagccacctgaagagcgtgctcgccgacggacagctcttccgctacgtcgagagcgaccgggaatcggcgaacaccttggtcgaacggcacttcgccgagcacttccgcaaggagagggcagtggccgtggccaacggcaccgtaggcctgcgcctggccctgcgtgcgctgggcatcggccccggtcaccgagtggcggtcaatgcctacgctttcatcgcatgtgccatggcgatatcagcgaccggcgccgagccggtgccggtcgacatgggcggatccgtcctgagcatggacgccgacgctctggagaagggcgtgggccacctcgatgcggtcctcctggtgcacgtccagggccacgccgtcgcggccggtccgatacgtgccgtctgcgaccggctcggcataccgatgatcgaggacgtgtgccaggcgctgggagctggttcgtcagaggcgggcgccggcggcgtaggtgacgtcgctgtgacgagtttccaacaggccaagcagatctcctcgggtgaaggcggactcgtcgccgggcccgaggaggtgatcgaacgggtctaccgcctgtcggatctgggcgccgtgcgccaggagaacggtctgccggactgggaccacgaggatgccctgatcggtgacaacctgcggatgactgagcttcaggccgcccttgtcatggatcaggcagtgcggctggagaacacgcttgcccggcaacgggaccagcggtcacggctgcgggccgggctcagtgatatccccgttatcgagagcgagaacccggccgaggacaccggatcgcacacgcttgtcctggcccgggacaccacggcggcggaggagttccgcgttgagctcgcacgccgcggggtgctggcccgaccggtctggaagaagagctgggtggaatacggtttgtaccgacgggagttcgcgagcggcgcccctgccggcccgtggcccgggaaggctgtcggcctcgcctcgcggattctgagtattcccacttcgaaatatgtgacggactccgccgtcgcccaagtggcccaggccatcgcggcgggccgccaccacctcacacaggacaggtga

SEQ ID NO: 16 - protein, 397 aa, Streptomyces microflavus
  MISC_FEATURE (1)..(397): orf4258; DegT/DnrJ/EryC1/StrS aminotransferase, cytosinine-like synthase; GouG
MTARNLTTRAGVINPHQLFDLSQEDIDSFSHLKSVLADGQLFRYVESDRESANTLVERHFAEHFRKERAVAVANGTVGLRLALRALGIGPGHRVAVNAYAFIACAMAISATGAEPVPVDMGGSVLSMDADALEKGVGHLDAVLLVHVQGHAVAAGPIRAVCDRLGIPMIEDVCQALGAGSSEAGAGGVGDVAVTSFQQAKQISSGEGGLVAGPEEVIERVYRLSDLGAVRQENGLPDWDHEDALIGDNLRMTELQAALVMDQAVRLENTLARQRDQRSRLRAGLSDIPVIESENPAEDTGSHTLVLARDTTAAEEFRVELARRGVLARPVWKKSWVEYGLYRREFASGAPAGPWPGKAVGLASRILSIPTSKYVTDSAVAQVAQAIAAGRHHLTQDR

SEQ ID NO: 17 - DNA, 1137 bp, Streptomyces microflavus
  misc_feature (1)..(1137): orf4259; phosphoglycerate mutase; GouH
atgtcatccttcgcgctcctgctccgcggcctgccgaactccggcaagacgaccactgccgcgctgcttcgcaacgccttgaagccgtccgttcggatctccaacgactcggtgcgctacatggcacagccccgggatttcagcgacttcactctcgtcgcctccgagctcggctgcctggatctcgcctcttcatacctggagagcggcttcgtacccgtgatcgacggcgtgttcgaggacatcgacttcctgtccgcgcagaagttgcgcttccacaggaaaggtatgcggctgatcgtcatcaccctggagggaagtctttccgatctgctcgaccgaaacgcctcccgcgatccgctggcccggatggaggaggaccggatgcgagagctccacgcccagttccggccgagcggactcgtcctgtccctcgacgggaaacagcccgaagaggtggcggacgacgtattggacctcctggaattgcagcccccgtaccaggccgaggcagctgacccgggagcggccgacattctcttcctgcgccacggtgctcccgagtaccccagtgacgtctaccccgatccctatgcgatggggctgtccgagcaaggctttgacgaggcccgcgtggcgcgtgccgctgtggagcggttcgcgcccgagatcgtctacacgtccgacttccgtcgtgcggagcaaactgcctcgctggtgaccgccacgatcgatgtcacgccccagcccgaacaccgtctgcgggagcgagtcttccatcagctcgccggcgtagagctcgaagaggtccgctcacagctgggggctgaggcggatgcggtcctcgggggcaacagcgatctgtgcgagcgtgaggaggaggaatcctacgaggctgcaagagcccgggtgctcgcctttttcgatgagatggccgagcggcacgccggccggcgggtcctggtcgtcggccacggcggacctcacgcatggctggtggagcgggcgcttggcgccgagatgcgaggagtgcgccgcatgcgctgggacacgggtcacttctcgcggttcaaggtgacgcccaaccaggtctcactggactacctcaacaggtcaccggaagacgtcaccccatga

SEQ ID NO: 18 - protein, 378 aa, Streptomyces microflavus
  MISC_FEATURE (1)..(378): orf4259; phosphoglycerate mutase; GouH
MSSFALLLRGLPNSGKTTTAALLRNALKPSVRISNDSVRYMAQPRDFSDFTLVASELGCLDLASSYLESGFVPVIDGVFEDIDFLSAQKLRFHRKGMRLIVITLEGSLSDLLDRNASRDPLARMEEDRMRELHAQFRPSGLVLSLDGKQPEEVADDVLDLLELQPPYQAEAADPGAADILFLRHGAPEYPSDVYPDPYAMGLSEQGFDEARVARAAVERFAPEIVYTSDFRRAEQTASLVTATIDVTPQPEHRLRERVFHQLAGVELEEVRSQLGAEADAVLGGNSDLCEREEEESYEAARARVLAFFDEMAERHAGRRVLVVGHGGPHAWLVERALGAEMRGVRRMRWDTGHFSRFKVTPNQVSLDYLNRSPEDVTP

SEQ ID NO: 19 - DNA, 120 bp, Streptomyces microflavus
  misc_feature (1)..(120): orf4260; hypothetical protein
atgctgtacgccttcgaggcaggaccgaagccgaagggggtggccaccacggcgacccgtggccgtcgtcgtggatccgaagcggtcgtggtcgcgtcctttgcgttagtcatggggtga

SEQ ID NO: 20 - protein, 39 aa, Streptomyces microflavus
  MISC_FEATURE (1)..(39): orf4260; hypothetical protein
MLYAFEAGPKPKGVATTATRGRRRGSEAVVVASFALVMG

SEQ ID NO: 21 - DNA, 1116 bp, Streptomyces microflavus
  misc_feature (1)..(1116): orf4261; cytosylglucuronic acid synthase; GouI
gtggccacccccttcggcttcggtcctgcctcgaaggcgtacagcatcggcgaagtcctgcacacccattggggtgtggacgtccagtactacggaacggactccgcccgcgacttcttctccgcgcagcccgatgtgaggcccctggcgccggaggcagtcggtgacaccggagcgatcgacgccgtactgaacgtgctggctccggatctgatccgaagttccgaggaggcagcccggacgtactacgtcgacagcctcggcttcatgtggcagccctcggacattccggacggcagtctgctcaaaagggtgcaccggtacttcgcccaggacatctttggcagcgctgaccatctcactgcgctggggatcaccggagtgacccccgtctcgggaatcgtcgccgaaacagcgccgaccgacatgtcaccgcggccacgctccgtgaaacggctgctcgtccaactcggtggtctgagtaacccggccggccggtcgtccggagaggtttatctcgcactcgccgcgagactactcacggcactgcagcaggacccgtacgaactgagcattgccatgaaccgcgcaggcggcacgttctccctgggatcgctcgaccaggcccgccaattgtccggccgcgacttccacgttgaactggccacctgcgccggtgtcctcagctcacccggtatgaccacgctcattgaggtgtcgcgtgccaagtgcccctatgttccattaccgcctcagaactggagccaggtagtcatatcacgctatatggcgcgaaattcacgcttggggatatgggactttctgatcggtccgtacgccacggtggacgctcatgtccccgaggctcagaaggccgcccaggtgggggagatcaaccagctgctggcaaggaacgccggctacacgacggcctatgtggacctggcccggacggcactggccgaagctcgagtaccggacgtgggcgcaccgttcgacggggcgcgcgtcgtggccgctgccattgcagacgatctcaccaagggaaaatcgcgttacggacggggctcgcatacggatttgaaagaccacggcacaccgactggtgaactctga

SEQ ID NO: 22 - protein, 371 aa, Streptomyces microflavus
  MISC_FEATURE (1)..(371): orf4261; cytosylglucuronic acid synthase; GouI
MATPFGFGPASKAYSIGEVLHTHWGVDVQYYGTDSARDFFSAQPDVRPLAPEAVGDTGAIDAVLNVLAPDLIRSSEEAARTYYVDSLGFMWQPSDIPDGSLLKRVHRYFAQDIFGSADHLTALGITGVTPVSGIVAETAPTDMSPRPRSVKRLLVQLGGLSNPAGRSSGEVYLALAARLLTALQQDPYELSIAMNRAGGTFSLGSLDQARQLSGRDFHVELATCAGVLSSPGMTTLIEVSRAKCPYVPLPPQNWSQVVISRYMARNSRLGIWDFLIGPYATVDAHVPEAQKAAQVGEINQLLARNAGYTTAYVDLARTALAEARVPDVGAPFDGARVVAAAIADDLTKGKSRYGRGSHTDLKDHGTPTGEL

SEQ ID NO: 23 - DNA, 714 bp, Streptomyces microflavus
  misc_feature (1)..(714): orf4262; hypothetical protein; GouJ
atgacgcagcagatcgacaacggcctcgtggccgtacttcagtcgctcgcgcacgaggtggaaaccgcgcgcgagtggagccaggtatcgcggacgctggcacaggagcgggtggccaccgtcttcggctcggcccgtacgcgccgcggtgaaccggcatacaacctggcgtatgaactcgccacggcactggccgcagggaagtggaccacgattaccggcggtggacccggcatcatgcaggccgcgcgggacggcagtggggagggcttgtcccgagcggtgcgggtggagatccccggtgaggaacccgacaccgtgctggacccgtccaggtccataaccgtcgcaaccttcgcgctgcgcaaattactcctgacccacgacatcgacgctctgttcgtcttccccgggggtgtcggcaccttcgacgagctgtacgaggtgctggtccaccaggacaccaaccgacttgcctggttcccggttgtcctgatgcagccggccggcgagagcctctggtcggcctggctggagttcatggagaagcacttggtcagcacgggactggccagctcctccgtgatcaagaggctggttgtggccgagtcggtggaagaggccctggcagccgccgaggggccccgcgcgacggcctacggaacgagcggttctccgtcgcccggaacaggtcacggggcgaccggaaagtga

SEQ ID NO: 24 - protein, 237 aa, Streptomyces microflavus
  MISC_FEATURE (1)..(237): orf4262; hypothetical protein; GouJ
MTQQIDNGLVAVLQSLAHEVETAREWSQVSRTLAQERVATVFGSARTRRGEPAYNLAYELATALAAGKWTTITGGGPGIMQAARDGSGEGLSRAVRVEIPGEEPDTVLDPSRSITVATFALRKLLLTHDIDALFVFPGGVGTFDELYEVLVHQDTNRLAWFPVVLMQPAGESLWSAWLEFMEKHLVSTGLASSSVIKRLVVAESVEEALAAAEGPRATAYGTSGSPSPGTGHGATGK

SEQ ID NO: 25 - DNA, 636 bp, Streptomyces microflavus
  misc_feature (1)..(636): orf4263; glycosyltransferase; GouK
gtggtgacgctcgacgccgaccaagtggtggagccgctcttccttgccgaacacgcccggctgcacgcaggcggccccggccgcgtcgttgcaggccagcgtctccaactcgccgaggggccaatgaacgaggctcgcttggagcacgggttcgacccgcaggccctcccaccggtggtccggggcgacgagcgggagcagctgtttcgtctcctcgacagctccctagaggacatggtgaccggctggcaccacgtctggacctgcaacgcctccttcccccgggacaggctcgaggcggtcgggggcttcgacgagacgttcaccggctgggggctggaggacgcggaactcgcctatcggctggttcaaggtggtgcaaccacgcacttcgccccgtcggcggtggtccgccacgagcaccgcacaccggttacagccgacatgtaccgggagtggtgccgcaacttggcctacttcgtgcgccgacatcccgcaccagaggtacggctccaggagatattcgctcccgccatcgatcccgaccggtccgcgccgggaacgtgggacgacatcgccgccgagttcgagcacacggctcgacggctcggcgctgaccccggccagcatccgtag

SEQ ID NO: 26 - protein, 211 aa, Streptomyces microflavus
  MISC_FEATURE (1)..(211): orf4263; glycosyltransferase; GouK
MVTLDADQVVEPLFLAEHARLHAGGPGRVVAGQRLQLAEGPMNEARLEHGFDPQALPPVVRGDEREQLFRLLDSSLEDMVTGWHHVWTCNASFPRDRLEAVGGFDETFTGWGLEDAELAYRLVQGGATTHFAPSAVVRHEHRTPVTADMYREWCRNLAYFVRRHPAPEVRLQEIFAPAIDPDRSAPGTWDDIAAEFEHTARRLGADPGQHP

SEQ ID NO: 27 - DNA, 1341 bp, Streptomyces microflavus
  misc_feature (1)..(1341): orf4264; hypothetical protein; GouL
atgcccacccctgcgggaaacgtccccgaccatctcgccccgaccgtccgccgggtcgtctatctgcctgtcaaccgccccttcgagacagcatttcactccgtggccgccgaagtggcatcgttggagaagaaccagcgagacaacgtcaccctcctcgtcgtggacgactgtgcgccaccagtgtcacgggccaatcgccaggtgaccgagcgggtagcccgtgaatcgggcctgcgcgtacacacactggaccaacaagactggcttcgtctggccaccacagtgatcgcagcttccgggctgaccggggccgaccgagccacggcgcggaccgccctggtcaaacccaccggttcctacggggcaggtcccaacaaggccgccctggtcgccgcgctggaaggtgcagtctccctgcatcgccgggacagcgaccaggtcacgacggtagaccccgacaccggagcctccccgctccgcctggaagccgacctcctgggtcgcgcccgcccggagggcggcgccgcggcctactgcgcaggctccttcctcaccggtcgccccacgcgagaccgaagggacctggaacgcgactcgacggagtacgcggcccgtatcgacgcactgagccaactcccctccgccccggcccgacgcccgcctctcccgcctgtccgggaacggacggaactcctaggagggcagcacgccgagcgtgacctgacaggtgtggtcgagatggggatcgcggccatgcgaagcgtgtacgagtggatcccagaaatgcccgccgtgggcatcctcggcagcgactacttccagaagggactgctctatcagctcaacctcccggtcttccaccacagcctcccagcccggcacacctacgaatcctggcgcacggagcagtgcgacgattcccatctggcctggtacgtccgggcggaggtgcgctacgccgtactgcgccgccactggaacagcttcaaccacctgctcgtgggccaacggacgcgcgtgctgtccgatggtcacttcgactcccgggcttacggtcagctgttcgtcgaagcgctccacgagggcacccggggggcggaaagcattcccgacgacttcgcggccgtataccgcgacgccgcgaacgcggccacaggcgaggtccgtcgacgtcttctggtgcggctggccgcactggaagaggagaccgatgctgtcaacgcatacgtggccgatgccatccacgaattcgccgccctctcacgtctgtggcccggattgatctctgccgcacaacgggtcgggaggacaaccgcgctggagacgtttacccactga

SEQ ID NO: 28 - protein, 446 aa, Streptomyces microflavus
  MISC_FEATURE (1)..(446): orf4264; hypothetical protein; GouL
MPTPAGNVPDHLAPTVRRVVYLPVNRPFETAFHSVAAEVASLEKNQRDNVTLLVVDDCAPPVSRANRQVTERVARESGLRVHTLDQQDWLRLATTVIAASGLTGADRATARTALVKPTGSYGAGPNKAALVAALEGAVSLHRRDSDQVTTVDPDTGASPLRLEADLLGRARPEGGAAAYCAGSFLTGRPTRDRRDLERDSTEYAARIDALSQLPSAPARRPPLPPVRERTELLGGQHAERDLTGVVEMGIAAMRSVYEWIPEMPAVGILGSDYFQKGLLYQLNLPVFHHSLPARHTYESWRTEQCDDSHLAWYVRAEVRYAVLRRHWNSFNHLLVGQRTRVLSDGHFDSRAYGQLFVEALHEGTRGAESIPDDFAAVYRDAANAATGEVRRRLLVRLAALEEETDAVNAYVADAIHEFAALSRLWPGLISAAQRVGRTTALETFTH

SEQ ID NO: 29 - DNA, 1764 bp, Streptomyces microflavus
  misc_feature (1)..(1764): orf4265; similarity to asparagine synthase; GouM
atgtgcggcatcggaggcatcgtcctgaagcagcgttcccgggtcgacagaaaccacatgatggaacgcctacgcgccggtctcgcccaccgcgggcgaagctcgcagggagacttcgccgacacccgcgcagccttgcactgcgcacggcacgctgtcatcgccgtcgaagccgcccaacagccgctacgggactcccggaacgaactggtgatggtcggcaacggcgagatcctgaactaccaggaactggcacagcagcttcccgccgcgcgaacacgccgcctgctgccaggagacctccaggtcgcgctcgaaatgtacgccgagcacgggatcggcgccctggagaagctgcgcggcccgttcgcggtcgccttgtgggacagccagtcgggcgagctgaccctcgcgcgtgaccggttaggagagcgccccctctacttcttcgactgtcccgactttttcgccttcgcatcggaggtacggtgcctcgccgcagctcttccgcaaggcctgctgaacctggacgaagaagcggcggtagccttcctggggctgggacgagtgcctacgggccgaaccctctaccgggagattttcgcggtcccggcgggctcagtgctccgaatggggactcagccgttcgagccccggcacatggcgtccctggctcctgtctcggcactgcgcagcgcgccggccccgcaggaggagatcgacgccgttctcgcccaggcccaacgccgggcgctggtggcggaccaccccgtagctgtgggattctccggcggcatggattctgcagcagtcctgtcagcggccctggacggagcgggtgccgccgcagtcatcacggtctactccgaactgtcgccagtcaccgatgtgaacctccggcgcgcgcggagtcttgcgccccttctgggcgtccaactgaccgaggtcccgttccgaatgcccacggtccagggcgccgtggatattctgaactcgacactcgacggcccagccgctgagcccctggtgctgcacaacgacgccctgcatactgcggcccgggagcactccgccgtcgtggtcggagggcacggagccgatgaagtcttcggagggtacgcccggtatccggcgctacgagcccaggagaccgcgccgacgaagcactggctcgcgtcgtccgcctgggagcggtggaatcgatcggccgcctggcaccggttcgtcgaggaaaacgccgcgccgcacctggcggatcgcgtatcggcgtcctttcccgatccgctagaaaagaccttcccctacgcatggtcggaatcgagcgaccccgtgctcttcggccaggctctcgatatgttccggctgatgacctacgacaacttccgagctacggacgagaacggcatggcacgacaggtggaggtcagatctcccttcttcgacctcgacctgctggctgccgtctacagtctcccggtgactgagcgcctcggaccaggggcctccaagccgctgttgcggcgttcgttccgaaataccccgctggcaggagcattcaccgaaccgaaggtaggcttcgacgatcatttctcctatgccgactggatgacagagaactggctccagttctcaaccgccatcaccgacgggccactcaaagggacgggcatcctgcaggacggcgccctggacgatctggagcatcgcgactggcgcacactgtggcgccttttcagtctgtccgcctggctgaggcgcagttga

SEQ ID NO: 30 - protein, 587 aa, Streptomyces microflavus
  MISC_FEATURE (1)..(587): orf4265; similarity to asparagine synthase; GouM
MCGIGGIVLKQRSRVDRNHMMERLRAGLAHRGRSSQGDFADTRAALHCARHAVIAVEAAQQPLRDSRNELVMVGNGEILNYQELAQQLPAARTRRLLPGDLQVALEMYAEHGIGALEKLRGPFAVALWDSQSGELTLARDRLGERPLYFFDCPDFFAFASEVRCLAAALPQGLLNLDEEAAVAFLGLGRVPTGRTLYREIFAVPAGSVLRMGTQPFEPRHMASLAPVSALRSAPAPQEEIDAVLAQAQRRALVADHPVAVGFSGGMDSAAVLSAALDGAGAAAVITVYSELSPVTDVNLRRARSLAPLLGVQLTEVPFRMPTVQGAVDILNSTLDGPAAEPLVLHNDALHTAAREHSAVVVGGHGADEVFGGYARYPALRAQETAPTKHWLASSAWGRWNRSAAWHRFVEENAAPHLADRVSASFPDPLEKTFPYAWSESSDPVLFGQALDMFRLMTYDNFRATDENGMARQVEVRSPFFDLDLLAAVYSLPVTERLGPGASKPLLRRSFRNTPLAGAFTEPKVGFDDHFSYADWMTENWLQFSTAITDGPLKGTGILQDGALDDLEHRDWRTLWRLFSLSAWLRRS

SEQ ID NO: 31 - DNA, 114 bp, Streptomyces microflavus
  misc_feature (1)..(114): orf4266; hypothetical protein
gtggacgaggtggaggaagacattggcggtgatgtcgacgtcgtcggccgtgctcggcccaccctcgctaccaagggctccggcgagaactacacggtcaacgacaactcgtag

SEQ ID NO: 32 - protein, 37 aa, Streptomyces microflavus
  MISC_FEATURE (1)..(37): orf4266; hypothetical protein
MDEVEEDIGGDVDVVGRARPTLATKGSGENYTVNDNS

SEQ ID NO: 33 - DNA, 405 bp, Streptomyces microflavus
  misc_feature (1)..(405): orf4267; hypothetical protein
atgtacgagggcggtcttttgcctctgggagcaaagtccgacagctgggtcagttgggaagctgactgttggctgagtcctcagccgttcgacggcaccgccctacgcaagctcgaccggcctttcccgcttgtagaggaatggcagtgggagtacgagtactacgaccacgccctccactcagcgccgctgcacgagatctaccagcacggctccgtgctgctgggcagtgatcaacctggcgactactggacgttggtggtgactggcccgcagcgcggcaaggtgtggtggctcagagacggatgcgccacaccctattcttcgtccggagaacttggagtcggcttcctggactgggtgagggactggcacctcggacagggctgttggcgctccgagtag

SEQ ID NO: 34 - protein, 134 aa, Streptomyces microflavus
  MISC_FEATURE (1)..(134): orf4267; hypothetical protein
MYEGGLLPLGAKSDSWVSWEADCWLSPQPFDGTALRKLDRPFPLVEEWQWEYEYYDHALHSAPLHEIYQHGSVLLGSDQPGDYWTLVVTGPQRGKVWWLRDGCATPYSSSGELGVGFLDWVRDWHLGQGCWRSE

SEQ ID NO: 35 - DNA, 1281 bp, Streptomyces microflavus
  misc_feature (1)..(1281): orf4268; hypothetical protein;+
atgtccgaccaaggaacacacaagctcagcacgaaggccgtgaggatgagtctgtcgcatcacgtcgcccggggggatccgtttgcgggactgtcacgcttccgggatgagttctattcctgtctgaccaggcgtgcggacgcgctgttcgaactcgcggacgcggtgttgtgcgcggacggtccggtccggtcgctggtggaactgtcgctggtcggtgaacaccgtcgcgggcacggcgggctctacgatgccctgtccgcaggccgggtcgatgtcgcccgactgcggcgggccctggccatggtgcggctgcctcgggcggccgacggacggctggtcctggccgccgatctcacctgctggctgcgacccgacgcgcacacctcaccgcagcggatcctgtgccacacctacgggcggggcaaggaccagcacattcccgttcccggctggccctactcggtgatctgcgcacttgagacgggccgtaattcctggaccgcgccgctggacgcactacgtctggcgccgggcgacgacgccgccaccgtcaccgccaggcaggcacgcgagctcgtcgagcggctgatcgatgccgggcagtggacggacggcgatcccgagatcctgatcgtcgtggacgccggctacgacgttccccgcctggccttcctcctgaaggatcttccggtgcaggtgctgggccgaatgcgctcggaccgcgtcctgcgacgcggggtcccaccccgcgagcccggtgtccggggccgcccaccacgccacggcggggagttcgtcttcggtgacccggccacctggaacactcccgacgcacagacggtgaccgcgacacgtctctacggcaccgccgtcgcacgggcatgggaccggctccacccgagactgacccaccgctcggcctggaccgcccagctagtgccgcatcaagcaacgtttgccctgtcaggccgacatactgtgggcgtgcttgagtacttgcttgcgaccgatgacgacgatttcctcgggccggtgcgctcggataggtgtccggatgtgcttcagccaaggggctggggggcggtgccagtggctggcgatggccactatcggatcgctgtcgaaggcatggagattgagttcgcttgggaaatgcccggccttcaggtcacggttcacggcatatcagacgagcccagggttgaggagctggtggctacgatcgcgcgtcaggtcggaaccgagctcgcggtgcgagtccgggtaatcccgctctag

SEQ ID NO: 36 - protein, 426 aa, Streptomyces microflavus
  MISC_FEATURE (1)..(426): orf4268; hypothetical protein
MSDQGTHKLSTKAVRMSLSHHVARGDPFAGLSRFRDEFYSCLTRRADALFELADAVLCADGPVRSLVELSLVGEHRRGHGGLYDALSAGRVDVARLRRALAMVRLPRAADGRLVLAADLTCWLRPDAHTSPQRILCHTYGRGKDQHIPVPGWPYSVICALETGRNSWTAPLDALRLAPGDDAATVTARQARELVERLIDAGQWTDGDPEILIVVDAGYDVPRLAFLLKDLPVQVLGRMRSDRVLRRGVPPREPGVRGRPPRHGGEFVFGDPATWNTPDAQTVTATRLYGTAVARAWDRLHPRLTHRSAWTAQLVPHQATFALSGRHTVGVLEYLLATDDDDFLGPVRSDRCPDVLQPRGWGAVPVAGDGHYRIAVEGMEIEFAWEMPGLQVTVHGISDEPRVEELVATIARQVGTELAVRVRVIPL

SEQ ID NO: 37 - DNA, 1137 bp, Streptomyces microflavus
  misc_feature (1)..(1137): ORF4269; Mobile element; -
gtggctgaacgagtacgcgtccgtgagatcgatgacgatgaaggccggcggttgttgcggatcgtccgccgcggcacagggtcagtggtgacctggcgccgggcccagatggtgctgctgtccgcgcagagcatgcccgtggtgaagatcgccgaggtcgcgttcaccagtgcggaccgggtccgggacgtgatccacaatttcaaatccgacgggttcgcatcgctctacccgaagtacagaggcggccggccggagacgttcaccctgcccgagcgccgggagatcaagaagatcgccaagtccaagccagtcgagcacaatctgcccttctcgacctggagtctggtcaagctggccgacttcctagttgccgagggggtggtcgacgacatcagccacgagggcctgcgcatcctgctccgcgaggaaggcgtctcctttcaacgcgtgaaaacctggaagacctcgaaagacccggactacgcgcagaagaaggcccgtgtcgagcatctctacgccatcgccgacggcgaggtcatacccgaggacggcgagcccgagatcatcttctgcatggacgaattcggcccgctcaacctccagccccaccccggacgccagtgggccgaacgcagtggccggcacaagaaccccgaccgagccccccggccacggcggcgggcgacctacacccgcccgcatggggtccggcacctgttcgccgcctacgacctgggcaaagaccagctctatggtcacatcaagaagaccaagaaccgctccaagtacctggagttctgccgctacctgcgctccttgcacccagcgaaggtgcggatcgccatcatctgcgacaactactccccgcacctgacgacgaagcggtgccaacgggtcgcgacgtgggcggacgcgaacaacgtcgagatcgcctacaccccaaccaacagctcctggctcaaccggatcgaggcccagttcaccgccgccctgcgctacttcaccctcgacggcaccgaccacgccagtcacaaggagcagggcagcatgatccgccgttacatcatctggagaaaccaccacactcatgaccagcaactacgaaccgtagtcaaccaagcccacgttgcctga

SEQ ID NO: 38 - protein, 378 aa, Streptomyces microflavus
  MISC_FEATURE (1)..(378): orf4269; Mobile element protein
MAERVRVREIDDDEGRRLLRIVRRGTGSVVTWRRAQMVLLSAQSMPVVKIAEVAFTSADRVRDVIHNFKSDGFASLYPKYRGGRPETFTLPERREIKKIAKSKPVEHNLPFSTWSLVKLADFLVAEGVVDDISHEGLRILLREEGVSFQRVKTWKTSKDPDYAQKKARVEHLYAIADGEVIPEDGEPEIIFCMDEFGPLNLQPHPGRQWAERSGRHKNPDRAPRPRRRATYTRPHGVRHLFAAYDLGKDQLYGHIKKTKNRSKYLEFCRYLRSLHPAKVRIAIICDNYSPHLTTKRCQRVATWADANNVEIAYTPTNSSWLNRIEAQFTAALRYFTLDGTDHASHKEQGSMIRRYIIWRNHHTHDQQLRTVVNQAHVA

SEQ ID NO: 39 - DNA, 564 bp, Streptomyces microflavus
  misc_feature (1)..(564): orf4270; Transcriptional regulator, MarR family; -
atggggaatccggcacaggagccgtgggagacgtcgcaggtcaagatgatggaagcactgcgggagtgggcgaccggcttcgccgagatcaacctgtacatgtcgcagtggatgcgactgccaggctcggacgccaacgccgtcggacagatcgtctgggcggcacagagcggcacccccctctcccctgccgcactctcccggcgtatcggaatgtccacaggatcaacagccgttctcctgaaccgcctcgaacgggcagggctggtggtccgcagccgcgagcaccaggaccgccgccgcgtcaccctgcggcccacacccgccgcctccgaacaggcacacgcattcatggccatcgccggaaccgagatcgcagcgaccctgcgccaggccaccgaggccgagctcagcaccgcgacctcagttctagatcggatgaacgatgccgcgaagcaggccatccagcgcctgcacaccgtcggcacccgcactccgcccgagaagcgaagctccatccctcagccgctaatgccgcatcagacaacgtttgccctgttgtga

SEQ ID NO: 40 - protein, 188 aa, Streptomyces microflavus
  MISC_FEATURE (1)..(188): orf4270; Transcriptional regulator, MarR family
MGNPAQEPWETSQVKMMEALREWATGFAEINLYMSQWMRLPGSDANAVGQIVWAAQSGTPLSPAALSRRIGMSTGSTAVLLNRLERAGLVVRSREHQDRRRVTLRPTPAASEQAHAFMAIAGTEIAATLRQATEAELSTATSVLDRMNDAAKQAIQRLHTVGTRTPXPEKRSSIPQPLMPHQTTFALL

SEQ ID NO: 41 - DNA, 1107 bp, Streptomyces microflavus
  misc_feature (1)..(1107): orf4271; monooxygenase; +; GouN
gtgatcgagcgcgcaccggagttccgcgatggcgggcagaacatcgacgtgcgcggcgtcgcgcgggaggttcttgtccgtatgggtctgttcgatgcggtcaaggcgcgcaacacgaccgagacgggcgccgtcatcgtggacgggaatggccaggcgattgcgaccctgccagacggcggaggcaccggggcgacggcggagctggagattctgcggggcgatctcgccggtgttctgcgcgatcacctccccgagggggtggagttcgtctacggcgacaccatcgaggacgtgagcgagcatgccgggcatgcccgcctgacgacggcgggcggccgggagctgcggtgcgatctgctggtgatcgccgaaggggtccgctccacgaccagggggcgcgtcttcgcccaagacaccgtcgaggagcgcgagctgggggtgacgatggtgttcggcacgatcccccgcgtgccgggtgacgacgaccgatggcgctggtacaacgcgcctggcgggcggcaggcccatctgcgcccggacccctacggcacgacgcggaccatcctgtcctacagccccggcgacgacctgctgtccatgagccgcaatgaggccttggcccaggtccggtcgcggtaccgcggcgcgggatgggagacatcacgcatccttgacgcgctggagacctcgcaggacgtctacatcgaccagctcgcgcagatccggatgaaaacttggcaccaaggacacgtcgtgatgctgggagacgccgcatggtgcgtgacccccatgggtggcggaggcgcttccctggcgctgaccagcgcgtacgttctggcggcacagctctccgcacattccggcgatctcgctgccgcgctggcggcatacgagcggtggatgcgcccgctcgtgcgggacgcgcagaacatgccgggctggctgacgcgtttcgcctacccccagagccgggcgggactggcgctgcgccacgtcgccgaccgcgtgttcacctccgcccccttccggcccctagctgcaaagctcacccaggtcgccgagactgaacggacgcttcccacgctccgcccgaccaccggataa

SEQ ID NO: 42 - protein, 368 aa, Streptomyces microflavus
  MISC_FEATURE (1)..(368): orf4271; monoxygenase; GouN
MIERAPEFRDGGQNIDVRGVAREVLVRMGLFDAVKARNTTETGAVIVDGNGQAIATLPDGGGTGATAELEILRGDLAGVLRDHLPEGVEFVYGDTIEDVSEHAGHARLTTAGGRELRCDLLVIAEGVRSTTRGRVFAQDTVEERELGVTMVFGTIPRVPGDDDRWRWYNAPGGRQAHLRPDPYGTTRTILSYSPGDDLLSMSRNEALAQVRSRYRGAGWETSRILDALETSQDVYIDQLAQIRMKTWHQGHVVMLGDAAWCVTPMGGGGASLALTSAYVLAAQLSAHSGDLAAALAAYERWMRPLVRDAQNMPGWLTRFAYPQSRAGLALRHVADRVFTSAPFRPLAAKLTQVAETERTLPTLRPTTG

SEQ ID NO: 43 - DNA, 24959 bp, Streptomyces microflavus
  misc_feature (1)..(21933): Genomic DNA sequence of gougerotin gene cluster plus some flanking sequences
atggtccccgcggaccgggacacgctggtccgccgctggtacgtgcgccagatccgtctggacagcgagggcacggtccgcccggaacggatcgagaccgaggccttcgcacggcccaccgacacctacgctcgcgtggagagcagtcggagaccggcatcgtcgcggccggcgtgatcggcttacctccgcgagcacttcccgcgatcttgatggatctcggcgttccggtcgacctccgcttacgcggagagcacacgatgaccatcttcggcctgctcgtgcgcttcggctcacctccgctcgcgcggagagcacgatccctgggtggtctccaccagcccctcggtcggctcacctccgctgacgcggaggtgtaccggacgcgggtgttctggagaaagacgctcaggtgtggtccttgccgaggcggggatggccccgcctgagatcacacctgagggctgtcccgtagtcctggtggatcagcgcgcggcgtcagatgcggggcatcgtaaggcgtaggggcgttcgcgtactggatgatttcgtgcgcggagaatgcggtgaggtgccgtagctgtcgtggtgcgcccgccaggggttacggggcagcccgaagggcttcgagcaggtgttcgtacgcccgcttcggccgcaggtccgtgtcccatggcagggaatcggccgtgcgcgggggatagatcttggtgtcgctggtggagccgtaccggtcggtgaatccccaggtggagaatgatgtgcagttcggctcctccaggcagactcgcagcttgcctgccatctcgacagcctgggtctctcgcccgtcctcctcgtcctcacctatggggacgtccatctccgacacccgcgcctgaaccccgagttccgccagatcctgcacatggctgcggaaggtctccggggcggtgcggtcgccgggtgtgtactcatggttctggaaaccgacgccgtcgatcggtacgccgcgttctttgagtcgtttgatcagatcgtagagggcgtcccatcgctcgccttcctcctcgaccccgtattcgttgaggaacagctctgccttcggatcggcccggtgggcggccctgaaggcctcgtcgatgtactcctcgcccatggcctcgtaccacgggctctgctcggatcgcagaccgaggttcccattggtgtagctcttctcgtcgtcggacatgggctcgttgaccacatcccattctgcgacttttcccttgaagtgccctgcgacggtggcgatgtgccggagcatggtccggcgtacctcctcggggtcgtcgtcctcccgcatccagttgggcagagcctcgtgccagacgagggtgtgcgcgtgaaccttcatgtcgtttgcgcgggcgaaacgtacgagtaggtccgcgtcgcggaagtcgtagacgccgcggcgtgggtggagaaactgtggcttgaacgcgttctccggagtgagcatggagaactggctccccgcgagcgcccggtaacgtgagtcggtgagcagcgggttctcagccagggcggttccgacgtcgaagggtcgttccacatctgcggcccgcgcacgcagcgtgtcgtcggactgcgcctggcgtagctggggggccttgatcacgcggagcgagtcaccgctctctggccgcgcgatcagttgggtcagacgccatccctcgcggcgctcgttttcgcccgcgtccgcctccagaccgaaccagacagcgccctcggcgaacaccccagggtcctgcacggttcctagctgccgcccgtcggcttttacgcggaatgtgtctccgatgctcgacacagcgagcgtcaccgtcccggagcagccgcagtcgaagtccttggaggtggccggctcatcgccctcgccgtcccatatctgcacccttactcgtccgtcggcggtcacgccgacgcggagtgagggccgctcctgcctccactcgtcgtagatgaccggtacgcgtccgtacagccgcagccatgagtcgccgtcatcgtcaccaacaccggacatgcgcgcggtgacggtgaagtcgccatcggatctgagatgcgggccggccagattcagcggggggttgggctggccgccggaggagtcctgctccacgatgtgccgatccgatgcgctgacccgcaggatgccgttctgtgcggtggtgcccggcatctgcgtccagttgtggttccgcagcaggtcttcgtcgcttctgccgccgatgctttcgccctgccccgtacaaccggccgccaccgccatgacgagcagcatggcgcccagtcggcgccacgtctccccactaagatccacggttccccactctcttgttcgagacgaggtcaacgtctcgaagctgggcagtagttcatcacggatgaggtatggctgccttgtggggcacgtcccagccagggactgtcaaatgagcggtgtaactcgggttgttgagggttactggcgtgctgcggagagtcggccgtcgaaggtgatatcgaaggcgttcagaacggttttccagcgcatggtccagcgggcttggcccttgccggtcgggtcgagcgacatgatcgccatgtagacgcacttcagggcagcctgttcgttcgggaagtgcccccgggctttcaccgcccggcggatcctggcgtagacggactcgatcgcgttggtggtgcagacgatgcggcggatctcggtgtcgaagcgcaggaacggggtgaactcctcccacgcgttctcccagagcctgacgatcgccggatacttcttgccccatgcgtcggcgaactccgcgaaccgatcgagggccgcgtcctcggtcgccgcggtgtagacgggcttgaggaccttggcgatcttgtcccagtcctggcgggcggcatagcggaaggagttccnnnnnnnnnnatggaccacgcatgtctgcacgacggtgcggggccagacggtctcgaccgcgtcaggaagccccttcagcccgtcgcagacgagcatgaggacgtcgctcacgccgcggttcttgatctcggtgaggatgtgcatccagtgcttggcgccctcgccgccgtcgccgacccacagcccgagaatgtcccgccggccctcgacggtgaccgccagggcgacgtagatgggccggttggcgaccgcgccgtcgcggatctttacgtggatggcgtcgatgaacaccaccggatagacggcgtccaggggccggttctgccattcggccatgccttcgaagaccttgtcggtgatcgtggagatcgtctggcgcgacacgtcggcgctatagacctcggccaggtgggcctggacctcgccggtgttcaggcccttggccgcgagtgagatgaccatctcgtcgacgccggacaaacgcttctggcgcttcttgacgatcttcggttcgaaggagccctcgcggtcgcggggcacggttatctccacagggcccacgtcggtcagtacggtcttggcgcgggtgccgttgcgggagttgccgccgttcttccccgccggatcgtgcgtgtcatagccgaggtggtcggtgctctcgccctcgagggccgactccaggagtcgtttggtcagctgctggagcagcccgccctcgccggtcagctgcaggccctccgcctgagcctggcccaccaactcgtcgatcagccggtcgtcaacagacttcgacggcaccgtctcagacggctcgacgggctcggccttggtcacgttgtttttggtcatcgatgcatcttccatgatcgggagttacaccgaacgttttacagtcccgcctctggcgctcccgcgacatcgcctcccgcttcggcgacatcaccgtggagaccatgtacagacatccctccagatgggccgagaccggcctcatccacaaacttggccccggcctctacgccgccacagcatggacccaaacaccccttgcgtgacctgcgaaaacgtcaactgaccggccttgggtcaaggcccgaaggctgctccggcgggtctggggaccaccaggagttcaccgcccggcagcctcgtcctggaggcggccgggattgaggacccgcgtccttccagccgtctccacccgctccagcggccgaagcgcggcgggctgctgacgtacgcgcgaccgggcgaaagcggtcacatctccgagatgaccggcccggggtcggctcccgcatcgatcttgcgaagtgtcttgtaggtgaggcgcaggtcagccgggcttgccaggtaaacggtccggtgcgcgatgcggccgatctgcggccccggctcccgagctgggcccgcaagtacttccagggaagcccggctcgctcgtacccgagaatgcctttggccggagtcgccttgtcgggtcggggagcgagggtctgggtgtctcggcagttggtcagagaggtcggcgggcgtggtagatccggcggtggggtgatgcgcccccgccgtagccgtggtcgacctgttccagaatcaacccggcacgcagtagagcggcttcgagatcgagtgcccgcaggtgggtccaatgctccgtgaaccggaggagaacgcttctgtctgttcggaaggttttgtcgatgaggatgtggtctgggtgggaccttgttcgttcccattcctcgacgggctgcctgctcacttcttcgcagggggcggacagtacccgctgccagtcgctgctctcccgcaggtcgaagttgctgctgacatcgatgtggactgtggcacctggcctcatggcgcgtacggcttccgtcagtgctcgctcccggtcctcgacggtccggagtaactggaacgtggagtaggggatcacgacctgatccgcagtccgggtcaggggaagccggcgcatgtcggcacacacagggtgcagtccaggcacgggtggcatacgtgccaagcgccatcgactcaggtctacggcgaccacccgggagcccgggcgagtggccagagggctggccactcgcccggttcccgcccccagcacgacgatattttgctgcgggggtaccaagttgagccagtactccaggtcaagcctctggttgcgcaacctgtgctggttgtgccagtcgtacagcaaggcttccaagtattgttcgcacatctctcctcgcctccttggttatccctggatttagccattctggccggaaggccgctgatttcgaaggtcggggtggtcctggtcgacggatcgactgtatgccacagagtggcgaagatggcgagatgtgttccgcgtaagtgccttatccagccacgtcggaatccatcattgatccgtggcgcgctaacgccgagtttcggccaacccgaacgatgaatgtgtgcgcggggatgatggggaaaggaagagcttggtcatgtgtcatcctgaacaacggtgctgaggggaggtgttcgagatggtggcgtcccatacagcgcggacgaggtcggagatctggaaggggtttccgttcagtactcgtcgcgagattggcacggtcgggatatcaacgttccagagtcagagcacttccgctcttatgcttctgctgctgtccgttctggtggtcgaggtgacgggttcggcggccagtgctcctttggtcatcgctgccggcgcactgcctgcgctgcttctggtgcgctgggttcggagtgtcaaccgtctcctggaccaccgctgggtgatgatcctctcggacacgggcgcttttgcagtcgcgctggctctcttcctgctatcgcaggccgacgtccaagcctggcaaatctactgcggcgtcgccttgttctccggcttcggtgccttctacctgcccgcaatgcgtggctgggtggccgaccagtcgggcgacatcacccaactcacctggctcaactcgatgctggccgtagctacgcaggcgtccgtcgtcgtcggatgggcacttgggggtgttctggccagcaccgtcggggtcaggttcgctctggggctgtgcgccattgcctacgtatgcggcatcgtgctgcagttcgtcgtgtttgtcgtggtcaaccggacgccgctacgtcgggccgctgcgtcggcggctggcctggtggtgcaacggcgttcttcggtgaaggaggtgccggagacggctatccggcaggagggcggtgcgtggcgcaaggtcttctcgccgcgcaggctcgggttgttcactggctcgctgttggcgatggagctcagccacgtgctggctttcagtatgttcgtcccacttgtcactcaagcttccgctgaccgctcctgggtggcgggcctggccaacgcgtgtttcgccctggcggcgatcggcagtggagtgctcgtctccggaggatcgctgggcaactgggtgcgcagccacacaccaggagtcctcatcgccggtttcgctgtgcagacggtgttcggacttaccgcgagtcagaccgtcttagccgttgccctctacacgctggtcggtgtgctcagcggcggggacaccgtgctgcagagcgaggtgcaggatcgctggcgaagtgtcgggtcctcccaggcgttcgccattttcggtgcggtgtccggaccttcccaactggtcggctccttggtcatcgcttttctgctcctgcacttctcgatcaccgctgtctacgtcggaacgattgtgattctgggattcggttcggcgctccttctggtcatggcgagagcgaagtcgatcaatcccgtggaagaagtcgtcccgtaagtttcaccgaaaatttgatgagtctttacggtgcgtcagagatgtggacggatccgatcctcggatattcgcatggaatgcctgaagaagggaaacccgcgatggaaatagccctctacggtctgggagagatgggctcggagatagcgcgctgcctggcgcggggcggtgcgcgggttcacacatacgatccatccgaatcggtggaagtggaggagaagaacctcattcggtgggacagtgtccggcatgccgcagagaacgcctccgtgcacttggtcgtcgcgaagcacctttccgacgtggagtcacttctcttctccgccgatgggataggcccgaatgcttctcaaaagtccctgatcgcggtgcacaccacactcaccccggaggttgtgcgggacctgcacacccggatgcgggacacccacggacacacgctggtggatgccgcgctcagccgccgcggcggtgttgtgcgcgagggttcgctgtccctgttcgtcggggcaggagacgaggccttcgccgtagcccggccggtcttcgaccgctacgccgacaacgtcgtccacgccggagacgtcggtgccggcatgacggtcaagctttgcaacaactggctgctctacgcgaaccggcactccgcactccaggccatccgaacgggccgtcagctcggcgtggatccggctgtgctcacggacgcgctcgcctcttccaccggatccagctgggcactgtcccactactccgacctggacgaagccatcgtcaccgggcggggcgcaccagcggtcatccgggacaggacagcttcggagcttggcatggcgaagcagatggcggcacaggacggtgaggtgcccaccagcctccaggagaccttcgcccttctggacgtgatgtagccgccttcggacgccagccgatcactgcctgcccgtaccggtccgcagcgcgggccccggctccatgccgctcatgcccggaaggccgatatgcacagcgaaccagttacacgcgagtcgtatgtggagaccgtcgccgagcttcccgtcccggtgtggaactcctccgtcgcaacggagttatacacgcggacgctcaccgtggtctgtcgcaggcgacgcgggggcgctgtggcaggggtctgggtctgcccgctggacacgggcatagagggcagaggtgacgcggcacggcggaagtaccggctgctgccatacgcctccccctggatcgatccgaacctccatcccctggagcggcaccgggtcgctctctcgttgctcgaggtggtcctgcagcgcgtgcacctggtcgagttacccatggatccgtgtttcggcgaagtagctgcactcgctgaggtgggtggagacgtggcgtgccgacacacccgcatgctggacatacgtgagggctgtgacccccgagggggttacagccccaccgtccgcaaccatctgcgggctgcggggcgcgctctgcgtgtggaggccgcagatccgtgtgagttcgacttcgctcgcgccgtcgttggccagtccgaggcggctgtggcggaacggagagccgccggactgcgcctccgccgctctgaaggggcggtccgctgtctcgcggcggtggacgccgaaggcgtcctgcgcggacaggcgttcgtcctgcgggaccgtcacaccgcagtgctcatgcaccagtggttcgaccgtgccgggccgcgcgggacaccgactttgctggtcgatagggcggtcatgcagacactgggatcacccggcgtgaactctttcgattttgaaggaagtgtcgttccgggcatcgaccgcttcatggctggcttcggcgctcaggccgtcggttacgggcagttccgctggcaacaggattggcgggaagaccctgccgggaggttcgggtgaatcggaacgaggatcgggcatccaggtctccggaagaggctgctgcgcctccacctttccttcggagggacgtgcgaaaggccggggaccctggcggcccactccaggtcgccccactcggcgagctcaggcctgaacaggaggcttactggcaggcactctacgacctctacggatccctggtgcagcagtcgcccgcgtacgcccgtgcggtcggcgagtcggggcggtacgtccttgtggtgatgggccaccggggggtgttcccgctgcagctcggctcggacgtgtgcacagcgctcggcggcgaccggccgctcctcgcggacggcaccggccccctgcccctggttcctctggtggccgcggccgcagaggccaccgggctccccgtctacctccctctggtggacgcttcgctcgccgaggcaggagttgtggaggcgttcagcgtgtgggagcggccacccaattcactgatcgactggtcgctcgacggcgccgacctatgggatcgcgtaaccgagcgcggtggttcacagtggagcaggaaacagcggctcatcgagcgggacggcctgattctgtccttcggccggtcgggcgaggcggccgccgaggaggtcctgcggatcgatgaccgctcgtggaagtctgcccacaggcagaacatgcgtgcgcgagagggccaggacaagttgtacgccgggctgatcgggtcaggggtgctcacggctacgttcctgcgggacggcgaccgctctgtcgccttccggcttgactcccgcgtcaaaggccgcctgacctgcttgaagtggtcgtatgacgagtcttaccggcgatactcacccggtgtccatttgctcacgcaggggctgcgccaggagtggtgcgggcgcggcatagaggtggtcgatctgcacgggagtcccgactcactgaaggacctgctgtgcaccgaccgggtgagccgcgtggacctctggtacggcgacccgctggccggcgcgcgccgtgcggccgagcggaccggcttcgacaggcggatgagggcggtccgtgacggtgggaaggggttacgccatgccttcgagtgagtccggtgccccaggggtggaacggcccgacagaggtgccacgggcttcgccggtcccgccgggtacgtcaccgtcggtgaagccgtcgcggaactgacccgtcgcatggcccagcccgcggtcgagttcaccgcctccggtaccgccgctctcgaagcggcactggaggtgctgggcatcggacggggcgatgaagtggttgtgcctgacgtgggatgtcactcggtggccgccgccgtcgtgcgacggggagcgatcccggtgttcacgggagtgggggaggccctgacgctcgatccccggggggtttccctggcctgcggcccacgcacccgcgctgtcgttgccgtgcatcagtacggactgccctgtgatgtgcccggcatcatggaggcggtggggccggacatcccggtgatcgaggatgtcgcccagacgtgggggtcggcggtgggcggtgccccggcggggtcgctcgggaccatcgccgtcatttctttcggttcgaccaagccggtggcgctcggcgcgggcggggcgctcttcgggccggcctcactgatcggcggagcggtctcccgcggcgatggagcggaccggcagctgcttcgccctcccagcgccgctcggttccccgcccccctgctcgcccatcttcccaaagccttggaaagggctgaccggctgctggccttgcgtcgggcagcggtggaaacctttctccgtgggccgctggcccaggagttacgtctgcctccgacgccacccggctcctcctccggatggacccgcacccctctgtatccgatcgcccccgcgacctcggtcacggccgaacacatggagcggctggaggcgtgtcacggcccggttcagcgcatgcacgcgacgccgccgtcggcgctgccgatgttccgcggaagcacaacgcgtgtgacaggcggcggccgtcggctcaccgaacccctactcgtgaagatgggatcaccacgatgactgcaaggaacctgacgacccgagcgggcgtcatcaaccctcaccagctcttcgacctttctcaggaggacatcgactccttcagccacctgaagagcgtgctcgccgacggacagctcttccgctacgtcgagagcgaccgggaatcggcgaacaccttggtcgaacggcacttcgccgagcacttccgcaaggagagggcagtggccgtggccaacggcaccgtaggcctgcgcctggccctgcgtgcgctgggcatcggccccggtcaccgagtggcggtcaatgcctacgctttcatcgcatgtgccatggcgatatcagcgaccggcgccgagccggtgccggtcgacatgggcggatccgtcctgagcatggacgccgacgctctggagaagggcgtgggccacctcgatgcggtcctcctggtgcacgtccagggccacgccgtcgcggccggtccgatacgtgccgtctgcgaccggctcggcataccgatgatcgaggacgtgtgccaggcgctgggagctggttcgtcagaggcgggcgccggcggcgtaggtgacgtcgctgtgacgagtttccaacaggccaagcagatctcctcgggtgaaggcggactcgtcgccgggcccgaggaggtgatcgaacgggtctaccgcctgtcggatctgggcgccgtgcgccaggagaacggtctgccggactgggaccacgaggatgccctgatcggtgacaacctgcggatgactgagcttcaggccgcccttgtcatggatcaggcagtgcggctggagaacacgcttgcccggcaacgggaccagcggtcacggctgcgggccgggctcagtgatatccccgttatcgagagcgagaacccggccgaggacaccggatcgcacacgcttgtcctggcccgggacaccacggcggcggaggagttccgcgttgagctcgcacgccgcggggtgctggcccgaccggtctggaagaagagctgggtggaatacggtttgtaccgacgggagttcgcgagcggcgcccctgccggcccgtggcccgggaaggctgtcggcctcgcctcgcggattctgagtattcccacttcgaaatatgtgacggactccgccgtcgcccaagtggcccaggccatcgcggcgggccgccaccacctcacacaggacaggtgagaccccatgtcatccttcgcgctcctgctccgcggcctgccgaactccggcaagacgaccactgccgcgctgcttcgcaacgccttgaagccgtccgttcggatctccaacgactcggtgcgctacatggcacagccccgggatttcagcgacttcactctcgtcgcctccgagctcggctgcctggatctcgcctcttcatacctggagagcggcttcgtacccgtgatcgacggcgtgttcgaggacatcgacttcctgtccgcgcagaagttgcgcttccacaggaaaggtatgcggctgatcgtcatcaccctggagggaagtctttccgatctgctcgaccgaaacgcctcccgcgatccgctggcccggatggaggaggaccggatgcgagagctccacgcccagttccggccgagcggactcgtcctgtccctcgacgggaaacagcccgaagaggtggcggacgacgtattggacctcctggaattgcagcccccgtaccaggccgaggcagctgacccgggagcggccgacattctcttcctgcgccacggtgctcccgagtaccccagtgacgtctaccccgatccctatgcgatggggctgtccgagcaaggctttgacgaggcccgcgtggcgcgtgccgctgtggagcggttcgcgcccgagatcgtctacacgtccgacttccgtcgtgcggagcaaactgcctcgctggtgaccgccacgatcgatgtcacgccccagcccgaacaccgtctgcgggagcgagtcttccatcagctcgccggcgtagagctcgaagaggtccgctcacagctgggggctgaggcggatgcggtcctcgggggcaacagcgatctgtgcgagcgtgaggaggaggaatcctacgaggctgcaagagcccgggtgctcgcctttttcgatgagatggccgagcggcacgccggccggcgggtcctggtcgtcggccacggcggacctcacgcatggctggtggagcgggcgcttggcgccgagatgcgaggagtgcgccgcatgcgctgggacacgggtcacttctcgcggttcaaggtgacgcccaaccaggtctcactggactacctcaacaggtcaccggaagacgtcaccccatgactaacgcaaaggacgcgaccacgaccgcttcggatccacgacgacggccacgggtcgccgtggtggccacccccttcggcttcggtcctgcctcgaaggcgtacagcatcggcgaagtcctgcacacccattggggtgtggacgtccagtactacggaacggactccgcccgcgacttcttctccgcgcagcccgatgtgaggcccctggcgccggaggcagtcggtgacaccggagcgatcgacgccgtactgaacgtgctggctccggatctgatccgaagttccgaggaggcagcccggacgtactacgtcgacagcctcggcttcatgtggcagccctcggacattccggacggcagtctgctcaaaagggtgcaccggtacttcgcccaggacatctttggcagcgctgaccatctcactgcgctggggatcaccggagtgacccccgtctcgggaatcgtcgccgaaacagcgccgaccgacatgtcaccgcggccacgctccgtgaaacggctgctcgtccaactcggtggtctgagtaacccggccggccggtcgtccggagaggtttatctcgcactcgccgcgagactactcacggcactgcagcaggacccgtacgaactgagcattgccatgaaccgcgcaggcggcacgttctccctgggatcgctcgaccaggcccgccaattgtccggccgcgacttccacgttgaactggccacctgcgccggtgtcctcagctcacccggtatgaccacgctcattgaggtgtcgcgtgccaagtgcccctatgttccattaccgcctcagaactggagccaggtagtcatatcacgctatatggcgcgaaattcacgcttggggatatgggactttctgatcggtccgtacgccacggtggacgctcatgtccccgaggctcagaaggccgcccaggtgggggagatcaaccagctgctggcaaggaacgccggctacacgacggcctatgtggacctggcccggacggcactggccgaagctcgagtaccggacgtgggcgcaccgttcgacggggcgcgcgtcgtggccgctgccattgcagacgatctcaccaagggaaaatcgcgttacggacggggctcgcatacggatttgaaagaccacggcacaccgactggtgaactctgaagaaaagagattccgatgacgcagcagatcgacaacggcctcgtggccgtacttcagtcgctcgcgcacgaggtggaaaccgcgcgcgagtggagccaggtatcgcggacgctggcacaggagcgggtggccaccgtcttcggctcggcccgtacgcgccgcggtgaaccggcatacaacctggcgtatgaactcgccacggcactggccgcagggaagtggaccacgattaccggcggtggacccggcatcatgcaggccgcgcgggacggcagtggggagggcttgtcccgagcggtgcgggtggagatccccggtgaggaacccgacaccgtgctggacccgtccaggtccataaccgtcgcaaccttcgcgctgcgcaaattactcctgacccacgacatcgacgctctgttcgtcttccccgggggtgtcggcaccttcgacgagctgtacgaggtgctggtccaccaggacaccaaccgacttgcctggttcccggttgtcctgatgcagccggccggcgagagcctctggtcggcctggctggagttcatggagaagcacttggtcagcacgggactggccagctcctccgtgatcaagaggctggttgtggccgagtcggtggaagaggccctggcagccgccgaggggccccgcgcgacggcctacggaacgagcggttctccgtcgcccggaacaggtcacggggcgaccggaaagtgaccgccaccgaggacgaccggccccgcagccaggcagatacaaggccgcctggcaccgctcaggtccacatcagcgtgatcatcccaacgttcaacgcccgcaccactttgcgatgctgtcttctctcgctcctccaccagaggctcggcgctcacggaccggacgcagggtctccgttcacgtacgaggtcatcgtcgttgacgacggttcctccgacggcacaaccgaaatgatcgcccagttcccctcccggctcgacctgcgatacaccttcctgcctcgaacggacagatcgggtcgggcccgggcacggaatgccggcctggctctcgccacgggaggcctcgtggtgacgctcgacgccgaccaagtggtggagccgctcttccttgccgaacacgcccggctgcacgcaggcggccccggccgcgtcgttgcaggccagcgtctccaactcgccgaggggccaatgaacgaggctcgcttggagcacgggttcgacccgcaggccctcccaccggtggtccggggcgacgagcgggagcagctgtttcgtctcctcgacagctccctagaggacatggtgaccggctggcaccacgtctggacctgcaacgcctccttcccccgggacaggctcgaggcggtcgggggcttcgacgagacgttcaccggctgggggctggaggacgcggaactcgcctatcggctggttcaaggtggtgcaaccacgcacttcgccccgtcggcggtggtccgccacgagcaccgcacaccggttacagccgacatgtaccgggagtggtgccgcaacttggcctacttcgtgcgccgacatcccgcaccagaggtacggctccaggagatattcgctcccgccatcgatcccgaccggtccgcgccgggaacgtgggacgacatcgccgccgagttcgagcacacggctcgacggctcggcgctgaccccggccagcatccgtagctggcatcaccggttccgctgctatggcagcacccgctcataggccgcagcagcggacccccctggaccaaattgagaggaggcgattcaccgccatgcccacccctgcgggaaacgtccccgaccatctcgccccgaccgtccgccgggtcgtctatctgcctgtcaaccgccccttcgagacagcatttcactccgtggccgccgaagtggcatcgttggagaagaaccagcgagacaacgtcaccctcctcgtcgtggacgactgtgcgccaccagtgtcacgggccaatcgccaggtgaccgagcgggtagcccgtgaatcgggcctgcgcgtacacacactggaccaacaagactggcttcgtctggccaccacagtgatcgcagcttccgggctgaccggggccgaccgagccacggcgcggaccgccctggtcaaacccaccggttcctacggggcaggtcccaacaaggccgccctggtcgccgcgctggaaggtgcagtctccctgcatcgccgggacagcgaccaggtcacgacggtagaccccgacaccggagcctccccgctccgcctggaagccgacctcctgggtcgcgcccgcccggagggcggcgccgcggcctactgcgcaggctccttcctcaccggtcgccccacgcgagaccgaagggacctggaacgcgactcgacggagtacgcggcccgtatcgacgcactgagccaactcccctccgccccggcccgacgcccgcctctcccgcctgtccgggaacggacggaactcctaggagggcagcacgccgagcgtgacctgacaggtgtggtcgagatggggatcgcggccatgcgaagcgtgtacgagtggatcccagaaatgcccgccgtgggcatcctcggcagcgactacttccagaagggactgctctatcagctcaacctcccggtcttccaccacagcctcccagcccggcacacctacgaatcctggcgcacggagcagtgcgacgattcccatctggcctggtacgtccgggcggaggtgcgctacgccgtactgcgccgccactggaacagcttcaaccacctgctcgtgggccaacggacgcgcgtgctgtccgatggtcacttcgactcccgggcttacggtcagctgttcgtcgaagcgctccacgagggcacccggggggcggaaagcattcccgacgacttcgcggccgtataccgcgacgccgcgaacgcggccacaggcgaggtccgtcgacgtcttctggtgcggctggccgcactggaagaggagaccgatgctgtcaacgcatacgtggccgatgccatccacgaattcgccgccctctcacgtctgtggcccggattgatctctgccgcacaacgggtcgggaggacaaccgcgctggagacgtttacccactgagtagtccggccggtcgaactgccgtcggaacgagggaagacaacacccaaccggaaggaagacgccatgtgcggcatcggaggcatcgtcctgaagcagcgttcccgggtcgacagaaaccacatgatggaacgcctacgcgccggtctcgcccaccgcgggcgaagctcgcagggagacttcgccgacacccgcgcagccttgcactgcgcacggcacgctgtcatcgccgtcgaagccgcccaacagccgctacgggactcccggaacgaactggtgatggtcggcaacggcgagatcctgaactaccaggaactggcacagcagcttcccgccgcgcgaacacgccgcctgctgccaggagacctccaggtcgcgctcgaaatgtacgccgagcacgggatcggcgccctggagaagctgcgcggcccgttcgcggtcgccttgtgggacagccagtcgggcgagctgaccctcgcgcgtgaccggttaggagagcgccccctctacttcttcgactgtcccgactttttcgccttcgcatcggaggtacggtgcctcgccgcagctcttccgcaaggcctgctgaacctggacgaagaagcggcggtagccttcctggggctgggacgagtgcctacgggccgaaccctctaccgggagattttcgcggtcccggcgggctcagtgctccgaatggggactcagccgttcgagccccggcacatggcgtccctggctcctgtctcggcactgcgcagcgcgccggccccgcaggaggagatcgacgccgttctcgcccaggcccaacgccgggcgctggtggcggaccaccccgtagctgtgggattctccggcggcatggattctgcagcagtcctgtcagcggccctggacggagcgggtgccgccgcagtcatcacggtctactccgaactgtcgccagtcaccgatgtgaacctccggcgcgcgcggagtcttgcgccccttctgggcgtccaactgaccgaggtcccgttccgaatgcccacggtccagggcgccgtggatattctgaactcgacactcgacggcccagccgctgagcccctggtgctgcacaacgacgccctgcatactgcggcccgggagcactccgccgtcgtggtcggagggcacggagccgatgaagtcttcggagggtacgcccggtatccggcgctacgagcccaggagaccgcgccgacgaagcactggctcgcgtcgtccgcctgggagcggtggaatcgatcggccgcctggcaccggttcgtcgaggaaaacgccgcgccgcacctggcggatcgcgtatcggcgtcctttcccgatccgctagaaaagaccttcccctacgcatggtcggaatcgagcgaccccgtgctcttcggccaggctctcgatatgttccggctgatgacctacgacaacttccgagctacggacgagaacggcatggcacgacaggtggaggtcagatctcccttcttcgacctcgacctgctggctgccgtctacagtctcccggtgactgagcgcctcggaccaggggcctccaagccgctgttgcggcgttcgttccgaaataccccgctggcaggagcattcaccgaaccgaaggtaggcttcgacgatcatttctcctatgccgactggatgacagagaactggctccagttctcaaccgccatcaccgacgggccactcaaagggacgggcatcctgcaggacggcgccctggacgatctggagcatcgcgactggcgcacactgtggcgccttttcagtctgtccgcctggctgaggcgcagttgaactacggaagttgaactcgcgacgtcgctgccgctcaggtgagtctgatggtcaggccggtctcggcgaggcagccgttctgtgaagtcgctgcggtacgcgctggacgtggtgttagggggtactgaaggcgacgttggctcgcagcgtggacgaggtggaggaagacattggcggtgatgtcgacgtcgtcggccgtgctcggcccaccctcgctaccaagggctccggcgagaactacacggtcaacgacaactcgtaggtcgtctgcggcaacgttcccaccgccaacgccacggtctacatcgtcgacaccgttctgatgcccaaggcgtgaccaccccactccgcccctgacgcgcggtgatgcggcaacgctctggtgagcgcgccacacgccgcctcccgctggagtgcaagctccagcaacgggcgagccacatccccatccctgactcggggccgcgtgcgtttctgaaggagcccgaccgctggcgctttcgccggaggccacacggaaggtctgccgggtgagcggctccggtctgcaggcggtggcgaaggccggggacatcacccaggcctagcttgatctttaaccccctgcactatgcatcaggaccgtatgtcggttgctggtgatatctgtggggcgtggaagatgcgatcttgagtgcgatagccctgctaagtgaagccttcgtggcagagacccgtcgccggccgctgggctgggaggggcttcggtcgtgggaggaccagcaaggtgtcgtgttgccggagccgtatcgcaccttcgtggccgagattgcgaacggaacaaacgagggcccgatgtacgagggcggtcttttgcctctgggagcaaagtccgacagctgggtcagttgggaagctgactgttggctgagtcctcagccgttcgacggcaccgccctacgcaagctcgaccggcctttcccgcttgtagaggaatggcagtgggagtacgagtactacgaccacgccctccactcagcgccgctgcacgagatctaccagcacggctccgtgctgctgggcagtgatcaacctggcgactactggacgttggtggtgactggcccgcagcgcggcaaggtgtggtggctcagagacggatgcgccacaccctattcttcgtccggagaacttggagtcggcttcctggactgggtgagggactggcacctcggacagggctgttggcgctccgagtagcccagttcctcaatcgcgaactcgtaggtcggacggttcgtcgtacttgatcactcggactggtaagtgccttacgagcagccgaccttcggctgagcatgtgatccgaccaaggaacacacaagctcagcacgaaggccgtgaggatgagtctgtcgcatcacgtcgcccggggggatccgtttgcgggactgtcacgcttccgggatgagttctattcctgtctgaccaggcgtgcggacgcgctgttcgaactcgcggacgcggtgttgtgcgcggacggtccggtccggtcgctggtggaactgtcgctggtcggtgaacaccgtcgcgggcacggcgggctctacgatgccctgtccgcaggccgggtcgatgtcgcccgactgcggcgggccctggccatggtgcggctgcctcgggcggccgacggacggctggtcctggccgccgatctcacctgctggctgcgacccgacgcgcacacctcaccgcagcggatcctgtgccacacctacgggcggggcaaggaccagcacattcccgttcccggctggccctactcggtgatctgcgcacttgagacgggccgtaattcctggaccgcgccgctggacgcactacgtctggcgccgggcgacgacgccgccaccgtcaccgccaggcaggcacgcgagctcgtcgagcggctgatcgatgccgggcagtggacggacggcgatcccgagatcctgatcgtcgtggacgccggctacgacgttccccgcctggccttcctcctgaaggatcttccggtgcaggtgctgggccgaatgcgctcggaccgcgtcctgcgacgcggggtcccaccccgcgagcccggtgtccggggccgcccaccacgccacggcggggagttcgtcttcggtgacccggccacctggaacactcccgacgcacagacggtgaccgcgacacgtctctacggcaccgccgtcgcacgggcatgggaccggctccacccgagactgacccaccgctcggcctggaccgcccagctagtgccgcatcaagcaacgtttgccctgtcaggccgacatactgtgggcgtgcttgagtacttgcttgcgaccgatgacgacgatttcctcgggccggtgcgctcggataggtgtccggatgtgcttcagccaaggggctggggggcggtgccagtggctggcgatggccactatcggatcgctgtcgaaggcatggagattgagttcgcttgggaaatgcccggccttcaggtcacggttcacggcatatcagacgagcccagggttgaggagctggtggctacgatcgcgcgtcaggtcggaaccgagctcgcggtgcgagtccgggtaatcccgctctagcgctgcttcaggcaacgtgggcttggttgactacggttcgtagttgctggtcatgagtgtggtggtttctccagatgatgtaacggcggatcatgctgccctgctccttgtgactggcgtggtcggtgccgtcgagggtgaagtagcgcagggcggcggtgaactgggcctcgatccggttgagccaggagctgttggttggggtgtaggcgatctcgacgttgttcgcgtccgcccacgtcgcgacccgttggcaccgcttcgtcgtcaggtgcggggagtagttgtcgcagatgatggcgatccgcaccttcgctgggtgcaaggagcgcaggtagcggcagaactccaggtacttggagcggttcttggtcttcttgatgtgaccatagagctggtctttgcccaggtcgtaggcggcgaacaggtgccggaccccatgcgggcgggtgtaggtcgcccgccgccgtggccggggggctcggtcggggttcttgtgccggccactgcgttcggcccactggcgtccggggtggggctggaggttgagcgggccgaattcgtccatgcagaagatgatctcgggctcgccgtcctcgggtatgacctcgccgtcggcgatggcgtagagatgctcgacacgggccttcttctgcgcgtagtccgggtctttcgaggtcttccaggttttcacgcgttgaaaggagacgccttcctcgcggagcaggatgcgcaggccctcgtggctgatgtcgtcgaccaccccctcggcaactaggaagtcggccagcttgaccagactccaggtcgagaagggcagattgtgctcgactggcttggacttggcgatcttcttgatctcccggcgctcgggcagggtgaacgtctccggccggccgcctctgtacttcgggtagagcgatgcgaacccgtcggatttgaaattgtggatcacgtcccggacccggtccgcactggtgaacgcgacctcggcgatcttcaccacgggcatgctctgcgcggacagcagcaccatctgggcccggcgccaggtcaccactgaccctgtgccgcggcggacgatccgcaacaaccgccggccttcatcgtcatcgatctcacggacgcgtactcgttcagccacccgcacagcttgacggccgcacgccgcccaggacaggtcccaaacggcgcgtcaggtcacaacagggcaaacgttgtctgatgcggcattagcggctgagggatggagcttcgcttctcgggctacggagtgcgggtgccgacggtgtgcaggcgctggatggcctgcttcgcggcatcgttcatccgatctagaactgaggtcgcggtgctgagctcggcctcggtggcctggcgcagggtcgctgcgatctcggttccggcgatggccatgaatgcgtgtgcctgttcggaggcggcgggtgtgggccgcagggtgacgcggcggcggtcctggtgctcgcggctgcggaccaccagccctgcccgttcgaggcggttcaggagaacggctgttgatcctgtggacattccgatacgccgggagagtgcggcaggggagaggggggtgccgctctgtgccgcccagacgatctgtccgacggcgttggcgtccgagcctggcagtcgcatccactgcgacatgtacaggttgatctcggcgaagccggtcgcccactcccgcagtgcttccatcatcttgacctgcgacgtctcccacggctcctgtgccggattccccatgcccactccaatgctctactgtagagatactttactgtagagcttagtggacgggagctgtcatgagtgcaggcactgcggtggtgtccggggcgagcatcgctgggctgtcggcggctttctggctgcggcgccttgggtggcaggtcactgtgatcgagcgcgcaccggagttccgcgatggcgggcagaacatcgacgtgcgcggcgtcgcgcgggaggttcttgtccgtatgggtctgttcgatgcggtcaaggcgcgcaacacgaccgagacgggcgccgtcatcgtggacgggaatggccaggcgattgcgaccctgccagacggcggaggcaccggggcgacggcggagctggagattctgcggggcgatctcgccggtgttctgcgcgatcacctccccgagggggtggagttcgtctacggcgacaccatcgaggacgtgagcgagcatgccgggcatgcccgcctgacgacggcgggcggccgggagctgcggtgcgatctgctggtgatcgccgaaggggtccgctccacgaccagggggcgcgtcttcgcccaagacaccgtcgaggagcgcgagctgggggtgacgatggtgttcggcacgatcccccgcgtgccgggtgacgacgaccgatggcgctggtacaacgcgcctggcgggcggcaggcccatctgcgcccggacccctacggcacgacgcggaccatcctgtcctacagccccggcgacgacctgctgtccatgagccgcaatgaggccttggcccaggtccggtcgcggtaccgcggcgcgggatgggagacatcacgcatccttgacgcgctggagacctcgcaggacgtctacatcgaccagctcgcgcagatccggatgaaaacttggcaccaaggacacgtcgtgatgctgggagacgccgcatggtgcgtgacccccatgggtggcggaggcgcttccctggcgctgaccagcgcgtacgttctggcggcacagctctccgcacattccggcgatctcgctgccgcgctggcggcatacgagcggtggatgcgcccgctcgtgcgggacgcgcagaacatgccgggctggctgacgcgtttcgcctacccccagagccgggcgggactggcgctgcgccacgtcgccgaccgcgtgttcacctccgcccccttccggcccctagctgcaaagctcacccaggtcgccgagactgaacggacgcttcccacgctccgcccgaccaccggataa

SEQ ID NO: 44 - DNA, 24 bp, Artificial Sequence
  Primer1F
gtcaatgcctacgctttcatcgca

SEQ ID NO: 45 - DNA, 24 bp, Artificial Sequence
  Primer1R
acaaaccgtattccacccagctct

SEQ ID NO: 46 - DNA, 24 bp, Artificial Sequence
  Primer2F
tcaccagctcttcgacctttctca

SEQ ID NO: 47 - DNA, 24 bp, Artificial Sequence
  Primer2R
catggcacatgcgatgaaagcgta

SEQ ID NO: 48 - DNA, 24 bp, Artificial Sequence
  Primer3F
acgaactgagcattgccatgaacc

SEQ ID NO: 49 - DNA, 23 bp, Artificial Sequence
  Primer3R
gtgcctggtctttcaaatccgta

SEQ ID NO: 50 - DNA, 24 bp, Artificial Sequence
  Primer4F
agagctgggtggaatacggtttgt

SEQ ID NO: 51 - DNA, 24 bp, Artificial Sequence
  Primer4R
tttcggtcgagcagatcggaaaga

SEQ ID NO: 52 - DNA, 24 bp, Artificial Sequence
  Primer5F
ccatcgccgtcatttctttcggtt

SEQ ID NO: 53 - DNA, 24 bp, Artificial Sequence
  Primer5R
catggcacatgcgatgaaagcgta

SEQ ID NO: 54 - DNA, 24 bp, Artificial Sequence
  Primer6F
acatacgactcgcgtgtaactggt

SEQ ID NO: 55 - DNA, 24 bp, Artificial Sequence
  Primer6R
acatacgactcgcgtgtaactggt

SEQ ID NO: 56 - DNA, 24 bp, Artificial Sequence
  Primer7F
ttgcagacgatctcaccaagggaa

SEQ ID NO: 57 - DNA, 24 bp, Artificial Sequence
  Primer7R
atgatcacgctgatgtggacctga

SEQ ID NO: 58 - DNA, 30 bp, Artificial Sequence
  Kan-F primer
gcccccgggttctatcataattgtggtttc

SEQ ID NO: 59 - DNA, 31 bp, Artificial Sequence
  Kan-R primer
ggggatccggtgattgattgagcaagcttta

SEQ ID NO: 60 - DNA, 31 bp, Artificial Sequence
  gouL-1-F(-2056) primer
cgaattcagtcgtacagcaaggcttccaagt

SEQ ID NO: 61 - DNA, 28 bp, Artificial Sequence
  gouL-1-R(-880) primer
ccggtaccgagtgacaagtgggacgaac

SEQ ID NO: 62 - DNA, 28 bp, Artificial Sequence
  gouL-2-F(+522) primer
cctctagattcggacgccagccgatcac

SEQ ID NO: 63 - DNA, 32 bp, Artificial Sequence
  gouL-2-R(+2364) primer
ccaagcttactcgtcatacgaccacttcaagc

SEQ ID NO: 64 - DNA, 30 bp, Artificial Sequence
  gouH-1-F(-1827) primer
cgaattcccgctgcagctcggctcggacgt

SEQ ID NO: 65 - DNA, 25 bp, Artificial Sequence
  gouH-1-R(-845) primer
ggcggtaccggaggcggtgaactcg

SEQ ID NO: 66 - DNA, 33 bp, Artificial Sequence
  gouH-2-F(+1184) primer
cctctagaggacaggtgagaccccatgtcatcc

SEQ ID NO: 67 - DNA, 32 bp, Artificial Sequence
  gouH-2-R(+2985) primer
ccaagcttggttcatggcaatgctcagttcgt

SEQ ID NO: 68 - DNA, 32 bp, Artificial Sequence
  gouF-1-F(-1831) primer
cgaattctaggtgacgtcgctgtgacgagttt

SEQ ID NO: 69 - DNA, 29 bp, Artificial Sequence
  gouF-1-R(-41) primer
ccggtacctggtcgcgtcctttgcgttag

SEQ ID NO: 70 - DNA, 31 bp, Artificial Sequence
  gouF-2-F(+1126) primer
cctctagattccgatgacgcagcagatcgac

SEQ ID NO: 71 - DNA, 32 bp, Artificial Sequence
  gouF-2-R(+2919) primer
ccaagcttcggtgaatcgcctcctctcaattt

SEQ ID NO: 72 - DNA, 30 bp, Artificial Sequence
  gouWcluster-F(+4) primer
cgaattcaccacgcatgtctgcacgacggt

SEQ ID NO: 73 - DNA, 27 bp, Artificial Sequence
  gouWcluster-R(+1897) primer
ccggtaccaactgccgagacacccaga

SEQ ID NO: 74 - DNA, 28 bp, Artificial Sequence
  gouWcluster-F(-1373end) primer
cctctagatcaatcgcgaactcgtaggt

SEQ ID NO: 75 - DNA, 32 bp, Artificial Sequence
  gouWcluster-R(-92end) primer
ccaagcttatatgccgtgaaccgtgacctgaa

SEQ ID NO: 76 - DNA, 11883 bp, Streptomyces puniceus
atgcttctgctgctgtccgttctggtgatcgaggtgacgggttcggcggccagtgctcctttggtcatcgctgccggcgcactgcctgcgctgcttctggtgcgctgggtgcggagcgtcaaccgtctcctggaccatcgctgggtgatgatcctctcggacacaggagctttcgcagtcgcgctggctctcttcctgctgtcgcaggccgacgtccaagcctggcagatctactgcggcgtcgccttgttctccggcttcggcgccttctacctgcccgcaatgcgtggctgggtggccgaccagtcgggcgacatcacccaactcacgtggctcaactcgatgctggcggtggctacgcaggcgtccgtcgtcgtcgggtgggcgcttgggggtgttctggcaagcacggtcgggatcagcttcgctctggggctgtgcgccatcgcctacgcatgcggcatcgtgctgcagttcgtcgtatttgttgtggtcaaccggacgccgctacgtcgggacgctgcaccggtggccggcccgggagagcggcggcgttcttcggcgaaggaggtgccggagacggccatgcggcaggagggcggtgcgtggcgcacggtcttctcgccgcgcaggctcggtctgttcactggctcgttgctcgcgatggagctcagccatgtgctggctttcagtatgtttgtcccacttgtcactcaggcttccgccgaccgatcctgggtggcgggcctggccaacgcatgtttcgccctggcggcgatcggcagcggagtgctcgtctccggaggatcactcggcaactgggtgcgcagccacgcaccaggagtcctcatcgccggtttcgctgtgcagacggtgttcggactcagcgcgagtcagaccgtcctggccgttgccctctacacgctggtcggtgtgctcagcggcggggacaccgtgctgcagagtgaggtgcaggatcgctggcggagtgtcgggtcctcccaggcgttcgccgttttcggcgctgtgtccggaccttcccaactggtcggctccttggtcattgcttttctgctcctgcacttctcgatcaccgccgtctatgtcggaacaatcatgattctgggattcggttcggcgctccttctggtcgtggcgagagcgaagtcgataaatcctgtggaagaagtcatcccgtaggtttcactgaaagtttggtgagtctgtgcggtgcgtcgcagatgtggacggatccgatcctcggatccgcgtggaatgccagaagaagggagactcgcgatggaaatagccctttacggtctgggagagatgggctcggagatagcgcgctgcctggcacggggcggtgcgcgggtccacacgtacgatccatccgaatcggtggaagtggaggagcagaacctcgttcggtggggcagcgtccggcatgccgcagagaaggcctccgtgcacctggtcatcgcgaagcacctttccgacgtggagtcacttctcttctccgccgacgggataggcccgaatgcttctcaaaagtccctgatcgcgctgcacaccacactcaccccggaggttgtgcgggacctgcacacccggatgggggacacccacggacacatgctggtggatgccgcgctcagccgccgcggcggtgctgtgcgcgagggttcgttgtccctgttcgtcggggcaggagacgaggccttcgccgtagcccggccggtcttcgaccgctacgccgacaacgtcgtccacgccggagacgtcggtgccggcatgacggtcaagctctgcaacaactggctgctctacgcgaatcggcactccgcactccaggccatccgaacgggccgtcagctcggcgtggacccggctgtgctcacggacgcgctcgcctcctccaccggatccagctgggccctgtctcactactccgacctggacgaagccatcgtcaccgggcggggcgcaccagcggtcatccgggacaggacggcttcggagctcggtatggcgaagcagatggcggcacgggatggtgtggtgcccaccagccttcaggagaccttcgctcttctggacgtgatgtagcagcctgcggaagccagccgatcactgcctacccgtaccggtccgcagcgcgggccccggctccctgccgttcatgcccggaaggccgatatgcacagcgaaccagttacacgcgagtcgtatgcggagaccgtcgccgagcttcccgtcccggtgtggaactcctccgtcgcaacggagctgtacacgcggacgctcactgtggtctgtcgcaggcgacgcgggggcgccgtggcaggggtctgggtctgcccgctggacacgggcatcgagggcaaaggtgacgtggcacggcgagaacaccggctgttgccatacgcctccccctggatcgatccgaacctccatcccctggagcggcaccgtgtcgctctctcgttgatcgaggtggtcctgcagcatgtgcacctggtcgagttgcccatggatccgtgcttcagcgaagtagctgcactcgccgaggtgggtggagacgtggcgtgtcggcacactcgcatgctggacatgcgtgagggctgtgacccccgagggggttacagccccaccgtgcgcaaccatctgcgggctgcggggcgcgttctgtgtgtggaggccgcagatccgtgtgagttcgacttcgctcgcgccgtcgtcggccagtccgaggcggctgttgcggaacggagggccgccggactgcggctccgccacgtcgagggggcggtccgctgtctcgcggcggtcgacgccgaaggcgtcctgcgcggacaggcgttcgtcctgcgggaccgtcacaccgcgatactcatgcaccagtggttcgatcgcaccgggccgcgcgggacaccgactctgctggtcgacagtgcggtcgtacagacactggagtcacccggcgtgatctcttttgattttgaaggaagtgtcattccgggcatcgatcgcttcatggccggcttcggcgcgcaggccgtcggttacgggcagttccgctggcagcaggatgggcgggaagagcctgccgggaggttcgggtgaatcggaacgaggatcgggcatccatgtctccggaagagggtgctgcgcttccgcctttccttcggggggacgtgcgaaaggccggaagccctggcggcccgctccaggtcaccccactcggcgaactcaggcccgagcaggaggcgtactggcaggcactctacgatctctgcggatcccgggtgcagcagtcgcccgcgtacgcccgtgcggtcggcgagtcggggcgggacgtccttgtggtgatgggccaccggggggtgttcccgttgcagctgggctcggacgtgtgcacagcgcttggcggcgaccggccgctcctcgcggactgcaccgtccccctgcccctggttgctctggtggccgcggccgcagatgccaccgggctccctgtctacctccctctggtggacgcttcgctggccgaggcaggagtcgtggacgcgttcagcgtgtgggagcggccacccaattcgctgatcgactggtcgctcgacggcgccgacctgtgggatcgcgtgaccgagcgcggtggttcacagtggagcaggaaacagcggctcgtcgagcgggacggcctgaatctgtctttcggccggtcgggcgaggcggccgccgaggaggtcctgcggatcgatgaccgctcgtggaagtccgcccgcgggcagaacatgcgtgcgcgagagggccaggacaggttgtacgccggtctgatcggggcaggggtgctcaccgctaccttcctgcgggacggcgaccactctgtcgccttccggctggactcccgggtcaaaggccgcctgacctgcttgaaatggtcgtatgacgagtcctaccggcggtactcacccggtgtccatctgctcacgcaggggctgcgccaggagtggtgcgggcgcggcatagaggtggtcgatctgcacggaagtcccgactcgctgaaggacctgttgtgcaccgaccggatgagccgcgtggacctctggtacggcgacccgctggccggcgcgcggcgtgcggccgagcggaccggcttcgacaggcggatgagggcggtccgtgacggcgggaaggggttgcgccatgccttcgagtgagtccggtgcgccagaagtggaacggcccgacgaaggcgccaagggcttcgctggtgcggccgaccacgtcacggtcggtgcagccgtcacggaactgacccgtcgtatggcccagcccgccgtcgagttcaccgcctccggtaccgccgctctcgaagcggccctggaggtgctgggcatcggacggggcgatgaagtggtggtgcctgacgtgggatgtcactcggtggccgccgccgtcgtgcgacggggagcgatcccggtgttcacgggagtgggggaagccctgacgctcgatcccctgggagtttccctggcctgcggcccacgcacccgcgctgtcgtcgccgtgcaccagtacggactgccctgtgatgtgcccggcatcatgaagacggtggggccggacatcccggtgatcgaggatgtcgcccagacctggggatcggcggtgggcggtgccccggccggttcgcttgggaccatcgccgtcatctctttcggttcgaccaagccggtggcgctcggcgcgggcggagcgctcttcgggccggcttcactgatccgcggagcggtctcccgcggcgatggagcggaccggcagctgcttcgccctcccagtgccgctcggttccccgcccctctgctggcccgtcttcccgaagccttggcaagggccgaccggttgctggcctcgcgtcgggcagcggtggaagcctttctccgtgggccgctggcccaggagttgcgtctgcctccgacgccatccggctcctcctccggatggacccgcacccctctgtatccgatcgcccccgcgacctcggtcacggccgaacaggtggagcggctggaggcgtgtcacggaccggttcagcgcatgcacgcgacgccgccgtcggcgctgccgatgttccgcggaagcacgacgcgtgtgacaggcggaggccgtcggctcaccgaacccctactcgtgaagatgggatcaccacgatgactgcaaggaacctgacgacccgagcgggcgtcatcaaccctcaccagctcttcgacctttcccaggaggacaccgactccttcagccacctgaagagcgtgctcgccgacggacagctcttccgctacgtcgagagcgaccgggaatcggcgaacaccttggtcgaacggcacttcgccgagcacttccgcaaggagagggcagtggccgtggccaatggcaccgtaggcctgcgcctggccctgcgtgcgctgggcatcggccccggtcaccgagtggcggtcaatgcctacgccttcatcgcgtgtgccatggcgatatcggcgaccggcgccgagccggtgccggtcgacatgggcggatccgtcctgagcatggacgccgacgctctggagaagagcgtgggccacctcgatgcggtcctcctggtgcacgtccagggccacgcccttgcggccggtccgatacgtgccgtctgcgaccggctcggtataccgatgatcgaggacgtgtgccaggcgctgggagctggttcgtcagaggcgggcgccggccgcgtgggtgacgtcgctgtgacgagcttccagcaggccaagcagatctcctcgggtgaaggcggactcgttgccgggcccgatgaggtgatcgaacgggtctaccgcctgtcggatctgggagcggtgcgccaggagaacggtctgccggactgggaccacgaggatgccctgatcggtgacaacctgcggatgaccgagcttcaggcggcccttgtcatggatcaggccgtgcggctggaggacacgctggcccggcagcgggagcggcggtcacggctgcgggccgggctcagtgatatccccgtcatcgagagcgagaacccggccgatgacgccggatcgcacacgcttgtcctggcccgggataccgcggcggcggaggagttccgcgttgagctcgcacgccgcggggtgctggcccggccggtctggaagaagagctgggtggaatacggtttgtaccgacgggagttcgcgagcggcgcccctgccggcccgtggcccgggaaggctgtcggcctcgcctcgcggattctgagtattcccacttcgaaatatgtgacggactccgccgtcgaccaagtggccgaggccatcgcggcgggccgccaacacctcacacaggacaggtgagaccccccatgtcatccttcgcacttctgctccgcggcctgccgaactccggcaagacgaccactgccgcgctgcttcgcaacgccttgaagccgtccgtccggatctccaacgactcggtgcgctacatggcacagccccgggatttcagcgacttcactctcgtcgcctccgagctcggctgcctggatctcgcctcctcatacctggagagcggcttcgtacccgtgatcgacggcgtgttcgaggacgtcgacttcctgtccgcgcagaagctgcgcttccacaggaagggtatgcggctgatcgtcatcaccctggagggaagtctttccgatctgctcgaccgaaacgcctcccgcgatccgctggcccggatggaggaggaccggatgcgtgagctccacgcccagttccgaccgagcggaatcgtcctgtcccttgacgggaagcagcccgaagaggtggcggacgacgtattggacctcctggacttgcagcccccgtaccagggcgaggcagctgaccagggagcggccgacattctcttcctgcgccacggtgctcccgagtaccccagtgacatctaccccgatccctatgcgatgggtctgtccgagcaaggcattgacgaggcccgcgtggcgcgcgccgctgtggagcggttcgcacccgagatcgtctacacgtccgacttccgtcgtgcggagcagactgcctcgctggtgaccgcgacgatcgatgtcacgccccagcccgaacaccggctgcgggagcgggtcttccatcagctcgccggcgtagagctcgacgaggtccgctcacagcttggcgctgaggcggatgcggtcctcgggggcaacagcgatctgtgcgagcgggaggaggaggaatcctacgaggcggcgcgagcccgggtgctcggcttcttcgacgaggtggccgagcggcacgccggccggcgggtcctggtcgtcggccacggcggaccgcacgcatggctggtggagcgggcgcttggcgccgagatgcgaggcgtgcgccgcatgcgctgggacacgggtcacttctcgcggttcaaggtcacgcccaaccaggtcgcactggactacctcaaccggtcaccggaagacatcacgcgatgaccgacgcaaaggacgcgaccacgaccgcctcggatccacgacgacggccacgggtcgccgtggtggccacccccttcggcttcggtcctgcctcgaaggcgtacagcatcggcgaagtcctgcgcacccattggggtgtggacgtccagtactacggaacggactccgcccgcgacttcttctccgcgcagcccgatgtgaggcccctggcgccggaggcggtcggtggcaccggagcgatcgacgccgtgctgaacgtgctggctccggatctgatccgaagttccgaggaggcagcccggacgtactacgtcgacagcctcggcttcatgtggcagccctcggacattccggacggcagtctgctcacaagggtgcatcggtacttcgcccaggacgtcttcggcagcgttgaccatctcaccgcgctcgggatcaccggagtgactcccgtctcgggaatcgtcgccgaaacagcgccgaccgacatctcgccgggcccacgctccgtgaggcggctgctcgtccagctcggcggcctgagcaacccggccgggcgctcttccggagaggtctacctcgcactcgccgcgggactgctcacggctctgcggcaggacccgtacgaactgagcattgccatgaaccgcgcgggcggcacgttctccctggggtcgctcggccaggcccgccagttgtccggccgcgacttccaccgtgaactggccacctgcgccggtgtcctcagctcacccggcatgaccaccctcatcgaggtgtcgcgcgccaagtgcccctatgttcccttaccgcctcaaaactggagccaagtattaatatcgcgccatatggcgcgacattcacgcctggggatctgggactttctgatcggtccgtacgccacggtggacgcccgtgcccccgaggctcagaaggcggcccaggtgggggagatcaaccagttgctggcgggggacaccggctacacgacggcctatgtggacctggcccggacggcactggccgaagctcgagtacccgacgtgggggcaccgttcgacggggcgcatgtcgtggccgcctccatcgcagacgatctcatcaagggcacatcgcgttgcgggcggggctcgcgtacggagttgaaggaccacggcacaccgaccggtgaactctgaagaaaagggattccgatgacgcagcacatcgacagcggcctcgtggccgtgcttcagtcgctcgcgcacgaggtggaaaccgcgcgcgagtggagccaggcatcgcagacgctggcacaggagcgggtggccactgtcttcggctcggcccgtacgcgccgcggcgaaccggcgtacaccctggcgtatgaactcgccacggcactggccgcggcgaagtggaccacgatcaccggcggtggccccggcatcatgcaggccgcgcgggacggcagtggggagggcttgtcccgagcggtgcgggtggggatcccccggtgaggaacccgacaccgtgctggacccgtccaggtccatcaccgtcgcgaccttcgcactgcgcaagttactcctgacccacgacatcgacgctctgttcgtcttccccggtggtgtcggcaccttcgacgagctgtacgaggtgctggtccaccaggacaccaaccgacttgcctggttcccggtcgtcctgatgcagccggccggtgagagtctctggtcggcctggctggagttcatggagaagcacttggtcagcacgggactggccagctcctccgtgatcaagcggctggttgtggccgagtcggtggaagaggccctggcagccgccgaggggccgcgtacgacggcctgcggaacgagcggttctccgtcgcccggaacacgtcacggggcgaccggaaagtgactgccaccgaggacgaccggcctcacagccaggcagatacaaggccgcctggtgccgcacaggtccgcatcagcgtgatcattccaacgttcaacgcccgcaccactctgcgatgctgtcttctctcgctcctccaccagaggttcggcgttcacggatcggacgcggggcctccgttcacgtacgaggtcatcgtcgtggacgacggttcctccgacggcacaagcgaaatgatcgcccagttcccctcccgactcgacctgcggtacaccttcctgcctcgaacggacagatcgggtcgggcccgggcacggaatgccggtctggctctcgccacgggaggccttgtggtgacgctcgacgccgaccaagtggtggagccccactttcttgccgaacacgcccggctgcacgcaggcggccccggccgtgttgtcgcaggccggcgtctccaactcgccgacgggccaatggacgaggcgcgcctggagcacgggttcgacccgcaggccctcccaccggtggtccggggcgacgagcgggagcagctgttccgtctcctcgacagctccctggaggacatggtgaccggctggcaccacgtctggacctgcaacgcctccttcccccgggacaggcttgaggcggtcgggggcttcgacgagacgttcaccggctgggggctggaggacgctgaactcgcctatcggctggtgcagggcggtgcaaccacgcacttcgccccgtcggcggtggtccgccacgagcaccgcacaccggtaacagccgacatgtaccgggagtggtgccgcaacctggcccacttcgtgcgccgacatcccgcaccggaggtgcggctccaggagatattcgctcccgccatcgaccccgaccggtccgcaccgggaacgtgggacgacatcgccgccgagttcgagcacacggctcgccggctcggcgctgaccccggccagcatcggtagccgccatgaccggttccgttgctgtggcagcacccgctcatgtgccgcagcagcggaacccccctggaccacactgagaggaggcgattcaccgccatgcccacccctgcgggaaacgtccccgaccatctcgccccgaccgtccgccgggtcgtctatctgccggtcaaccgccccttcgaggcggcattccactccgtggccgccgaagtggcatcgttggagaagagccagcgagacaacgtcaccctcctcgtcgtcgacgactgcgcgccgccggtgtcacgggccaaccgccaggtgaccgagcgggtagcccgtgaatcgggcctgcgcgtacacacactggaccaacaggcctggcgtcgtctggccaccacactgatcgcggctgccgggctgaccggggccgaccgagccacggcgcagaccgccctggtcaaacccaccggttcctacggggcaggtcccaacaaggccgccctggtcgccgccctggaaggtgcggtctccctgcatcgccgggacagcgaccagatcacgaccgtagaccccgacaccggagcctctccgctccgtctggaagccgacctcctcagtcgcgcccgccccgagggcggcgctgcggcctactgcgcaggctccttcctcacgggtcgcccaacgcgagaccgaagggacctggaacgcgactcgacggagtacgcggcccgtatcgacgcgctgagccaactcccctccgccccggcccgacgcccacctctcccgcctgtccgggaacgggcggcgctcctgggagggcagcacgccgagcgcgacctgacaggtgtggtcgagatggggatcgcagccatgcgaagcgtgtacgagtggattccagagatgcccgccgtgggcatcctcggcagcgactacttccagaagggactgctctatcagctcgacctcccggtcttccaccacagcctcccagcccggcacacctacgaatcctggcgcacggagcagcgcgacgattcccatctggcctggtacgtgcgggcggaggtgcgctacgccgtactgcgccgccactggaacagcttcaaccacctgctcgtggccgaacgggcgcgtgtgctgtccgatgggcacttcgactcccgggcttacggagagctgttcgtcgaagcgctccacgagggcgcccggggggcggaaagcattcccgacgacttcgtggccgtataccgcgacgccgcgaacgcggccactggcgaggtccgccggcgtcttctggtgcggctggccggactggaagaggagaccggtgctgtcaacgcatacgtggccggcgccatccacgaattcgccgccctctcacgtctgtggcccggattgatctctgccgcacaacgggtcgggaggacgaccgcgctggagacgtttacccactga

SEQ ID NO: 77 - protein, 399 aa, Streptomyces puniceus
MLLLLSVLVIEVTGSAASAPLVIAAGALPALLLVRWVRSVNRLLDHRWVMILSDTGAFAVALALFLLSQADVQAWQIYCGVALFSGFGAFYLPAMRGWVADQSGDITQLTWLNSMLAVATQASVVVGWALGGVLASTVGISFALGLCAIAYACGIVLQFVVFVVVNRTPLRRDAAPVAGPGERRRSSAKEVPETAMRQEGGAWRTVFSPRRLGLFTGSLLAMELSHVLAFSMFVPLVTQASADRSWVAGLANACFALAAIGSGVLVSGGSLGNWVRSHAPGVLIAGFAVQTVFGLSASQTVLAVALYTLVGVLSGGDTVLQSEVQDRWRSVGSSQAFAVFGAVSGPSQLVGSLVIAFLLLHFSITAVYVGTIMILGFGSALLLVVARAKSINPVEEVIP

SEQ ID NO: 78 - protein, 213 aa, Streptomyces puniceus
MHLVIAKHLSDVESLLFSADGIGPNASQKSLIALHTTLTPEVVRDLHTRMGDTHGHMLVDAALSRRGGAVREGSLSLFVGAGDEAFAVARPVFDRYADNVVHAGDVGAGMTVKLCNNWLLYANRHSALQAIRTGRQLGVDPAVLTDALASSTGSSWALSHYSDLDEAIVTGRGAPAVIRDRTASELGMAKQMAARDGVVPTSLQETFALLDVM

SEQ ID NO: 79 - protein, 143 aa, Streptomyces puniceus
MEAADPCEFDFARAVVGQSEAAVAERRAAGLRLRHVEGAVRCLAAVDAEGVLRGQAFVLRDRHTAILMHQWFDRTGPRGTPTLLVDSAVVQTLESPGVISFDFEGSVIPGIDRFMAGFGAQAVGYGQFRWQQDGREEPAGRFG

SEQ ID NO: 80 - protein, 304 aa, Streptomyces puniceus
MQQSPAYARAVGESGRDVLVVMGHRGVFPLQLGSDVCTALGGDRPLLADCTVPLPLVALVAAAADATGLPVYLPLVDASLAEAGVVDAFSVWERPPNSLIDWSLDGADLWDRVTERGGSQWSRKQRLVERDGLNLSFGRSGEAAAEEVLRIDDRSWKSARGQNMRAREGQDRLYAGLIGAGVLTATFLRDGDHSVAFRLDSRVKGRLTCLKWSYDESYRRYSPGVHLLTQGLRQEWCGRGIEVVDLHGSPDSLKDLLCTDRMSRVDLWYGDPLAGARRAAERTGFDRRMRAVRDGGKGLRHAFE

SEQ ID NO: 81 - protein, 326 aa, Streptomyces puniceus
MERPDEGAKGFAGAADHVTVGAAVTELTRRMAQPAVEFTASGTAALEAALEVLGIGRGDEVVVPDVGCHSVAAAVVRRGAIPVFTGVGEALTLDPLGVSLACGPRTRAVVAVHQYGLPCDVPGIMKTVGPDIPVIEDVAQTWGSAVGGAPAGSLGTIAVISFGSTKPVALGAGGALFGPASLIRGAVSRGDGADRQLLRPPSAARFPAPLLARLPEALARADRLLASRRAAVEAFLRGPLAQELRLPPTPSGSSSGWTRTPLYPIAPATSVTAEQVERLEACHGPVQRMHATPPSALPMFRGSTTRVTGGGRRLTEPLLVKMGSPR

SEQ ID NO: 82 - protein, 397 aa, Streptomyces puniceus
MTARNLTTRAGVINPHQLFDLSQEDTDSFSHLKSVLADGQLFRYVESDRESANTLVERHFAEHFRKERAVAVANGTVGLRLALRALGIGPGHRVAVNAYAFIACAMAISATGAEPVPVDMGGSVLSMDADALEKSVGHLDAVLLVHVQGHALAAGPIRAVCDRLGIPMIEDVCQALGAGSSEAGAGRVGDVAVTSFQQAKQISSGEGGLVAGPDEVIERVYRLSDLGAVRQENGLPDWDHEDALIGDNLRMTELQAALVMDQAVRLEDTLARQRERRSRLRAGLSDIPVIESENPADDAGSHTLVLARDTAAAEEFRVELARRGVLARPVWKKSWVEYGLYRREFASGAPAGPWPGKAVGLASRILSIPTSKYVTDSAVDQVAEAIAAGRQHLTQDR

SEQ ID NO: 83 - protein, 378 aa, Streptomyces puniceus
MSSFALLLRGLPNSGKTTTAALLRNALKPSVRISNDSVRYMAQPRDFSDFTLVASELGCLDLASSYLESGFVPVIDGVFEDVDFLSAQKLRFHRKGMRLIVITLEGSLSDLLDRNASRDPLARMEEDRMRELHAQFRPSGIVLSLDGKQPEEVADDVLDLLDLQPPYQGEAADQGAADILFLRHGAPEYPSDIYPDPYAMGLSEQGIDEARVARAAVERFAPEIVYTSDFRRAEQTASLVTATIDVTPQPEHRLRERVFHQLAGVELDEVRSQLGAEADAVLGGNSDLCEREEEESYEAARARVLGFFDEVAERHAGRRVLVVGHGGPHAWLVERALGAEMRGVRRMRWDTGHFSRFKVTPNQVALDYLNRSPEDITR

SEQ ID NO: 84 - protein, 393 aa, Streptomyces puniceus
MTDAKDATTTASDPRRRPRVAVVATPFGFGPASKAYSIGEVLRTHWGVDVQYYGTDSARDFFSAQPDVRPLAPEAVGGTGAIDAVLNVLAPDLIRSSEEAARTYYVDSLGFMWQPSDIPDGSLLTRVHRYFAQDVFGSVDHLTALGITGVTPVSGIVAETAPTDISPGPRSVRRLLVQLGGLSNPAGRSSGEVYLALAAGLLTALRQDPYELSIAMNRAGGTFSLGSLGQARQLSGRDFHRELATCAGVLSSPGMTTLIEVSRAKCPYVPLPPQNWSQVLISRHMARHSRLGIWDFLIGPYATVDARAPEAQKAAQVGEINQLLAGDTGYTTAYVDLARTALAEARVPDVGAPFDGAHVVAASIADDLIKGTSRCGRGSRTELKDHGTPTGEL

SEQ ID NO: 85 - protein, 101 aa, Streptomyces puniceus
MTQHIDSGLVAVLQSLAHEVETAREWSQASQTLAQERVATVFGSARTRRGEPAYTLAYELATALAAAKWTTITGGGPGIMQAARDGSGEGLSRAVRVGIPR

SEQ ID NO: 86 - protein, 131 aa, Streptomyces puniceus
MLDPSRSITVATFALRKLLLTHDIDALFVFPGGVGTFDELYEVLVHQDTNRLAWFPVVLMQPAGESLWSAWLEFMEKHLVSTGLASSSVIKRLVVAESVEEALAAAEGPRTTACGTSGSPSPGTRHGATGK

SEQ ID NO: 87 - protein, 170 aa, Streptomyces puniceus
MDEARLEHGFDPQALPPVVRGDEREQLFRLLDSSLEDMVTGWHHVWTCNASFPRDRLEAVGGFDETFTGWGLEDAELAYRLVQGGATTHFAPSAVVRHEHRTPVTADMYREWCRNLAHFVRRHPAPEVRLQEIFAPAIDPDRSAPGTWDDIAAEFEHTARRLGADPGQHR

SEQ ID NO: 88 - protein, 446 aa, Streptomyces puniceus
MPTPAGNVPDHLAPTVRRVVYLPVNRPFEAAFHSVAAEVASLEKSQRDNVTLLVVDDCAPPVSRANRQVTERVARESGLRVHTLDQQAWRRLATTLIAAAGLTGADRATAQTALVKPTGSYGAGPNKAALVAALEGAVSLHRRDSDQITTVDPDTGASPLRLEADLLSRARPEGGAAAYCAGSFLTGRPTRDRRDLERDSTEYAARIDALSQLPSAPARRPPLPPVRERAALLGGQHAERDLTGVVEMGIAAMRSVYEWIPEMPAVGILGSDYFQKGLLYQLDLPVFHHSLPARHTYESWRTEQRDDSHLAWYVRAEVRYAVLRRHWNSFNHLLVAERARVLSDGHFDSRAYGELFVEALHEGARGAESIPDDFVAVYRDAANAATGEVRRRLLVRLAGLEEETGAVNAYVAGAIHEFAALSRLWPGLISAAQRVGRTTALETFTH

SEQ ID NO: 89 - DNA, 1200 bp, Streptomyces puniceus
atgcttctgctgctgtccgttctggtgatcgaggtgacgggttcggcggccagtgctcctttggtcatcgctgccggcgcactgcctgcgctgcttctggtgcgctgggtgcggagcgtcaaccgtctcctggaccatcgctgggtgatgatcctctcggacacaggagctttcgcagtcgcgctggctctcttcctgctgtcgcaggccgacgtccaagcctggcagatctactgcggcgtcgccttgttctccggcttcggcgccttctacctgcccgcaatgcgtggctgggtggccgaccagtcgggcgacatcacccaactcacgtggctcaactcgatgctggcggtggctacgcaggcgtccgtcgtcgtcgggtgggcgcttgggggtgttctggcaagcacggtcgggatcagcttcgctctggggctgtgcgccatcgcctacgcatgcggcatcgtgctgcagttcgtcgtatttgttgtggtcaaccggacgccgctacgtcgggacgctgcaccggtggccggcccgggagagcggcggcgttcttcggcgaaggaggtgccggagacggccatgcggcaggagggcggtgcgtggcgcacggtcttctcgccgcgcaggctcggtctgttcactggctcgttgctcgcgatggagctcagccatgtgctggctttcagtatgtttgtcccacttgtcactcaggcttccgccgaccgatcctgggtggcgggcctggccaacgcatgtttcgccctggcggcgatcggcagcggagtgctcgtctccggaggatcactcggcaactgggtgcgcagccacgcaccaggagtcctcatcgccggtttcgctgtgcagacggtgttcggactcagcgcgagtcagaccgtcctggccgttgccctctacacgctggtcggtgtgctcagcggcggggacaccgtgctgcagagtgaggtgcaggatcgctggcggagtgtcgggtcctcccaggcgttcgccgttttcggcgctgtgtccggaccttcccaactggtcggctccttggtcattgcttttctgctcctgcacttctcgatcaccgccgtctatgtcggaacaatcatgattctgggattcggttcggcgctccttctggtcgtggcgagagcgaagtcgataaatcctgtggaagaagtcatcccgtag

SEQ ID NO: 90 - DNA, 642 bp, Streptomyces puniceus
gtgcacctggtcatcgcgaagcacctttccgacgtggagtcacttctcttctccgccgacgggataggcccgaatgcttctcaaaagtccctgatcgcgctgcacaccacactcaccccggaggttgtgcgggacctgcacacccggatgggggacacccacggacacatgctggtggatgccgcgctcagccgccgcggcggtgctgtgcgcgagggttcgttgtccctgttcgtcggggcaggagacgaggccttcgccgtagcccggccggtcttcgaccgctacgccgacaacgtcgtccacgccggagacgtcggtgccggcatgacggtcaagctctgcaacaactggctgctctacgcgaatcggcactccgcactccaggccatccgaacgggccgtcagctcggcgtggacccggctgtgctcacggacgcgctcgcctcctccaccggatccagctgggccctgtctcactactccgacctggacgaagccatcgtcaccgggcggggcgcaccagcggtcatccgggacaggacggcttcggagctcggtatggcgaagcagatggcggcacgggatggtgtggtgcccaccagccttcaggagaccttcgctcttctggacgtgatgtag

SEQ ID NO: 91 - DNA, 432 bp, Streptomyces puniceus
gtggaggccgcagatccgtgtgagttcgacttcgctcgcgccgtcgtcggccagtccgaggcggctgttgcggaacggagggccgccggactgcggctccgccacgtcgagggggcggtccgctgtctcgcggcggtcgacgccgaaggcgtcctgcgcggacaggcgttcgtcctgcgggaccgtcacaccgcgatactcatgcaccagtggttcgatcgcaccgggccgcgcgggacaccgactctgctggtcgacagtgcggtcgtacagacactggagtcacccggcgtgatctcttttgattttgaaggaagtgtcattccgggcatcgatcgcttcatggccggcttcggcgcgcaggccgtcggttacgggcagttccgctggcagcaggatgggcgggaagagcctgccgggaggttcgggtga

SEQ ID NO: 92 - DNA, 915 bp, Streptomyces puniceus
gtgcagcagtcgcccgcgtacgcccgtgcggtcggcgagtcggggcgggacgtccttgtggtgatgggccaccggggggtgttcccgttgcagctgggctcggacgtgtgcacagcgcttggcggcgaccggccgctcctcgcggactgcaccgtccccctgcccctggttgctctggtggccgcggccgcagatgccaccgggctccctgtctacctccctctggtggacgcttcgctggccgaggcaggagtcgtggacgcgttcagcgtgtgggagcggccacccaattcgctgatcgactggtcgctcgacggcgccgacctgtgggatcgcgtgaccgagcgcggtggttcacagtggagcaggaaacagcggctcgtcgagcgggacggcctgaatctgtctttcggccggtcgggcgaggcggccgccgaggaggtcctgcggatcgatgaccgctcgtggaagtccgcccgcgggcagaacatgcgtgcgcgagagggccaggacaggttgtacgccggtctgatcggggcaggggtgctcaccgctaccttcctgcgggacggcgaccactctgtcgccttccggctggactcccgggtcaaaggccgcctgacctgcttgaaatggtcgtatgacgagtcctaccggcggtactcacccggtgtccatctgctcacgcaggggctgcgccaggagtggtgcgggcgcggcatagaggtggtcgatctgcacggaagtcccgactcgctgaaggacctgttgtgcaccgaccggatgagccgcgtggacctctggtacggcgacccgctggccggcgcgcggcgtgcggccgagcggaccggcttcgacaggcggatgagggcggtccgtgacggcgggaaggggttgcgccatgccttcgagtga

SEQ ID NO: 93 - DNA, 981 bp, Streptomyces puniceus
gtggaacggcccgacgaaggcgccaagggcttcgctggtgcggccgaccacgtcacggtcggtgcagccgtcacggaactgacccgtcgtatggcccagcccgccgtcgagttcaccgcctccggtaccgccgctctcgaagcggccctggaggtgctgggcatcggacggggcgatgaagtggtggtgcctgacgtgggatgtcactcggtggccgccgccgtcgtgcgacggggagcgatcccggtgttcacgggagtgggggaagccctgacgctcgatcccctgggagtttccctggcctgcggcccacgcacccgcgctgtcgtcgccgtgcaccagtacggactgccctgtgatgtgcccggcatcatgaagacggtggggccggacatcccggtgatcgaggatgtcgcccagacctggggatcggcggtgggcggtgccccggccggttcgcttgggaccatcgccgtcatctctttcggttcgaccaagccggtggcgctcggcgcgggcggagcgctcttcgggccggcttcactgatccgcggagcggtctcccgcggcgatggagcggaccggcagctgcttcgccctcccagtgccgctcggttccccgcccctctgctggcccgtcttcccgaagccttggcaagggccgaccggttgctggcctcgcgtcgggcagcggtggaagcctttctccgtgggccgctggcccaggagttgcgtctgcctccgacgccatccggctcctcctccggatggacccgcacccctctgtatccgatcgcccccgcgacctcggtcacggccgaacaggtggagcggctggaggcgtgtcacggaccggttcagcgcatgcacgcgacgccgccgtcggcgctgccgatgttccgcggaagcacgacgcgtgtgacaggcggaggccgtcggctcaccgaacccctactcgtgaagatgggatcaccacgatga

SEQ ID NO: 94 - DNA, 1194 bp, Streptomyces puniceus
atgactgcaaggaacctgacgacccgagcgggcgtcatcaaccctcaccagctcttcgacctttcccaggaggacaccgactccttcagccacctgaagagcgtgctcgccgacggacagctcttccgctacgtcgagagcgaccgggaatcggcgaacaccttggtcgaacggcacttcgccgagcacttccgcaaggagagggcagtggccgtggccaatggcaccgtaggcctgcgcctggccctgcgtgcgctgggcatcggccccggtcaccgagtggcggtcaatgcctacgccttcatcgcgtgtgccatggcgatatcggcgaccggcgccgagccggtgccggtcgacatgggcggatccgtcctgagcatggacgccgacgctctggagaagagcgtgggccacctcgatgcggtcctcctggtgcacgtccagggccacgcccttgcggccggtccgatacgtgccgtctgcgaccggctcggtataccgatgatcgaggacgtgtgccaggcgctgggagctggttcgtcagaggcgggcgccggccgcgtgggtgacgtcgctgtgacgagcttccagcaggccaagcagatctcctcgggtgaaggcggactcgttgccgggcccgatgaggtgatcgaacgggtctaccgcctgtcggatctgggagcggtgcgccaggagaacggtctgccggactgggaccacgaggatgccctgatcggtgacaacctgcggatgaccgagcttcaggcggcccttgtcatggatcaggccgtgcggctggaggacacgctggcccggcagcgggagcggcggtcacggctgcgggccgggctcagtgatatccccgtcatcgagagcgagaacccggccgatgacgccggatcgcacacgcttgtcctggcccgggataccgcggcggcggaggagttccgcgttgagctcgcacgccgcggggtgctggcccggccggtctggaagaagagctgggtggaatacggtttgtaccgacgggagttcgcgagcggcgcccctgccggcccgtggcccgggaaggctgtcggcctcgcctcgcggattctgagtattcccacttcgaaatatgtgacggactccgccgtcgaccaagtggccgaggccatcgcggcgggccgccaacacctcacacaggacaggtga

SEQ ID NO: 95 - DNA, 1137 bp, Streptomyces puniceus
atgtcatccttcgcacttctgctccgcggcctgccgaactccggcaagacgaccactgccgcgctgcttcgcaacgccttgaagccgtccgtccggatctccaacgactcggtgcgctacatggcacagccccgggatttcagcgacttcactctcgtcgcctccgagctcggctgcctggatctcgcctcctcatacctggagagcggcttcgtacccgtgatcgacggcgtgttcgaggacgtcgacttcctgtccgcgcagaagctgcgcttccacaggaagggtatgcggctgatcgtcatcaccctggagggaagtctttccgatctgctcgaccgaaacgcctcccgcgatccgctggcccggatggaggaggaccggatgcgtgagctccacgcccagttccgaccgagcggaatcgtcctgtcccttgacgggaagcagcccgaagaggtggcggacgacgtattggacctcctggacttgcagcccccgtaccagggcgaggcagctgaccagggagcggccgacattctcttcctgcgccacggtgctcccgagtaccccagtgacatctaccccgatccctatgcgatgggtctgtccgagcaaggcattgacgaggcccgcgtggcgcgcgccgctgtggagcggttcgcacccgagatcgtctacacgtccgacttccgtcgtgcggagcagactgcctcgctggtgaccgcgacgatcgatgtcacgccccagcccgaacaccggctgcgggagcgggtcttccatcagctcgccggcgtagagctcgacgaggtccgctcacagcttggcgctgaggcggatgcggtcctcgggggcaacagcgatctgtgcgagcgggaggaggaggaatcctacgaggcggcgcgagcccgggtgctcggcttcttcgacgaggtggccgagcggcacgccggccggcgggtcctggtcgtcggccacggcggaccgcacgcatggctggtggagcgggcgcttggcgccgagatgcgaggcgtgcgccgcatgcgctgggacacgggtcacttctcgcggttcaaggtcacgcccaaccaggtcgcactggactacctcaaccggtcaccggaagacatcacgcgatga

SEQ ID NO: 96 - DNA, 1182 bp, Streptomyces puniceus
atgaccgacgcaaaggacgcgaccacgaccgcctcggatccacgacgacggccacgggtcgccgtggtggccacccccttcggcttcggtcctgcctcgaaggcgtacagcatcggcgaagtcctgcgcacccattggggtgtggacgtccagtactacggaacggactccgcccgcgacttcttctccgcgcagcccgatgtgaggcccctggcgccggaggcggtcggtggcaccggagcgatcgacgccgtgctgaacgtgctggctccggatctgatccgaagttccgaggaggcagcccggacgtactacgtcgacagcctcggcttcatgtggcagccctcggacattccggacggcagtctgctcacaagggtgcatcggtacttcgcccaggacgtcttcggcagcgttgaccatctcaccgcgctcgggatcaccggagtgactcccgtctcgggaatcgtcgccgaaacagcgccgaccgacatctcgccgggcccacgctccgtgaggcggctgctcgtccagctcggcggcctgagcaacccggccgggcgctcttccggagaggtctacctcgcactcgccgcgggactgctcacggctctgcggcaggacccgtacgaactgagcattgccatgaaccgcgcgggcggcacgttctccctggggtcgctcggccaggcccgccagttgtccggccgcgacttccaccgtgaactggccacctgcgccggtgtcctcagctcacccggcatgaccaccctcatcgaggtgtcgcgcgccaagtgcccctatgttcccttaccgcctcaaaactggagccaagtattaatatcgcgccatatggcgcgacattcacgcctggggatctgggactttctgatcggtccgtacgccacggtggacgcccgtgcccccgaggctcagaaggcggcccaggtgggggagatcaaccagttgctggcgggggacaccggctacacgacggcctatgtggacctggcccggacggcactggccgaagctcgagtacccgacgtgggggcaccgttcgacggggcgcatgtcgtggccgcctccatcgcagacgatctcatcaagggcacatcgcgttgcgggcggggctcgcgtacggagttgaaggaccacggcacaccgaccggtgaactctga

SEQ ID NO: 97 - DNA, 306 bp, Streptomyces puniceus
atgacgcagcacatcgacagcggcctcgtggccgtgcttcagtcgctcgcgcacgaggtggaaaccgcgcgcgagtggagccaggcatcgcagacgctggcacaggagcgggtggccactgtcttcggctcggcccgtacgcgccgcggcgaaccggcgtacaccctggcgtatgaactcgccacggcactggccgcggcgaagtggaccacgatcaccggcggtggccccggcatcatgcaggccgcgcgggacggcagtggggagggcttgtcccgagcggtgcgggtggggatcccccggtga

SEQ ID NO: 98 - DNA, 396 bp, Streptomyces puniceus
gtgctggacccgtccaggtccatcaccgtcgcgaccttcgcactgcgcaagttactcctgacccacgacatcgacgctctgttcgtcttccccggtggtgtcggcaccttcgacgagctgtacgaggtgctggtccaccaggacaccaaccgacttgcctggttcccggtcgtcctgatgcagccggccggtgagagtctctggtcggcctggctggagttcatggagaagcacttggtcagcacgggactggccagctcctccgtgatcaagcggctggttgtggccgagtcggtggaagaggccctggcagccgccgaggggccgcgtacgacggcctgcggaacgagcggttctccgtcgcccggaacacgtcacggggcgaccggaaagtga

SEQ ID NO: 99 - DNA, 513 bp, Streptomyces puniceus
atggacgaggcgcgcctggagcacgggttcgacccgcaggccctcccaccggtggtccggggcgacgagcgggagcagctgttccgtctcctcgacagctccctggaggacatggtgaccggctggcaccacgtctggacctgcaacgcctccttcccccgggacaggcttgaggcggtcgggggcttcgacgagacgttcaccggctgggggctggaggacgctgaactcgcctatcggctggtgcagggcggtgcaaccacgcacttcgccccgtcggcggtggtccgccacgagcaccgcacaccggtaacagccgacatgtaccgggagtggtgccgcaacctggcccacttcgtgcgccgacatcccgcaccggaggtgcggctccaggagatattcgctcccgccatcgaccccgaccggtccgcaccgggaacgtgggacgacatcgccgccgagttcgagcacacggctcgccggctcggcgctgaccccggccagcatcggtag

SEQ ID NO: 100 - DNA, 1341 bp, Streptomyces puniceus
atgcccacccctgcgggaaacgtccccgaccatctcgccccgaccgtccgccgggtcgtctatctgccggtcaaccgccccttcgaggcggcattccactccgtggccgccgaagtggcatcgttggagaagagccagcgagacaacgtcaccctcctcgtcgtcgacgactgcgcgccgccggtgtcacgggccaaccgccaggtgaccgagcgggtagcccgtgaatcgggcctgcgcgtacacacactggaccaacaggcctggcgtcgtctggccaccacactgatcgcggctgccgggctgaccggggccgaccgagccacggcgcagaccgccctggtcaaacccaccggttcctacggggcaggtcccaacaaggccgccctggtcgccgccctggaaggtgcggtctccctgcatcgccgggacagcgaccagatcacgaccgtagaccccgacaccggagcctctccgctccgtctggaagccgacctcctcagtcgcgcccgccccgagggcggcgctgcggcctactgcgcaggctccttcctcacgggtcgcccaacgcgagaccgaagggacctggaacgcgactcgacggagtacgcggcccgtatcgacgcgctgagccaactcccctccgccccggcccgacgcccacctctcccgcctgtccgggaacgggcggcgctcctgggagggcagcacgccgagcgcgacctgacaggtgtggtcgagatggggatcgcagccatgcgaagcgtgtacgagtggattccagagatgcccgccgtgggcatcctcggcagcgactacttccagaagggactgctctatcagctcgacctcccggtcttccaccacagcctcccagcccggcacacctacgaatcctggcgcacggagcagcgcgacgattcccatctggcctggtacgtgcgggcggaggtgcgctacgccgtactgcgccgccactggaacagcttcaaccacctgctcgtggccgaacgggcgcgtgtgctgtccgatgggcacttcgactcccgggcttacggagagctgttcgtcgaagcgctccacgagggcgcccggggggcggaaagcattcccgacgacttcgtggccgtataccgcgacgccgcgaacgcggccactggcgaggtccgccggcgtcttctggtgcggctggccggactggaagaggagaccggtgctgtcaacgcatacgtggccggcgccatccacgaattcgccgccctctcacgtctgtggcccggattgatctctgccgcacaacgggtcgggaggacgaccgcgctggagacgtttacccactga

(19) United States
(12) Patent Application Publication
(10) Pub. No.: US 2014/0105862 A1
(43) Pub. Date: Apr. 17, 2014

(54) STREPTOMYCES MICROFLAVUS STRAINS AND METHODS OF THEIR USE TO CONTROL PLANT DISEASES AND PESTS

(71) Applicant: Bayer CropScience LP, Research Triangle Park, NC (US)

(72) Inventors: Brian CAMPBELL, Davis, CA (US); Damian CURTIS, Davis, CA (US); Shaohua GUAN, Davis, CA (US); Magalie GUILHABERT-GOYA, Davis, CA (US); Daniel M. JOO, Davis, CA (US); Tara LU, Woodland, CA (US); Jonathan S. MARGOLIS, Davis, CA (US); Reed Nathan ROYALTY, Davis, CA (US); Gerardo Bueno SALAZAR, Davis, CA (US); David SESIN, Benicia, CA (US); Frisby Davis SMITH, Dixon, CA (US); Colleen TAYLOR, Folsom, CA (US); Hong ZHU, West Sacramento, CA (US)

(73) Assignee: Bayer CropScience LP, Research Triangle Park, NC (US)

(21) Appl. No.: 14/052,094

(22) Filed: Oct. 11, 2013

Related U.S. Application Data
(60) Provisional application No. 61/712,626, filed on Oct. 11, 2012.
(60) Provisional application No. 61/714,267, filed on Oct. 16, 2012.
(60) Provisional application No. 61/718,674, filed on Oct. 25, 2012.
(60) Provisional application No. 61/734,541, filed on Dec. 7, 2012.
(60) Provisional application No. 61/759,955, filed on Feb. 1, 2013.
(60) Provisional application No. 61/759,977, filed on Feb. 1, 2013.
(60) Provisional application No. 61/879,601, filed on Sep. 18, 2013.

(30) Foreign Application Priority Data
Feb. 7, 2013 (EP) EP13154355.5

(51) Int. Cl. A01N 63/02; A01N 43/54

(52) U.S. Cl. CPC A01N 63/02; A01N 43/54
USPC 424/93.2; 424/93.43; 424/780; 435/252.35; 435/253.5

(57) ABSTRACT

The present invention relates to novel strains of Streptomyces microflavus and methods of their use for controlling diseases or pests of a plant. The invention also relates to a fermentation broth obtained by cultivating a gougerotin producing Streptomyces strain, wherein the fermentation broth contains at least about 1 g/L gougerotin. The invention also relates to a method of producing a fermentation broth of a gougerotin producing Streptomyces strain, wherein the fermentation broth contains at least about 1 g/L gougerotin, the method comprising cultivating the Streptomyces strain in a culture medium containing a digestible carbon source and a digestible nitrogen source under aerobic conditions, wherein the culture medium contains an amino acid at a concentration effective to achieve a gougerotin concentration of at least 1 g/L. The present disclosure also relates to the molecular cloning of a gougerotin biosynthetic gene cluster from Streptomyces microflavus, and identification of individual genes in the gene cluster as well as the proteins encoded thereby. A gougerotin gene cluster comprising 13 open reading frames (ORFs) is located within a genetic locus of Streptomyces microflavus.

### FIELD OF INVENTION

The present invention relates to the field of bacterial strains and their ability to control plant diseases and pests.

### REFERENCE TO SEQUENCE LISTING SUBMITTED ELECTRONICALLY

The official copy of the sequence listing is submitted electronically via EFS-Web as an ASCII-formatted sequence listing with a file named “250-US_ST25.txt” created on Oct. 10, 2013, and having a size of 175 kilobytes, and is filed concurrently with the specification. The sequence listing contained in this ASCII-formatted document is part of the specification and is herein incorporated by reference in its entirety.

### BACKGROUND OF INVENTION

Phytophagous mites, especially spider mites, are a major agricultural pest of orchards, greenhouses and many vegetable and fruit crops, including peppers, tomatoes, potatoes, squash, eggplant, cucumber and strawberries. Mites damage leaf and/or fruit surfaces using their sharp mouthparts. Besides direct damage to plant parts (referred to as stippling), mite feeding also causes increased susceptibility to plant diseases.

Mites are acari rather than insects, and few broad spectrum insecticides are also effective against mites. Characteristics of mites and of available miticides pose challenges to mite control. For example, spider mites, one of the most economically important families of mites, generally live on the undersides of leaves of plants, such that they are difficult to treat. Further, mites are known to develop resistance to presently available miticides, many of which have a single mode of action, within two to four years. Few available miticides have activity against mite eggs, making repeat applications necessary. Therefore, there is a need for new miticides having translaminar, ovicidal and strong residual activities in addition to good knockdown activity.

### SUMMARY OF INVENTION

The present invention provides the Streptomyces microflavus strain NRRL B-50550 or a phytophagous-miticidal mutant (strain) derived therefrom. In one embodiment, the phytophagous-miticidal and/or fungicidal mutant strain is Streptomyces microflavus strain M.

The present invention also provides the Streptomyces puniceus strain A or a phytophagous-miticidal and/or fungicidal mutant (strain) derived therefrom.

The present invention also provides a composition containing Streptomyces microflavus strain NRRL B-50550 or a phytophagous-miticidal and/or fungicidal mutant (strain) derived therefrom. In one aspect, the composition is a fermentation product of the Streptomyces microflavus strain NRRL B-50550 or a phytophagous-miticidal and/or fungicidal mutant strain derived therefrom. The present invention also provides a composition containing Streptomyces puniceus strain A or a phytophagous-miticidal and/or fungicidal mutant (strain) derived therefrom. In one aspect, the composition is a fermentation product of the Streptomyces puniceus strain A or a phytophagous-miticidal and/or fungicidal mutant strain derived therefrom.

The present invention also provides a fermentation product obtained by cultivating a gougerotin producing Streptomyces strain, wherein the fermentation product contains at least about 1 g/L gougerotin.

Also provided is a fermentation broth containing at least about 1 g/L gougerotin. In one embodiment the fermentation broth has not been subjected to any downstream processing. In a particular embodiment the fermentation broth is from a Streptomyces strain. Types of Streptomyces strains that are suitable for the invention are described in detail herein.

Also provided is a fermentation product of a gougerotin-producing Streptomyces strain, wherein the fermentation product comprises at least about 1 g/L gougerotin. In one embodiment the fermentation product is a fermentation broth. Also provided is a fermentation broth containing at least about 1 g/L, at least about 2 g/L, at least about 3 g/L, at least about 4 g/L, at least about 5 g/L, at least about 6 g/L, at least about 7 g/L or at least about 8 g/L gougerotin. In one embodiment, the fermentation broth contains gougerotin in a concentration of about 1 g/L to about 15 g/L. In one embodiment the gougerotin-producing Streptomyces strain is S. microflavus, S. griseus, S. anulatus, S. fimicarius, S. parvus, S. lavendulae, S. alboviridis, S. puniceus, or S. graminearus. In another the gougerotin-producing Streptomyces strain comprises a nucleic acid sequence encoding an amino acid sequence having at least about 80% sequence identity, at least about 85% sequence identity, at least about 90% sequence identity, or at least about 95% sequence identity to at least one amino acid sequence selected from the group consisting of SEQ ID NO: 2, SEQ ID NO:4, SEQ ID NO: 6, SEQ ID NO: 10, SEQ ID NO: 12, SEQ ID NO: 14, SEQ ID NO: 16, SEQ ID NO: 18, SEQ ID NO: 22, SEQ ID NO: 24, SEQ ID NO: 26, SEQ ID NO: 28, SEQ ID NO: 30, and SEQ ID NO: 42. In one instance, the gougerotin-producing Streptomyces strain comprises a nucleic acid sequence encoding an amino acid sequence having at least about 80% sequence identity, at least about 85% sequence identity, at least about 90% sequence identity, or at least about 95% sequence identity to all amino acid sequences selected from the group consisting of SEQ ID NO: 2, SEQ ID NO:4, SEQ ID NO: 6, SEQ ID NO: 10, SEQ ID NO: 12, SEQ ID NO: 14, SEQ ID NO: 16, SEQ ID NO: 18, SEQ ID NO: 22, SEQ ID NO: 24, SEQ ID NO: 26, SEQ ID NO: 28, SEQ ID NO: 30, and SEQ ID NO: 42. In another instance, the gougerotin-producing Streptomyces strain comprises a nucleic acid sequence encoding an amino acid sequence having at least about 80% sequence identity, at least about 85% sequence identity, at least about 90% sequence identity, or at least about 95% sequence identity to all amino acid sequences selected from the group consisting of SEQ ID NO: 2, SEQ ID NO:4, SEQ ID NO: 6, SEQ ID NO: 10, SEQ ID NO: 12, SEQ ID NO: 14, SEQ ID NO: 16, SEQ ID NO: 18, SEQ ID NO: 22, SEQ ID NO: 24, SEQ ID NO: 26, SEQ ID NO: 28, and SEQ ID NO: 30. In another, the gougerotin-producing Streptomyces strain comprises a nucleic acid sequence encoding an amino acid sequence having at least about 80% sequence identity, at least about 85% sequence identity, at least about 90% sequence identity, or at least about 95% sequence identity to all amino acid sequences selected from the group consisting of SEQ ID NO:4, SEQ ID NO: 6, SEQ ID NO: 10, SEQ ID NO: 12, SEQ ID NO: 14, SEQ ID NO: 16, SEQ ID NO: 18, SEQ ID NO: 22, SEQ ID NO: 24, SEQ ID NO: 26, SEQ ID NO: 28, and SEQ ID NO: 30. In another embodiment, the gougerotin-producing Streptomyces strain comprises a nucleic acid sequence encoding an amino acid sequence having at least about 80% sequence identity, at least about 85% sequence identity, at least about 90% sequence identity, or at least about 95% sequence identity to at least one amino acid sequence selected from the group consisting of SEQ ID NO: 77, SEQ ID NO: 78, SEQ ID NO: 79, SEQ ID NO: 80, SEQ ID NO: 81, SEQ ID NO: 82, SEQ ID NO: 83, SEQ ID NO: 84, SEQ ID NO: 85, SEQ ID NO: 86, SEQ ID NO: 87, and SEQ ID NO: 88. In one instance, the gougerotin-producing Streptomyces strain comprises a nucleic acid sequence encoding an amino acid sequence having at least about 80% sequence identity, at least about 85% sequence identity, at least about 90% sequence identity, or at least about 95% sequence identity to all amino acid sequence selected from the group consisting of SEQ ID NO: 77, SEQ ID NO: 78, SEQ ID NO: 79, SEQ ID NO: 80, SEQ ID NO: 81, SEQ ID NO: 82, SEQ ID NO: 83, SEQ ID NO: 84, SEQ ID NO: 85, SEQ ID NO: 86, SEQ ID NO: 87, and SEQ ID NO: 88. In yet another embodiment the gougerotin-producing Streptomyces strain is Streptomyces microflavus strain NRRL B-50550 or a phytophagous-miticidal and/or fungicidal mutant strain derived therefrom. In another it is Streptomyces puniceus strain A or a phytophagous-miticidal mutant strain derived therefrom. In yet another it is Streptomyces microflavus strain M.

The present invention also provides a method of producing a fermentation broth of a gougerotin producing Streptomyces strain, wherein the fermentation broth contains at least about 0.5 g/L gougerotin, the method comprising cultivating the Streptomyces strain in a culture medium containing a digestible carbon source and a digestible nitrogen source under aerobic conditions, wherein the culture medium contains an amino acid at a concentration effective to achieve a gougerotin concentration of at least 0.5 g/L. The present invention also provides a method of producing a fermentation broth of a gougerotin producing Streptomyces strain, wherein the fermentation broth contains at least about 1 g/L gougerotin, the method comprising cultivating the Streptomyces strain in a culture medium containing a digestible carbon source and a digestible nitrogen source under aerobic conditions, wherein the culture medium contains an amino acid at a concentration effective to achieve a gougerotin concentration of at least 1 g/L. The present invention also provides a method of treating a plant to control a plant disease or pest, wherein the method comprises applying the Streptomyces microflavus strain NRRL B-50550 or a phytophagous-miticidal mutant strain derived therefrom, to the plant, to a part of the plant and/or to a locus of the plant. In one embodiment, a fermentation product of the strain or a fermentation product of a mutant derived therefrom is applied to the plant and/or to a locus of the plant.

The present invention also provides a method of treating a plant to control a plant disease or pest, wherein the method comprises applying a Streptomyces microflavus strain, including the Streptomyces microflavus strain NRRL-50550 or a phytophagous-miticidal mutant strain derived therefrom, to the plant, to a part of the plant and/or to a locus of the plant. In one embodiment, a fermentation product of the strain or a fermentation product of a mutant derived therefrom is applied to the plant and/or to a locus of the plant.

The invention also provides for a method of controlling phytophagous acari or insects comprising applying to a plant or to soil surrounding the plant a Streptomyces microflavus strain, including the Streptomyces microflavus strain NRRL B-50550 or a phytophagous-miticidal strain derived therefrom. In one embodiment, a fermentation product of the strain or a fermentation product of a mutant derived therefrom is applied to the plant and/or to a locus of the plant.

Also provided is a method of producing a fermentation broth of a gougerotin producing Streptomyces strain, wherein the fermentation broth contains at least about 1 g/L gougerotin, the method comprising cultivating the Streptomyces strain in a culture medium containing a digestible carbon source and a digestible nitrogen source under aerobic conditions, wherein the culture medium contains an amino acid at a concentration effective to achieve a gougerotin concentration of at least 1 g/L. In one embodiment, the Streptomyces strain is cultivated in the culture medium until the culture medium contains gougerotin in a concentration of at least about 2 g/L, of at least about 3 g/L, of at least about 4 g/L, of at least about 5 g/L, of at least about 6 g/L, of at least about 7 g/L or of at least about 8 g/L gougerotin. In another, the Streptomyces strain is cultivated in the culture medium until the culture medium contains gougerotin in a concentration ranging from about 1 g/L to about 15 g/L gougerotin.

In one embodiment of said method of producing a fermentation broth, the amino acid is selected from the group consisting of glycine, glutamic acid, glutamine, serine and mixtures thereof. In one instance, the culture medium contains the amino acid in an initial concentration of at least about 2 g/L. In a particular instance, the culture medium contains glycine at an initial concentration and/or glutamic acid at an initial concentration of about 5 g/L to about 15 g/L.

The culture medium, as described above, contains, in one embodiment, as carbon source a mixture of glucose and an oligosaccharide. In one instance, the oligosaccharide is maltodextrin or dextrin. In a particular instance, the initial maltodextrin concentration in the culture medium is about 50 g/L to about 100 g/L. In another, the initial maltodextrin concentration is about 60 g/L to about 80 g/L.

In one embodiment, the initial glucose concentration in the culture medium is about 20 g/L to 60 g/L or about 30 g/L to about 50 g/L.

In one embodiment, the culture medium contains calcium carbonate at an initial concentration of about 1 g/L to 3 g/L.

In one embodiment, the nitrogen source is at least partially selected from the group consisting of soy peptone, soy acid hydrolysate, soy flour hydrolysate, casein hydrolysate, yeast extract, and mixtures thereof.

Any of the gougerotin-producing Streptomyces strains described above may be used to practice this method.

Also provided is a method of enhancing gougerotin levels in a fermentation broth of a gougerotin-producing Streptomyces strain comprising cultivating the Streptomyces strain in a culture medium containing a digestible carbon source and a digestible nitrogen source under aerobic conditions, wherein the culture medium contains an amino acid at a concentration effective to achieve a gougerotin concentration that is at least two times greater than the gougerotin concentration achieved in a culture medium that contains less than about 1 g/L, about 2 g/L, about 3 g/L, about 4 g/L, about 5 g/L, about 6 g/L, about 7 g/L, about 8 g/L, about 9 g/L, or about 10 g/L, of one or more amino acids. In one embodiment the amino acid used in the culture medium is glutamic acid, serine and/or glycine. In one embodiment, the amino acid concentration in the culture medium used to obtain an enhanced level of gougerotin (i.e., the enhanced culture medium) is about 2 g/L to about 15 g/L and the gougerotin concentration achieved is at least two times that achieved in a starting culture medium, where, in one embodiment, the starting culture medium contains no more than about ½ the concentration of amino acids contained in the enhanced culture medium.

Any of the gougerotin-producing Streptomyces strains described above may be used to practice this method.

The present invention also provides the gougerotin biosynthetic gene cluster from Streptomyces microflavus (specifically from Streptomyces microflavus NRRL B-50550) the characterization of the individual genes in the gene cluster, and the proteins encoded thereby. A gougerotin gene cluster from Streptomyces microflavus is disclosed, the gene cluster comprising 14 open reading frames (ORFs) referred to as ORFs 4251 to 4253, 4255 to 4259, 4261 to 4265, and 4271, respectively (SEQ ID NOs: 1, 3, 5, 9, 11, 13, 15, 17, 21, 23, 25, 27, 29, and 41 respectively), and referred to herein as GouA, GouB, GouC, GouD, GouE, GouF, GouG, GouH, GouI, GouJ, GouK, GouL, GouM, and GouN, respectively. The corresponding proteins are provided at SEQ ID NOs: 2, 4, 6, 10, 12, 14, 16, 18, 22, 24, 26, 28, 30, and 42, respectively. The genomic DNA sequence comprising the gougerotin biosynthetic gene cluster from Streptomyces microflavus and some of the flanking regions is provided in SEQ ID NO: 43, and describes the locations of genes GouA through GouN.

The present invention also provides the partial gougerotin biosynthetic gene cluster from Streptomyces puniceus (specifically from Streptomyces puniceus strain A), the characterization of individual genes in the gene cluster, and the proteins encoded thereby. A partial gougerotin gene cluster from Streptomyces puniceus is disclosed, the disclosed gene cluster comprising 12 open reading frames (ORFs) referred to as ORFs, respectively (SEQ ID NOs: 89-100, respectively), and referred to herein as GouB, GouC, GouD, GouE, GouF, GouG, GouH, GouI, GouJ, GouK, GouL, GouM, respectively. These are orthologous to the genes provided in SEQ ID NOs: 3, 5, 9, 11, 13, 15, 17, 21, 23, 25, 27, and 29, respectively, and referred to herein as GouB, GouC, GouD, GouE, GouF, GouG, GouH, GouI, GouJ, GouK, GouL, and GouM, respectively. The corresponding proteins are provided at SEQ ID NOs: 77-88, respectively. The genomic DNA sequence comprising the gougerotin biosynthetic gene cluster from Streptomyces puniceus is provided in SEQ ID NO: 76.

Also provided is nucleic acid sequence having at least 70% sequence identity to the nucleotide sequence of SEQ ID NO: 43, operably linked to at least one exogenous and/or heterologous regulatory element for directing expression of said sequence. The nucleic acid sequence may further comprise the nucleotide sequence of position 10820 to position 12013 of SEQ ID NO: 43, and/or may further comprise the nucleotide sequence of position 13219 to position 14334 of SEQ ID NO: 43. Said nucleic acid sequence may be isolated from S. microflavus, S. griseus, S. anulatus, S. fimicarius, S. parvus, S. lavendulae, S. alboviridis, S. puniceus, or S. graminearus.

Also provided is a host cell comprising any one of the nucleic acid sequences described herein, including in the immediately preceding paragraph. Also provided is an expression vector comprising any one of said nucleic acid sequences, as well as a host cell comprising said vector.

A method for producing a gougerotin or gougerotin analog is provided, comprising: cultivating a gougerotin or gougerotin-producing bacterium of the Streptomyces genus in a medium to produce and excrete said gougerotin or gougerotin analog into the medium, and collecting said gougerotin or gougerotin analog from the medium, wherein said bacterium has been modified to enhance expression of a nucleic acid sequence having at least 70% sequence identity to the nucleotide sequence of SEQ ID NO: 43. The bacterium may be selected from the group consisting of S. microflavus, S. griseus, S. anulatus, S. fimicarius, S. parvus, S. lavendulae, S. alboviridis, S. puniceus, and S. graminearus.

A method for preparing a gougerotin or gougerotin analog is provided, comprising the following steps: a) constructing a recombinant expression vector containing the nucleic acid sequence of SEQ ID NO: 43, further containing the nucleotide sequence of position 10820 to position 12013 of SEQ ID NO: 43, and/or further containing the nucleotide sequence of position 13219 to position 14334 of SEQ ID NO: 43; b) transforming a host cell with the expression vector containing the nucleic acid sequence of step a) to produce a transformant; c) culturing the transformant of step b); and d) isolating and purifying said gougerotin or gougerotin analog from the culture product of the transformant of step c).

A transgenic prokaryotic cell is provided, comprising a nucleic acid sequence encoding an amino acid sequence having at least 70% sequence identity to at least one amino acid sequence selected from the group consisting of SEQ ID NO: 2, SEQ ID NO: 4, SEQ ID NO: 6, SEQ ID NO: 10, SEQ ID NO: 12, SEQ ID NO: 14, SEQ ID NO: 16, SEQ ID NO: 18, SEQ ID NO: 22, SEQ ID NO: 24, SEQ ID NO: 26, SEQ ID NO: 28, SEQ ID NO: 30, and SEQ ID NO: 42. In another embodiment a transgenic prokaryotic cell is provided, comprising a nucleic acid sequence encoding an amino acid sequence having at least 75% sequence identity, at least 80% sequence identity, at least 85% sequence identity, at least 90% sequence identity, at least 95% sequence identity, or at least 99% sequence identity to at least one amino acid sequence selected from the group consisting of SEQ ID NO: 2, SEQ ID NO: 4, SEQ ID NO: 6, SEQ ID NO: 10, SEQ ID NO: 12, SEQ ID NO: 14, SEQ ID NO: 16, SEQ ID NO: 18, SEQ ID NO: 22, SEQ ID NO: 24, SEQ ID NO: 26, SEQ ID NO: 28, SEQ ID NO: 30, and SEQ ID NO: 42.

A transgenic prokaryotic cell is also provided, comprising a nucleic acid sequence encoding an amino acid sequence having at least 70% sequence identity to at least one amino acid sequence selected from the group consisting of SEQ ID NO: 77, SEQ ID NO: 78, SEQ ID NO: 79, SEQ ID NO: 80, SEQ ID NO: 81, SEQ ID NO: 82, SEQ ID NO: 83, SEQ ID NO: 84, SEQ ID NO: 85, SEQ ID NO: 86, SEQ ID NO: 87, SEQ ID NO: 88. In another embodiment, a transgenic prokaryotic cell is provided, comprising a nucleic acid sequence encoding an amino acid sequence having at least 70% sequence identity, at least 80% sequence identity, at least 85% sequence identity, at least 90% sequence identity, at least 95% sequence identity, or at least 99% sequence identity, to at least one amino acid sequence selected from the group consisting of SEQ ID NO: 77, SEQ ID NO: 78, SEQ ID NO: 79, SEQ ID NO: 80, SEQ ID NO: 81, SEQ ID NO: 82, SEQ ID NO: 83, SEQ ID NO: 84, SEQ ID NO: 85, SEQ ID NO: 86, SEQ ID NO: 87, SEQ ID NO: 88.

Also provided is a nucleic acid sequence having at least 70% sequence identity to a nucleic acid sequence selected from the group consisting of SEQ ID NO: 1, SEQ ID NO: 3, SEQ ID NO: 5, SEQ ID NO: 9, SEQ ID NO: 11, SEQ ID NO: 13, SEQ ID NO: 15, SEQ ID NO: 17, SEQ ID NO: 21, SEQ ID NO: 23, SEQ ID NO: 25, SEQ ID NO: 27, SEQ ID NO: 29, and SEQ ID NO: 41, further comprising a nucleic acid sequence comprising an exogenous restriction enzyme cleavage site.

### BRIEF DESCRIPTION OF THE DRAWINGS

FIG. 1 shows the results of UV stability tests with bacterial candidate strains, when diluted fermentation products of the strains were sprayed on leafs of lima bean plants infested with two spotted spider mites. The columns in light gray (lower column for each strain) represent the antimiticidal activity without UV light irradiation, the columns in dark gray (upper column for each strain) represent the antimiticidal activity after irradiation with UV light for 24 hours. On the fifth day, plants were assessed for presence of mites and eggs on a scale of 1 to 4.

FIG. 2 shows the result of tests for translaminar activity of the bacterial candidate strains tested, when diluted fermentation products of the strains were sprayed on leafs of lima bean plants infested with two spotted spider mites. The columns in light gray (lower column for each strain) represent the translaminar (antimiticidal) activity, the columns in dark gray (upper column for each strain) represent the overall antimiticidal activity. On the sixth day, plants were assessed for presence of mites and eggs on a scale of 1 to 4.

FIG. 3 shows increased gougerotin production in mutants of Streptomyces microflavus strain NRRL B-50550 grown in 1 L shake flasks relative to the parent strain.

FIG. 4 shows increased gougerotin production in mutants of Streptomyces microflavus strain NRRL B-50550 grown in 5 L bioreactors relative to the parent strain.

FIG. 5 shows the chemical structure of gougerotin, as well as the serine, sugar, cytosine, and sarcosine subdomains thereof.

FIG. 6 shows a potential biosynthetic pathway for gougerotin.

FIG. 7 shows the chemical structure of gougerotin, annotated with the open reading frame (ORF) numbers potentially involved with and/or responsible for particular subdomain structure of gougerotin.

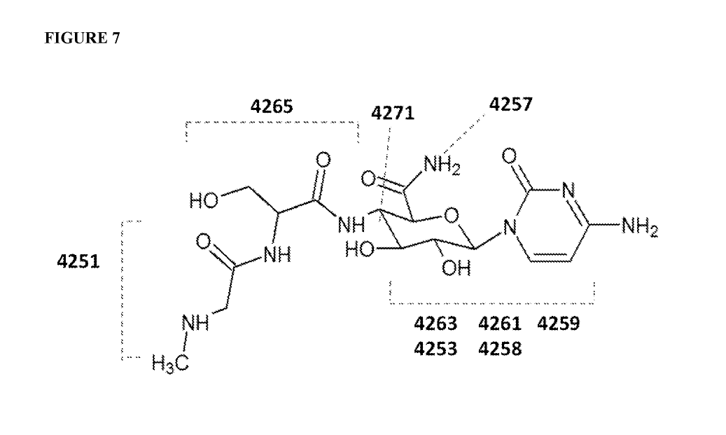

FIG. 8 shows the organization of the gougerotin biosynthetic gene cluster.

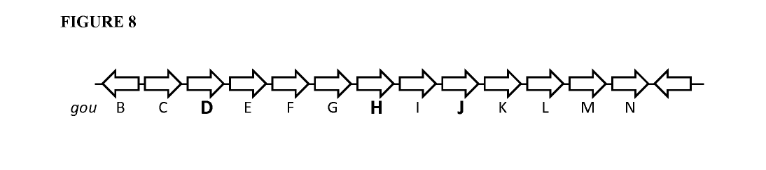

FIG. 9 shows PCR products of the named primer pairs (see Sequence Listing for primer pair names), resolved via agarose gel electrophoresis. MW=1 kDa molecular weight ladder. C=16S positive control. gouC1 is from primers of SEQ ID NOs: 44 and 45. gouC2 is from primers of SEQ ID NOs: 46 and 47. gouD is from primers of SEQ ID NOs: 48 and 49. gouG1 is from primers of SEQ ID NOs: 50 and 51. gouG2 is from primers of SEQ ID NOs: 52 and 53. gouI1 is from primers of SEQ ID NOs: 54 and 55. gouF2 is from primers of SEQ ID NOs: 56 and 57.

FIG. 10 is a schematic diagram of pUC118 vector.

FIG. 11 is a schematic diagram of pKC1139 shuttle vector.

FIG. 12 shows PCR products from PCR using different primer sets, resolved via agarose gel electrophoresis. I=gouI primer; G=gouG primer; Ia=single crossover with Apramycin resistance; IKI (with GouIup and gouIdown), CKW (with gouCup and gouwholeclusterdown), and CM (with gouCup and gouIdown) are all kanamycin-resistant double crossovers.

### SEQUENCE LISTINGS

TABLE 1

| SEQ ID NO: | DESCRIPTION |
|---|---|
| 1 | ORF 4251 (GouA); reverse complement of nuc. 4455 to 4880 of SEQ ID NO: 43 |
| 2 | amino acid sequence of ORF 4251 (SEQ ID NO: 1) |
| 3 | ORF 4252 (GouB); nuc. 6340 to 6801 of SEQ ID NO: 43 |
| 4 | amino acid sequence of ORF 4252 (SEQ ID NO: 3) |
| 5 | ORF 4253 (GouC); nuc. 7197 to 7712 of SEQ ID NO: 43 |
| 6 | amino acid sequence of ORF 4253 (SEQ ID NO: 5) |
| 7 | ORF 4254; reverse complement of nuc. 8130 to 8486 of SEQ ID NO: 43 |
| 8 | amino acid sequence of ORF 4254 (SEQ ID NO: 7) |
| 9 | ORF 4255 (GouD); nuc. 8589 to 8729 of SEQ ID NO: 43 |
| 10 | amino acid sequence of ORF 4255 (SEQ ID NO: 9) |
| 11 | ORF 4256 (GouE); nuc. 8912 to 9826 of SEQ ID NO: 43 |
| 12 | amino acid sequence of ORF 4256 (SEQ ID NO: 11) |
| 13 | ORF 4257 (GouF); nuc. 9827 to 10823 of SEQ ID NO: 43 |
| 14 | amino acid sequence of ORF 4257 (SEQ ID NO: 13) |
| 15 | ORF 4258 (GouG); nuc. 10820 to 12013 of SEQ ID NO: 43 |
| 16 | amino acid sequence of ORF 4258 (SEQ ID NO: 15) |
| 17 | ORF 4259 (GouH); nuc. 12020 to 13145 of SEQ ID NO: 43 |
| 18 | amino acid sequence of ORF 4259 (SEQ ID NO: 17) |
| 19 | ORF 4260; reverse complement of nuc. 13146 to 13265 of SEQ ID NO: 43 |
| 20 | amino acid sequence of ORF 4260 (SEQ ID NO: 19) |
| 21 | ORF 4261 (GouI); nuc. 13219 to 14334 of SEQ ID NO: 43 |
| 22 | amino acid sequence of ORF 4261 (SEQ ID NO: 21) |
| 23 | ORF 4262 (GouJ); nuc. 14350 to 15063 of SEQ ID NO: 43 |
| 24 | amino acid sequence of ORF 4262 (SEQ ID NO: 23) |
| 25 | ORF 4263 (GouK); nuc. 15411 to 16046 of SEQ ID NO: 43 |
| 26 | amino acid sequence of ORF 4263 (SEQ ID NO: 25) |
| 27 | ORF 4264 (GouL); nuc. 16142 to 17482 of SEQ ID NO: 43 |
| 28 | amino acid sequence of ORF 4264 (SEQ ID NO: 27) |
| 29 | ORF 4265 (GouM); nuc. 17549 to 19312 of SEQ ID NO: 43 |
| 30 | amino acid sequence of ORF 4265 (SEQ ID NO: 29) |
| 31 | ORF 4266; nuc. 19461 to 19574 of SEQ ID NO: 43 |
| 32 | amino acid sequence of ORF 4266 (SEQ ID NO: 31) |
| 33 | ORF 4267; nuc. 20147 to 20551 of SEQ ID NO: 43 |
| 34 | amino acid sequence of ORF 4267 (SEQ ID NO: 33) |
| 35 | ORF 4268 |
| 36 | amino acid sequence of ORF 4268 (SEQ ID NO: 35) |
| 37 | ORF 4269 |
| 38 | amino acid sequence of ORF 4269 (SEQ ID NO: 37) |
| 39 | ORF 4270 |
| 40 | amino acid sequence of ORF 4270 (SEQ ID NO: 39) |
| 41 | ORF 4271 |
| 42 | amino acid sequence of ORF 4271 (SEQ ID NO: 41) |
| 43 | nucleic acid sequence of a genetic locus comprising a gougerotin gene cluster |
| | (from Streptomyces microflavus) |
| 44 | Primer1F |
| 45 | Primer1R |
| 46 | Primer2F |
| 47 | Primer2R |
| 48 | Primer3F |
| 49 | Primer3R |
| 50 | Primer4F |
| 51 | Primer4R |
| 52 | Primer5F |
| 53 | Primer5R |
| 54 | Primer6F |
| 55 | Primer6R |
| 56 | Primer7F |
| 57 | Primer7R |
| 58 | Kan-F primer |
| 59 | Kan-R primer |
| 60 | gouL-1-F(−2056) primer |
| 61 | gouL-1-R(−880) primer |
| 62 | gouL-2-F(+522) primer |
| 63 | gouL-2-R(+2364) primer |
| 64 | gouH-1-F(−1827): primer |
| 65 | gouH-1-R(−845): primer |
| 66 | gouH-2-F(+1184): primer |
| 67 | gouH-2-R(+2985): primer |
| 68 | gouF-1-F(−1831): primer |
| 69 | gouF-1-R(−41): primer |
| 70 | gouF-2-F(+1126): primer |
| 71 | gouF-2-R(+2919): primer |
| 72 | gouWcluster-F(+4) primer |
| 73 | gouWcluster-R(+1897) primer |
| 74 | gouWcluster-F(−1373end) primer |
| 75 | gouWcluster-R(−92end) primer |
| 76 | Nucleic acid sequence of a genetic locus comprising a gougerotin gene cluster |
| | (from Streptomyces puniceus) |
| 77 | Amino acid sequence of ORF 4075 (GouB) |
| 78 | Amino acid sequence of ORF 4076 (GouC) |
| 79 | Amino acid sequence of ORF 4077 (GouD) |
| 80 | Amino acid sequence of ORF 4078 (GouE) |
| 81 | Amino acid sequence of ORF4079 (GouF) |
| 82 | Amino acid sequence of ORF 4080 (GouG) |
| 83 | Amino acid sequence of ORF 4081 (GouH) |
| 84 | Amino acid sequence of ORF 4082 (GouI) |
| 85 | Amino acid sequence of ORF4083 (GouJ) |
| 86 | Amino acid sequence of ORF4084 (GouK) |
| 87 | Amino acid sequence of ORF 4085 (GouL) |
| 88 | Amino acid sequence of ORF4086 (GouM) |
| 89 | ORF 4075 (GouB) |
| 90 | ORF4076 (GouC) |
| 91 | ORF4077 (GouD) |
| 92 | ORF 4078 (GouE) |
| 93 | ORF 4079 (GouF) |
| 94 | ORF 4080 (GouG) |
| 95 | ORF 4081 (GouH) |
| 96 | ORF 4082 (GouI) |
| 97 | ORF 4083 (GouJ) |
| 98 | ORF 4084 (GouK) |
| 99 | ORF4085 (GouL) |
| 100 | ORF 4086 (GouM) |

### DETAILED DESCRIPTION OF INVENTION

All publications, patents and patent applications, including any drawings and appendices, herein are incorporated by reference to the same extent as if each individual publication or patent application was specifically and individually indicated to be incorporated by reference.

The following description includes information that may be useful in understanding the present invention. It is not an admission that any of the information provided herein is prior art or relevant to the presently claimed inventions, or that any publication specifically or implicitly referenced is prior art.

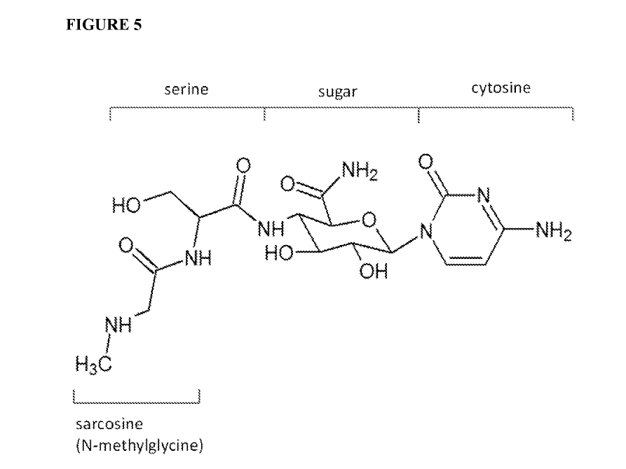

The present invention provides the Streptomyces microflavus strain NRRL B-50550 or a phytophagous-miticidal mutant strain derived therefrom. It has been found that the strain NRRL B-50550 has a variety of advantageous properties. Not only does the strain NRRL B-50550 (or its fermentation product) have acaricidal activity as such but, for example, also shows a high UV stability, a good translaminar activity, good ovicidal activity, long residual activity, drench activity as well as activity against a broad range of mites (see Example Section) and thus meets the requirements for an effective acaricide. In addition, the strain NRRL B-50550 (or its fermentation product) possesses both insecticidal activity and activity against various fungal phytopathogens such as leaf rust and mildew. This unique combination of activities makes the strain NRRL B-50550 a highly versatile candidate and renders the strain suitable to be broadly employed in methods of treating plants to control a plant disease and/or a plant pest. Such a broad range of activities and possible applications in agriculture has not yet been reported for known Streptomyces strains. In relation to a possible agricultural use, Streptomyces strains have been predominantly described in publications from the late 1960's and early 1970's. See, for example, the British Patent No. GB 1 507 193 that describes the Streptomyces rimofaciens strain No. B-98891, deposited as ATCC 31120, which produces the microbial compound B-98891. According to GB 1 507 193, filed March 1975, the microbial compound B-98891 is the active ingredient that provides antifungal activity of the Streptomyces rimofaciens strain No. B-98891 against powdery mildew. U.S. Pat. No. 3,849,398, filed Aug. 2, 1972, describes that the strain Streptomyces toyocaensis var. aspiculamyceticus produces the microbial compound aspiculamycin which is also known as gougerotin (see, Toru Ikeuchi et al., 25 J. Antibiotics 548 (September 1972). According to U.S. Pat. No. 3,849,398, gougerotin has parasiticidal action against parasites on animals, such as pin worm and the like, although gougerotin is said to show a weak antibacterial activity against gram-positive, gram-negative bacteria and tubercule bacillus. Similarly, Japanese Patent Application No. JP 53109998 (A), published 1978, reports the strain Streptomyces toyocaensis (LA-681) and its ability to produce gougerotin for use as miticide. However, it is to be noted that no miticidal fermentation product based on such Streptomcyes strains is commercially available. Thus, the Streptomyces microflavus strain NRRL B-50550 with its broad efficacy against acari (based on gougerotin production), fungi and insects and its favorable properties in terms of mode of action (e.g., translaminar activity and residual activity) represents a significant and unexpected advancement in terms of biological and advantageous properties which as such have not been reported for known Streptomyces strains. Applicant has solved the problem of producing a fermentation broth containing high concentrations of gougerotin, making feasible the ultimate use of the fermentation broth as a commercial pesticide or as a source of gougerotin for use as a commercial pesticide. Thus, this invention encompasses fermentation broths containing gougerotin at concentrations of at least about 0.5 g/L. In addition, this invention encompasses fermentation broths containing gougerotin at concentrations of at least about 1 g/L, at least about 2 g/L, at least about 3 g/L, at least about 4 g/L, at least about 5 g/L at least about 6 g/L, at least about 7 g/L or at least about 8 g/L or of at least about 1 mg/g, at least about 2 mg/g, at least about 3 mg/g, at least about 4 mg/g, at least about 5 mg/g, at least about 6 mg/g, at least about 7 mg/g or at least about 8 mg/g. In other embodiments the fermentation broth contains gougerotin in a concentration ranging from about 2 g/L to about 15 g/L, including in a concentration of about 3 g/L, of about 4 g/L, of about of about 5 g/L, of about 6 g/L, of about 7 g/L, of about 8 g/L, of about 9 g/L, of about of 10 g/L, of about 11 g/L, of about 12 g/L, of about 13 g/L, and of about 14 g/L or in a concentration ranging from about 2 mg/g to about 15 mg/g. In some embodiments the fermentation broths are from Streptomyces species. In specific embodiments, the fermentation broths are from Streptomyces microflavus. In still other specific embodiments, the fermentation broths are from Streptomyces microflavus NRRL-50550 or phytophagous-miticidal mutants derived therefrom. Additionally, Applicant has identified and manipulated the Streptomyces microflavus gene cluster responsible for gougerotin production. See structure of gougerotin below and in FIG. 5.

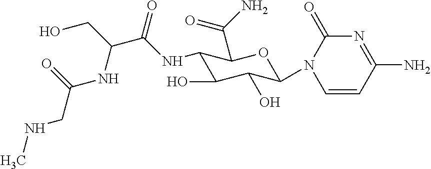 [SMILES: CNCC(=O)NC(CO)C(=O)NC1C(C(N)=O)OC(n2ccc(N)nc2=O)C(O)C1O]

The microorganisms and particular strains described herein, unless specifically noted otherwise, are all separated from nature (i.e., isolated) and grown under artificial conditions, such as in shake flask cultures or through scaled-up manufacturing processes, such as in bioreactors, as described herein. In one embodiment, a phytophagous-miticidal mutant strain of the Streptomyces microflavus strain NRRL B-50550 is provided. Streptomyces microflavus is a mesophilic, saprophytic bacterium belonging to the genus Streptomyces, found commonly in soil and decaying vegetation. NRRL B-50550 is a strain of Streptomyces microflavus that was isolated from soil in the continental United States of America. Streptomyces microflavus is an aerobic, Gram-positive, filamentous bacterium which produces well developed filamentous vegetative hyphae (˜1.0 μm wide and 10-100 μm long) and is capable of producing conidia—asexual spores. The hyphae consist of long, straight filaments, which bear beige, smooth spores at more or less regular intervals, arranged in whorls (verticils). Each branch of a verticil produces, at its apex, an umbel which carries from two to several chains of spores.

The term “mutant” refers to a genetic variant derived from Streptomyces microflavus strain NRRL B-50550. In one embodiment, the mutant has one or more or all the identifying (functional) characteristics of Streptomyces microflavus strain NRRL B-50550. In a particular instance, the mutant or a fermentation product thereof controls (as an identifying functional characteristic) mites at least as well as the parent Streptomyces microflavus NRRL B-50550 strain. In addition, the mutant or a fermentation product thereof may have one, two, three, four or all five of the following characteristics: translaminar activity in relation to the miticidal activity, residual activity in relation to the miticidal activity, ovicidal activity, insecticide activity, in particular against diabrotica, or activity against fungal phytopathogens, in particular against mildew and rust disease. Such mutants may be genetic variants having a genomic sequence that has greater than about 85%, greater than about 90%, greater than about 95%, greater than about 98%, or greater than about 99% sequence identity to Streptomyces microflavus strain NRRL B-50550. Mutants may be obtained by treating Streptomyces microflavus strain NRRL B-50550 cells with chemicals or irradiation or by selecting spontaneous mutants from a population of NRRL B-50550 cells (such as phage resistant or antibiotic resistant mutants) or by other means well known to those practiced in the art.

Suitable chemicals for mutagenesis of Streptomcyes microflavus include hydroxylamine hydrochloride, methyl methanesulfonate (MMS), ethyl methanesulfonate (EMS), 4-nitroquinoline 1-oxide (NQO), mitomycin C or N-methyl-N′-nitro-N-nitrosoguanidine (NTG), to mention only a few (cf., for example, Stonesifer & Baltz, Proc. Natl. Acad. Sci. USA Vol. 82, pp. 1180-1183, February 1985). The mutagenesis of Streptomyces strains by, for example, NTG, using spore solutions of the respective Streptomcyes strain is well known to the person skilled in the art. See, for example Delic et al, Mutation Research/Fundamental and Molecular Mechanisms of Mutagenesis, Volume 9, Issue 2, February 1970, pages 167-182, or Chen et al., J Antibiot (Tokyo), 2001 November; 54(11), pages 967-972.). In more detail, Streptomyces microflavus can be subjected to mutation by NTG using the protocol described in Kieser, T., et al., 2000, supra. Practical Streptomyces Genetics, Ch. 5 John Innes Centre, Norwich Research Park, England (2000), pp. 99-107. Mutagenesis of spores of Streptomyces microflavus by ultraviolet light (UV) can be carried out using standard protocols. For example, a spore suspension of the Streptomyces strain (freshly prepared or frozen in 20% glycerol) can be suspended in a medium that does not absorb UV light at a wave length of 254 nm (for example, water or 20% glycerol are suitable). The spore suspension is then placed in a glass Petri dish and irradiated with a low pressure mercury vapour lamp that emits most of its energy at 254 nm with constant agitation for an appropriate time at 30° C. (the most appropriate time of irradiation can be determined by first plotting a dose-survival curve). Slants or plates of non-selective medium can, for example, then be inoculated with the dense irradiated spore suspension and the so obtained mutant strains can be assessed for their properties as explained in the following. See Kieser, T., et al., 2000, supra.

The mutant strain can be any mutant strain that has one or more or all the identifying characteristics of Streptomyces microflavus strain NRRL B-50550 and in particular miticidal activity that is comparable or better than that of Streptomyces microflavus NRRL B-50550. The miticidal activity can, for example, be determined against two-spotted spider mites (“TSSM”) as explained in Example 2 herein, meaning culture stocks of the mutant strain of Streptomyces microflavus NRRL B-50550 can be grown in 1 L shake flasks in Media 1 or Media 2 of Example 2 at 20-30° C. for 3-5 days, and the diluted fermentation product can then be applied on top and bottom of lima bean leaves of two plants, after which treatment, plants can be infested on the same day with 50-100 TSSM and left in the greenhouse for five days.

Example 16 provides a specific example of a method for generating mutants of Streptomyces microflavus strain NRRL B-50550. One mutant generated by this method is Streptomyces microflavus strain M, which is described more fully in the examples. The gougerotin biosynthetic gene cluster of Streptomyces microflavus M has about 99% sequence identity to the gougerotin biosynthetic gene cluster of Streptomyces microflavus strain NRRL B-50550 (i.e., SEQ ID NO: 43).

In one aspect of the invention, the Streptomyces microflavus strain NRRL B-50550 or a phytophagous-miticidal mutant strain thereof has translaminar activity. The term “translaminar activity” is used herein in its regular meaning in the art and thus by “translaminar activity” is meant the ability of a compound or composition (here a composition such as a fermentation product containing the Streptomyces microflavus strain NRRL B-50550 or a mutant strain thereof) of moving through the leaf tissue of the plant to be treated. A translaminar compound/composition penetrates leaf tissues and forms a reservoir of active ingredient within the leaf. This translaminar activity therefore also provides residual activity against foliar-feeding insects and mites. Because the composition (or its one or more active ingredients) can move through leaves, thorough spray coverage is less critical to control acari such as mites, which normally feed on leaf undersides. The translaminar activity of a mutant strain alone or in comparison to Streptomyces microflavus NRRL B-50550 can, for example, be determined against two-spotted spider mites (“TSSM”) as explained in Example 6 herein. Translaminar activity can still be observed after several days (e.g., about 5 days) under the conditions of Example 6. In one aspect of the invention, translaminar activity can be observed (is present) at least about 1, 2, 3, 4, 5, 6, 7, 8, 9, and/or 10 days after treatment.

In another aspect of the invention, the Streptomyces microflavus strain NRRL B-50550 or a phytophagous-miticidal mutant strain thereof has residual activity. The term “residual activity” is used herein in its regular meaning in the art and thus by “residual activity” is meant the ability of a compound or composition (here a composition such as a fermentation product containing the Streptomyces microflavus strain NRRL B-50550 or a mutant strain thereof) to remain effective (i.e., cause greater mortality of mites or cause a reduction in the total number of mites, versus conditions where the compound or composition was not applied) for an extended period of time after it is applied. The length of time may depend on the formulation (dust, liquid, etc.), the type of plant or location and the condition of the plant surface or soil surface (wet, dry, etc.) to which a composition containing Streptomyces microflavus strain NRRL B-50550 or a mutant strain thereof is applied. The residual activity of a mutant strain alone or in comparison to Streptomyces microflavus NRRL B-50550 can, for example, be determined against two-spotted spider mites (“TSSM”) as explained in Example 2 or 7 herein and means, in relation to the miticidal effect, that an antimiticidal effect can still be observed after several days (e.g., about 12 days) under the conditions of Example 5. In one aspect of the invention, residual activity can be observed (is present) at least about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, and/or 40 days after treatment.

In another aspect of the invention, the Streptomyces microflavus strain NRRL B-50550 or a phytophagous-miticidal mutant strain thereof has ovicidal activity. The term “ovicidal activity” is used herein in its regular meaning in the art to mean “the ability of causing destruction or death of an ovum” and is used herein in relation to eggs of acari such as mites. The ovicidal activity of a mutant strain of Streptomyces microflavus NRRL B-50550 alone or in comparison to Streptomyces microflavus NRRL B-50550 can be determined using the method as described in Example 7. Ovicidal activity can still be observed after several days (e.g., about 5 days) under the conditions of Example 7. In one aspect of the invention, ovicidal activity can be observed (is present) at least about 1, 2, 3, 4, 5, 6, 7, 8, 9, and/or 10 days after treatment.

In another aspect of the invention, the Streptomyces microflavus strain NRRL B-50550 or a phytophagous-miticidal mutant strain thereof may have drench activity. The term “drench activity” is used herein in its regular meaning in the art to mean pesticidal activity that travels from soil or other growth media upward through the plant via the xylem. The drench activity of a mutant strain of Streptomyces microflavus NRRL B-50550 alone or in comparison to Streptomyces microflavus NRRL B-5055 can be determined using the method as described in Example 8. In one aspect of the invention, drench activity can still be observed (is present) after several days (e.g., about 2, 3, 4, 5, 6, 7, 8, 9, 10, or 11 days) under the conditions of Example 8.

In another aspect of the invention, the Streptomyces microflavus strain NRRL B-50550 or a phytophagous-miticidal mutant strain thereof has miticidal activity against a variety of mite species, including, as illustrated in the Examples, but not limited to, activity against two-spotted spider mites, activity against citrus rust mites (Phyllocoptruta oleivora), eriophyid (russet) mites and broad mites.

The Streptomyces microflavus strain NRRL B-50550 or a phytophagous-miticidal mutant strain thereof may thus have activity against a mite that is selected from the group consisting of clover mite, brown mite, hazelnut spider mite, asparagus spider mite, brown wheat mite, legume mite, oxalis mite, boxwood mite, Texas citrus mite, Oriental red mite, citrus red mite, European red mite, yellow spider mite, fig spider mite, Lewis spider mite, six-spotted spider mite, Willamette mite, Yuma spider mite, web-spinning mite, pineapple mite, citrus green mite, honey-locust spider mite, tea red spider mite, southern red mite, avocado brown mite, spruce spider mite, avocado red mite, Banks grass mite, carmine spider mite, desert spider mite, vegetable spider mite, tumid spider mite, strawberry spider mite, two-spotted spider mite, McDaniel mite, Pacific spider mite, hawthorn spider mite, four-spotted spider mite, Schoenei spider mite, Chilean false spider mite, citrus flat mite, privet mite, flat scarlet mite, white-tailed mite, pineapple tarsonemid mite, West Indian sugar cane mite, bulb scale mite, cyclamen mite, broad mite, winter grain mite, red-legged earth mite, filbert big-bud mite, grape erineum mite, pear blister leaf mite, apple leaf edgeroller mite, peach mosaic vector mite, alder bead gall mite, Perian walnut leaf gall mite, pecan leaf edgeroll mite, fig bud mite, olive bud mite, citrus bud mite, litchi erineum mite, wheat curl mite, coconut flower and nut mite, sugar cane blister mite, buffalo grass mite, bermuda grass mite, carrot bud mite, sweet potato leaf gall mite, pomegranate leaf curl mite, ash sprangle gall mite, maple bladder gall mite, alder erineum mite, redberry mite, cotton blister mite, blueberry bud mite, pink tea rust mite, ribbed tea mite, grey citrus mite, sweet potato rust mite, horse chestnut rust mite, citrus rust mite, apple rust mite, grape rust mite, pear rust mite, flat needle sheath pine mite, wild rose bud and fruit mite, dryberry mite, mango rust mite, azalea rust mite, plum rust mite, peach silver mite, apple rust mite, tomato russet mite, pink citrus rust mite, cereal rust mite, rice rust mite and combinations thereof. In addition, the Streptomyces microflavus strain NRRL B-50550 or a phytophagous-miticidal mutant strain thereof has activity against mites that are resistant to other mite control agents. In one embodiment, the strain has activity against abamectin-resistant mites.

In another aspect of the invention, the Streptomyces microflavus strain NRRL B-50550 or a phytophagous-miticidal mutant strain thereof may have also insecticide activity. The target insect may be a diabrotica. The Diabrotica may be banded cucumber beetle (Diabrotica balteata), Western spotted cucumber beetle (Diabrotica undecimpunctata undecimpunctata), or a corn rootworm such as Northern corn rootworm (Diabrotica barberi), Southern corn rootworm (Diabrotica undecimpunctata howardi), Western cucumber beetle (Diabrotica undecimpunctata tenella), Western corn rootworm (Diabrotica virgifera virgifera), Mexican corn rootworm (Diabrotica virgifera zeae) and combinations of such Diabrotica. The insecticidal activity of a mutant strain of Streptomyces microflavus NRRL B-50550 alone or in comparison to Streptomyces microflavus NRRL B-50550 can be determined against corn rootworm, using the method as described in Example 10.

In another aspect of the invention, the Streptomyces microflavus strain NRRL B-50550 or a phytophagous-miticidal mutant strain thereof has fungicide activity, meaning activity against a plant disease that is caused by a fungus. The plant disease may be mildew or a rust disease. Examples of mildew that can be treated with the Streptomyces microflavus strain NRRL B-50550 or a phytophagous-miticidal mutant strain thereof include, but are not limited to, powdery mildew, such as cucumber powdery mildew caused by Sphaerotheca fuliginea, or downy mildew, such as brassica downy mildew, caused by Peronospora parasitica. Examples of a rust disease that may be treated with Streptomyces microflavus strain NRRL B-50550 or a phytophagous-miticidal mutant strain thereof include, but are not limited to, wheat leaf rust caused by Puccinia triticina (also known as P. recondita), wheat stem rust caused by Puccinia grammis, wheat stripe rust caused by Puccinia striiformis, leaf rust of barley caused by Puccinia hordei, leaf rust of rye caused by Puccinia recondita, brown leaf rust, crown rust, and stem rust. The fungicidal activity of a mutant strain of Streptomyces microflavus NRRL B-50550 alone or in comparison to Streptomyces microflavus NRRL B-50550 can be determined against cucumber powdery mildew using the method as described in Example 9. Fungicidal activity can still be observed after several days (e.g., about 7 days) under the conditions of Example 9. In one aspect of the invention, fungicidal activity can be observed (is present) about 1, 2, 3, 4, 5, 6, 7, 8, 9, 10, 11, 12, 13, 14, and/or 15 days after treatment.

The present invention also provides a Streptomyces puniceus strain A or a phytophagous-miticidal and/or fungicidal mutant strain derived therefrom. Streptomyces puniceus is a member of the S. griseus clade of the Streptomyces bacterium. S. puniceus is an aerobic, gram positive, filamentous bacteria. It produces moderately long mature spore chains with 10 to more than 50 spores per chain. The spore texture is smooth and colony is yellowish to reddish in color when growing on oatmeal based agar. Streptomyces puniceus strain A was isolated from a soil sample collected in the continental United States of America. A fermentation product of strain A has miticidal properties, as described in Example 18. In one embodiment, a phytophagous-miticidal and/or fungicidal mutant strain of the Streptomyces puniceus strain A is provided. The term “mutant” refers to a genetic variant derived from Streptomyces puniceus strain A. In one embodiment, the mutant has one or more or all the identifying (functional) characteristics of Streptomyces puniceus strain A. In a particular instance, the mutant or a fermentation product thereof controls (as an identifying functional characteristic) mites at least as well as the parent Streptomyces puniceus strain A. Such mutants may be genetic variants having a genomic sequence that has greater than about 85%, greater than about 90%, greater than about 95%, greater than about 98%, or greater than about 99% sequence identity to Streptomyces puniceus strain A. Mutants may be obtained by treating Streptomyces puniceus strain A cells with chemicals or irradiation or by selecting spontaneous mutants from a population of A cells (such as phage resistant or antibiotic resistant mutants) or by other means well known to those practiced in the art, including those means described above and in Example 16 in reference to Streptomyces microflavus NRRL B-50550. Streptomyces puniceus strain A contains a gougerotin gene cluster that encodes proteins GouB-GouM and is anticipated to contain GouA. Proteins GouB-GouM of Streptomyces puniceus strain A have at least 90% sequence identity to the orthologous proteins from Streptomyces microflavus NRRL B-50550.

The present invention also encompasses methods of treating a plant to control plant pests and diseases by administering to a plant or a plant part, such as a leaf, stem, flowers, fruit, root, or seed or by applying to a locus on which plant or plant parts grow, such as soil, one or more of a gougerotin containing fermentation broth of Streptomcyes, the Streptomyces microflavus strain NRRL B-50550 or a phytophagous-miticidal or fungicidal mutant strain thereof or cell-free preparations thereof or metabolites thereof or the Streptomyces puniceus strain A or a phytophagous-miticidal mutant strain thereof or cell-free preparations thereof or metabolites thereof. Additional gougerotin-producing strains that are suitable for the methods and fermentation products of the present invention are described herein.

As used herein, the term “plant” refers to any living organism belonging to the kingdom Plantae (i.e., any genus/species in the Plant Kingdom). This includes familiar organisms such as but not limited to trees, herbs, bushes, grasses, vines, ferns, mosses and green algae. The term refers to both monocotyledonous plants, also called monocots, and dicotyledonous plants, also called dicots. The plant is in some embodiments of economic importance. In some embodiments the plant is a human-grown plant, for instance a cultivated plant, which may be an agricultural, a silvicultural or a horticultural plant. Examples of particular plants include but are not limited to corn, potatoes, roses, apple trees, sunflowers, wheat, rice, bananas, tomatoes, opo, pumpkins, squash, beans (e.g., lima beans), lettuce, cabbage, oak trees, guzmania, geraniums, hibiscus, clematis, poinsettias, sugarcane, taro, duck weed, pine trees, Kentucky blue grass, zoysia, coconut trees, brassica leafy vegetables (e.g., broccoli, broccoli raab, Brussels sprouts, cabbage, Chinese cabbage (Bok Choy and Napa), cauliflower, cavalo, collards, kale, kohlrabi, mustard greens, rape greens, and other brassica leafy vegetable crops), bulb vegetables (e.g., garlic, leek, onion (dry bulb, green, and Welch), shallot, and other bulb vegetable crops), citrus fruits (e.g., grapefruit, lemon, lime, orange, tangerine, citrus hybrids, pummelo, and other citrus fruit crops), cucurbit vegetables (e.g., cucumber, citron melon, edible gourds, gherkin, muskmelons (including hybrids and/or cultivars of cucumis melons), watermelon, cantaloupe, and other cucurbit vegetable crops), fruiting vegetables (including eggplant, ground cherry, pepino, pepper, tomato, tomatillo, and other fruiting vegetable crops), grape, leafy vegetables (e.g., romaine), root/tuber and corm vegetables (e.g., potato), lentils, alfalfa sprouts, clover and tree nuts (almond, pecan, pistachio, and walnut), berries (e.g., tomatoes, barberries, currants, elderberries, gooseberries, honeysuckles, mayapples, nannyberries, Oregon-grapes, see-buckthorns, hackberries, bearberries, lingonberries, strawberries, sea grapes, blackberries, cloudberries, loganberries, raspberries, salmonberries, thimbleberries, and wineberries), cereal crops (e.g., corn, rice, wheat, barley, sorghum, millets, oats, ryes, triticales, buckwheats, fonio, and quinoa), pome fruit (e.g., apples, pears), stone fruits (e.g., coffees, jujubes, mangos, olives, coconuts, oil palms, pistachios, almonds, apricots, cherries, damsons, nectarines, peaches and plums), vine (e.g., table grapes, wine grapes), fibber crops (e.g., hemp, cotton), ornamentals, to name a few. The plant may, in some embodiments, be a household/domestic plant, a greenhouse plant, an agricultural plant, or a horticultural plant. As already indicated above, in some embodiments the plant may a hardwood such as one of acacia, eucalyptus, hornbeam, beech, mahogany, walnut, oak, ash, willow, hickory, birch, chestnut, poplar, alder, maple, sycamore, ginkgo, a palm tree and sweet gum. In some embodiments the plant may be a conifer such as a cypress, a Douglas fir, a fir, a sequoia, a hemlock, a cedar, a juniper, a larch, a pine, a redwood, spruce and yew. In some embodiments the plant may be a fruit bearing woody plant such as apple, plum, pear, banana, orange, kiwi, lemon, cherry, grapevine, papaya, peanut, and fig. In some embodiments the plant may be a woody plant such as cotton, bamboo and a rubber plant. The plant may in some embodiments be an agricultural, a silvicultural and/or an ornamental plant, i.e., a plant which is commonly used in gardening, e.g., in parks, gardens and on balconies. Examples are turf, geranium, pelargonia, petunia, begonia, and fuchsia, to name just a few among the vast number of ornamentals. The term “plant” is also intended to include any plant propagules.

The term “plant” generally includes a plant that has been modified by one or more of breeding, mutagenesis and genetic engineering. Genetic engineering refers to the use of recombinant DNA techniques. Recombinant DNA techniques allow modifications which cannot readily be obtained by cross breeding under natural circumstances, mutations or natural recombination. In some embodiments a plant obtained by genetic engineering may be a transgenic plant.

As used herein, the term “plant part” refers to any part of a plant including but not limited to the shoot, root, stem, seeds, stipules, leaves, petals, flowers, ovules, bracts, branches, petioles, internodes, bark, wood, tubers, pubescence, tillers, rhizomes, fronds, blades, pollen, stamen, microspores, fruit and seed. The two main parts of plants grown in typical media employed in the art, such as soil, are often referred to as the “above-ground” part, also often referred to as the “shoots”, and the “below-ground” part, also often referred to as the “roots”.

In a method according to the invention a composition containing Streptomyces microflavus NRRL B-50550 or a phytophagous-miticidal mutant strain thereof can be applied to any plant or any part of any plant grown in any type of media used to grow plants (e.g., soil, vermiculite, shredded cardboard, and water) or applied to plants or the parts of plants grown aerially, such as orchids or staghorn ferns. The composition may for instance be applied by spraying, atomizing, vaporizing, scattering, dusting, watering, squirting, sprinkling, pouring or fumigating. As already indicated above, application may be carried out at any desired location where the plant of interest is positioned, such as agricultural, horticultural, forest, plantation, orchard, nursery, organically grown crops, turfgrass and urban environments.

Compositions of the present invention can be obtained by culturing Streptomyces microflavus NRRL B-50550 or mutants derived from it using conventional large-scale microbial fermentation processes, such as submerged fermentation, solid state fermentation or liquid surface culture, including the methods described, for example, in U.S. Pat. No. 3,849,398; British Patent No. GB 1 507 193; Toshiko Kanzaki et al., Journal of Antibiotics, Ser. A, Vol. 15, No. 2, June 1961, pages 93 to 97; or Toru Ikeuchi et al., Journal of Antibiotics, (September 1972), pages 548 to 550. Fermentation is configured to obtain high levels of live biomass, including spores, and desirable secondary metabolites in the fermentation vessels. Specific fermentation methods that are suitable for the strain of the present invention to achieve high levels of sporulation, cfu (colony forming units), and secondary metabolites are described in the Examples section.

The bacterial cells, spores and metabolites in culture broth resulting from fermentation (the “whole broth” or “fermentation broth”) may be used directly or concentrated by conventional industrial methods, such as centrifugation, filtration, and evaporation, or processed into dry powder and granules by spray drying, drum drying and freeze drying, for example.

The terms “whole broth” and “fermentation broth,” as used herein, refer to the culture broth resulting from fermentation (including the production of a culture broth that contains gougerotin in a concentration of at least about 1 g/L) before any downstream treatment. The whole broth encompasses the microorganism (e.g., Streptomyces microflavus NRRL B-50550 or a phytophagous-miticidal mutant strain thereof) and its component parts, unused raw substrates, and metabolites produced by the microorganism during fermentation. The term “broth concentrate,” as used herein, refers to whole broth (fermentation broth) that has been concentrated by conventional industrial methods, as described above, but remains in liquid form. The term “fermentation solid,” as used herein, refers to dried fermentation broth. The term “fermentation product,” as used herein, refers to whole broth, broth concentrate and/or fermentation solids. Compositions of the present invention include fermentation products. In some embodiments, the concentrated fermentation broth is washed, for example, via a diafiltration process, to remove residual fermentation broth and metabolites.

In one embodiment, the fermentation broth contains at least about 1×10⁵ colony forming units (CFU) of the microorganism (e.g., Streptomyces microflavus NRRL B-50550 or a phytophagous-miticidal mutant strain thereof)/mL broth. In another embodiment, the fermentation broth contains at least about 1×10⁶ colony forming units (CFU) of the microorganism (e.g., Streptomyces microflavus NRRL B-50550 or a phytophagous-miticidal mutant strain thereof)/mL broth. In yet another embodiment, the fermentation broth contains at least about 1×10⁷ colony forming units (CFU) of the microorganism (e.g., Streptomyces microflavus NRRL B-50550 or a phytophagous-miticidal mutant strain thereof)/mL broth. In another embodiment, the fermentation broth contains at least about 1×10⁸ colony forming units (CFU) of the microorganism (e.g., Streptomyces microflavus NRRL B-50550 or a phytophagous-miticidal mutant strain thereof)/mL broth. In another embodiment, the fermentation broth contains at least about 1×10⁹ colony forming units (CFU) of the microorganism (e.g., Streptomyces microflavus NRRL B-50550 or a phytophagous-miticidal mutant strain thereof)/mL broth. In another embodiment, the fermentation broth contains at least about 1×10¹⁰ colony forming units (CFU) of the microorganism (e.g., Streptomyces microflavus NRRL B-50550 or a phytophagous-miticidal mutant strain thereof)/mL broth. In another embodiment, the fermentation broth contains at least about 1×10¹¹ colony forming units (CFU) of the microorganism (e.g., Streptomyces microflavus NRRL B-50550 or a phytophagous-miticidal mutant strain thereof)/mL broth. One of skill in the art will understand that the concentrations described above relate to CFU measured shortly after completion of fermentation but that CFU levels will decline over time, depending on storage conditions. CFU levels of unformulated fermentation products of the microorganisms described herein are stable when the products are maintained in cold storage (e.g., about 4° C.) but decline at room temperature.

In one embodiment, the fermentation broth or broth concentrate can be formulated into liquid suspension, liquid concentrate, emulsion concentrate, or wettable powder with the addition of stabilization agents, preservatives, adjuvants, and/or colorants.

In another embodiment, the fermentation broth or broth concentrate can be dried with or without the addition of carriers, inerts, or additives using conventional drying processes or methods such as spray drying, freeze drying, tray drying, fluidized-bed drying, drum drying, or evaporation.

In some embodiments, the fermentation broth, broth concentrate or fermentation solid is treated in order to kill the microorganism, resulting in a fermentation product that consists of the killed microbe, its metabolites and residual fermentation media. Suitable treatments to accomplish this are known to those of skill in the art and include heat treatments.

In embodiments in which the fermentation broth or broth concentrate is freeze dried, one gallon of fermentation broth yields about 0.2 lb to about 1 lb freeze dried powder. In a particular instance, one gallon of fermentation broth yields about 0.4 lb to about 0.6 lb freeze dried powder. In another instance, one gallon of fermentation broth yields about 0.5 lb freeze dried powder.

In a further embodiment, the resulting dry products may be further processed, such as by milling or granulation, with or without the addition of inerts or additives to achieve specific particle sizes or physical formats or physical properties desirable for agricultural applications.

In addition to the use of whole broth or broth concentrate, cell-free preparations of fermentation broth of the novel variants and strains of Streptomyces of the present invention can be obtained by any means known in the art, such as extraction, centrifugation and/or filtration of fermentation broth. Those of skill in the art will appreciate that so-called cell-free preparations may not be devoid of cells but rather are largely cell-free or essentially cell-free, depending on the technique used (e.g., speed of centrifugation) to remove the cells. The resulting cell-free preparation may be dried and/or formulated with components that aid in its application. Concentration methods and drying techniques described above for fermentation broth are also applicable to cell-free preparations.

Compositions of the present invention may include formulation ingredients added to compositions comprising cells, cell-free preparations or metabolites to improve efficacy, stability, and physical properties, usability and/or to facilitate processing, packaging and end-use application. Such formulation ingredients may include carriers, inerts, stabilization agents, preservatives, nutrients, or physical property modifying agents, which may be added individually or in combination. In some embodiments, the carriers may include liquid materials such as water, oil, and other organic or inorganic solvents and solid materials such as minerals, polymers, or polymer complexes derived biologically or by chemical synthesis. In some embodiments, the ingredient is a binder, adjuvant, or adhesive that facilitates adherence of the composition to a plant part, such as leaves, seeds, or roots. See, for example, Taylor, A. G., et al., “Concepts and Technologies of Selected Seed Treatments” Annu. Rev. Phytopathol. 28: 321-339 (1990). The stabilization agents may include anti-caking agents, anti-oxidation agents, desiccants, protectants or preservatives. The nutrients may include carbon, nitrogen, and phosphors sources such as sugars, polysaccharides, oil, proteins, amino acids, fatty acids and phosphates. The physical property modifiers may include bulking agents, wetting agents, thickeners, pH modifiers, rheology modifiers, dispersants, adjuvants, surfactants, antifreeze agents or colorants. In some embodiments, the composition comprising cells, cell-free preparation or metabolites produced by fermentation can be used directly with or without water as the diluent without any other formulation preparation. In a particular embodiment, a wetting agent is added to a fermentation solid, such as a freeze-dried or spray-dried powder. A wetting agent increases the spreading and penetrating properties of the active ingredient (once diluted) when it is applied to surfaces. Exemplary wetting agents are known to those of skill in the art and include sulfoccinates and derivatives, such as MONAWET MO-70 (Croda Inc., Edison, N.J.); trsiloxanes such as BREAKTHRU (Evonik, Germany); nonionic compounds, such as ALTOX 4894 (Croda Inc., Edison, N.J.); alkyl polygulcosides, such as TERWET 3001 (Huntsman International LLC, The Woodlands, Texas); C12-C14 secondary alcohol ethoxylate, such as TERGITOL 15-s-15 (The Dow Chemical Company, Midland, Mich.); phosphate esters, such as RHODAFAC BG-510 (Rhodia, Inc.); and alkyl ether carboylates, such as EMULSOGEN-LS (Clariant Corporation, North Carolina).

In some embodiments, the formulation inerts are added after concentrating fermentation broth and during and/or after drying.

The present invention encompasses fermentation broths containing gougerotin at a concentration of at least about 1 g/L. In some embodiments such whole broth cultures come from gougerotin-producing strains of Streptomyces. In a particular embodiment, such gougerotin-producing strain is Streptomyces microflavus, Streptomyces puniceus, or Streptomyces graminearus. In another embodiment, the gougerotin-producing strain is S. griseus, S. anulatus, S. fimicarius, S. parvus, S. lavendulae, S. alboviridis, or S. puniceus. In yet another particular embodiment, such gougerotin-producing strain is Streptomyces graminearus CGMCC 4.506, deposited at China General Microbiological Culture Collection Center CGMCC.

The present invention also provides the gougerotin biosynthetic gene cluster from Streptomyces microflavus, the characterization of the individual genes in the gene cluster, and the proteins encoded thereby. A gougerotin gene cluster is disclosed, the gene cluster comprising 14 open reading frames (ORFs) referred to as ORFs 4251 to 4253, 4255 to 4259, 4261 to 4265, and 4271, respectively (SEQ ID NOs: 1, 3, 5, 9, 11, 13, 15, 17, 21, 23, 25, 27, 29, and 41 respectively), and referred to herein as GouA, GouB, GouC, GouD, GouE, GouF, GouG, GouH, GouI, GouJ, GouK, GouL, GouM, and Gou N, respectively. The corresponding proteins are provided at SEQ ID NOs: 2, 4, 6, 10, 12, 14, 16, 18, 22, 24, 26, 28, 30, and 42, respectively. The genomic DNA sequence comprising the gougerotin biosynthetic gene cluster and some of the flanking regions is provided in SEQ ID NO: 43, and describes the locations of genes GouA through GouN. The present disclosure provides the nucleic acid sequence of a gougerotin gene cluster located within a genetic locus, the ORFs contained therein, and the proteins encoded thereby. This information enables, for example, the isolation of related nucleic acid molecules encoding homologs of the gougerotin gene cluster and the corresponding ORFs, such as in other Streptomyces spp.

The gougerotin gene cluster included within SEQ ID NO: 43 (nucleotide residues 1-21933), identified from a Streptomyces microflavus strain, includes twenty-four ORFs referred to as ORFs 4248 to 4271. ORFs 4251, 4252, 4253, 4255, 4256, 4257, 4258, 4259, 4261, 4262, 4263, 4264, 4265, and 4271 are thirteen genes gouA, gouB, gouC, gouD, gouE, gouF, gouG, gouH, gouI, gouJ, gouK, gouL, gouM, and gou N, respectively. Note that SEQ ID NOs: 89-100 (identified from a Streptomyces puniceus strain) provide orthologous genes gouB, gouC, gouD, gouE, gouF, gouG, gouH, gouI, gouJ, gouK, gouL, gouM, respectively. The potential function of these genes and their possible role in gougerotin synthesis is provided in Table 2.

TABLE 2
Possible Role of Gougerotin Biosynthetic Genes

| | # of | | | |
|---|---|---|---|---|
| ORF | a.a. | Potential Function | Strand | Possible Role in Gougerotin Biosynthesis |
| 4248 | 58 | hypothetical protein | + | |
| 4249 | 568 | endo-1,4-beta- | − | |
| | | xylanase A precursor | | |
| 4250 | 99 | transposase | − | |
| 4251 | 141 | methyltransferase | − | may be involved in synthesis of sarcosine from |
| | | | | glycine |
| 4252 | 153 | kinase | + | transfers a phosphate group |
| 4253 | 171 | dehydrogenase | + | may be involved in producing UDP-glucuronic acid |
| 4254 | 118 | hypothetical protein | − | |
| 4255 | 46 | hypothetical protein | + | |
| 4256 | 304 | hypothetical protein | + | transfers an amino group to the sugar backbone or |
| 4257 | 326 | aminotransferase | + | involved in the synthesis of serine or sarcosine; has |
| | | | | similarity to DegT/DnrJ/EryC1/StrS |
| | | | | aminotransferase family which includes StsC, the |
| | | | | aminotransferase catalyzing the first amino transfer |
| | | | | in the biosynthesis of streptidine subunit of |
| | | | | streptomycin |
| 4258 | 397 | similar to cytosinine | + | possible enzyme for creating cytosinine-like |
| | | synthase | | molecule; has similarity to DegT/DnrJ/EryC1/StrS |
| | | | | aminotransferase family |
| 4259 | 378 | phosphatase | + | may remove the phosphate group in UDP-glucuronic |
| | | | | acid to create a precursor to CGA |
| 4260 | 39 | hypothetical protein | − | |
| 4261 | 371 | CGA synthase | + | potential enzyme for synthesizing cytosylglucoronic |
| | | | | acid, a potential intermediate in gougerotin |
| 4262 | 237 | nucleotide binding | + | |
| 4263 | 211 | glycosyltransferase | + | Potentially another enzyme for attaching the sugar |
| | | | | group to cytosine to create CGA |
| 4264 | 446 | unknown | + | |
| 4265 | 587 | asparagine synthase | + | similar to asparagine synthase of other gram positive |
| | | | | bacteria in other genus; may synthesize one of the |
| | | | | amino acids in gougerotin |
| 4266 | 37 | hypothetical protein | + | |
| 4267 | 134 | hypothetical protein | + | |
| 4268 | 414 | transposase | + | |
| 4269 | 378 | transposase | − | |
| 4270 | 187 | transcription | − | |
| | | regulator | | |
| 4271 | 368 | monooxygenase | + | may transfer a hydroxyl group to the sugar backbone |

Therefore, in yet another embodiment, the fermentation products, including fermentation broths having at least about 0.5 g/L gougerotin or at least about 1 g/L gougerotin, of the present invention are from a gougerotin-producing Streptomyces strain that has a nucleic acid sequence encoding an amino acid sequence having at least about 75%, at least about 80%, at least about 85%, at least about 90%, at least about 95% or at least about 99% sequence identity to at least one amino acid sequence selected from the group consisting of SEQ ID NO: 2, SEQ ID NO: 4, SEQ ID NO: 6, SEQ ID NO: 10, SEQ ID NO: 12, SEQ ID NO: 14, SEQ ID NO: 16, SEQ ID NO: 18, SEQ ID NO: 22, SEQ ID NO: 24, SEQ ID NO: 26, SEQ ID NO: 28, SEQ ID NO: 30, and SEQ ID NO: 42. In yet another embodiment, the fermentation products, including fermentation broths having at least about 0.5 g/L gougerotin or at least about 1 g/L gougerotin, are from a gougerotin-producing Streptomyces strain that has a nucleotide sequence having at least about 75%, at least about 80%, at least about 85%, at least about 90%, at least about 95%, at least about 96%, at least about 97%, at least about 98%, or at least about 99% sequence identity to the nucleotide sequence of SEQ ID NO: 43 or to the region of the nucleotide sequence of SEQ ID NO:43 that codes for proteins GouA, GouB, GouC, GouD, GouE, GouF, GouG, GouH, GouI, GouJ, GouK, GouL, and/or GouM.

In a particular embodiment, such gougerotin-producing strain with the above nucleic acid sequence is a Streptomyces microflavus or a Streptomyces puniceus. One particular example is Streptomyces microflavus NRRL B-50550 or phytophagous-miticidal mutants thereof. In one instance, such phytophagous-miticidal mutant thereof is Streptomcyes microflavus Strain M. In another example, such gougerotin-producing strain is Streptomyces puniceus Strain A or phytophagous-miticidal mutants thereof.

Fermentation broths containing at least about 1 g/L gougerotin may be obtained in several ways, such as fermentation optimization and/or mutagenesis of a parent gougerotin-producing strain in order to attain a mutant strain that produces higher levels of gougerotin than the parent strain.

Thus, the present invention also encompasses a method of producing a fermentation broth of a gougerotin producing Streptomyces strain, wherein the fermentation broth contains at least about 0.5 g/L gougerotin. The method comprises cultivating the Streptomyces strain in a culture medium that contains a digestible carbon source and a digestible nitrogen source under aerobic conditions, wherein the culture medium contains a precursor to gougerotin, such as cytosine; a nucleobase; and/or an amino acid at a concentration effective to achieve a gougerotin concentration of at least 0.5 g/L.

In some embodiments, the Streptomyces strain is cultivated in the culture medium until the culture medium contains gougerotin in a concentration of at least about 0.5 g/L, of at least about 1 g/L, of at least about 2 g/L, of at least about 3 g/L, of at least about 4 g/L, of at least about 5 g/L, of at least about 6 g/L, of about at least 7 g/L or of at least about 8 g/L gougerotin.

In other embodiments, the Streptomyces strain is cultivated in the culture medium until the culture medium contains gougerotin in a concentration ranging from about 0.5 g/L to about 25 g/L gougerotin, meaning the fermentation broth contains gougerotin in a concentration ranging typically ranging from about 0.5 g/L to about 15 g/L gougerotin after completion of the fermentation of rom about 0.5 mg/g to about 15 mg/g gougerotin.

In this context it is noted that the amino acid that is added at a concentration effective to achieve a gougerotin concentration of at least about 0.5 g/L or at least about 1 g/L is provided to the culture medium as a separate individual component in a defined concentration and not part of a composition such as a yeast extract or a protein hydrolysate (for example, casein hydrolysate, soy flour hydrolysate, soy peptone, soy acid hydrolysate, to name only a few) in which amino acids may be present in a mixture with other compounds such as oligopeptides and partially hydrolyzed proteins. Thus, by “a concentration effective to achieve a gougerotin concentration of at least 1 g/L” in the fermentation broth is meant a concentration of an amino acid in the culture medium that is specifically chosen to provide such a gougerotin concentration. In some embodiments, the concentration effective to achieve the desired gougerotin concentration is a concentration of the amino acid in the culture medium of at least about 1 g/L. This “effective concentration” may thus be higher than 2 g/L and may, for example, range from about 2 g/L to about 15 g/L. The concentration may be about 3 g/L, about 4 g/L, about 5 g/L, about 6 g/L, about 7 g/L, about 8 g/L, about 9 g/L, about 10 g/L, about 11 g/L, about 12 g/L, about 13 g/L, or about 14 g/L.

The amino acid may be any amino acid which provides for a concentration of gougerotin of at least about 0.5 g/L or a higher concentration such as at least about 1 g/L, at least about 2 g/L, at least about 3 g/L, at least about 4 g/L, at least about 5 g/L, at least about 6 g/L, method of any of Claims 6 to 8. In some embodiments the amino acid is glycine, L-glutamic acid, L-glutamine, L-aspartic acid, L-serine, or a mixture thereof. In some embodiments the culture medium contains glycine at a concentration of about 5 g/L to about 15 g/L, whereas in other embodiments the culture medium contains glutamic acid in an initial concentration of about 5 g/L to about 15 g/L. It is also possible that the culture medium contains both glycine and L-glutamic acid (or L-glutamine) in a concentration of about 5 g/L to about 15 g/L.

Any carbon source that is digestible (and thus available) for Streptomyces strains can be used in the method of producing a fermentation broth (or fermentation method) as described here. Examples of suitable carbon sources include glucose, fructose, mannose, galactose, sucrose, maltose, lactose, molasses, starch (as an example for a polysaccharide), dextrin, maltodextrin (as an example of an oligosaccharide) or glycerin, to name only a few. The total initial concentration of the carbon source (or sources) may be any concentration that provides a suitable growth of Streptomyces and production of the desired concentration of gougerotin and may be determined experimentally (determining the final concentration of gougerotin in the fermentation broth dependent from the concentration of the used carbon source(s)). The total initial carbon source concentration may, for example, be in the range of about 10 g/L to about 150 g/L, for example, about 10 g/L, about 20 g/L, about 30 g/L, about 40 g/L, about 50 g/L, about 60 g/L, about 70 g/L, about 80 g/L, about 90 g/L, about 100 g/L, about 110 g/L or about 120 g/L. In some embodiments, the carbon source might be a mixture of two or more carbon sources, for example, a mixture of glucose with a polysaccharide such as starch, a mixture of glucose and an oligosaccharide such as dextrin or maltodextrin or a mixture of glucose, starch and dextrin. In some embodiments the culture medium contains as carbon source a mixture of glucose and an oligosaccharide. The oligosaccharide may be maltodextrin or dextrin. In such embodiments, the initial maltodextrin concentration in the culture medium may be about 50 g/L to about 100 g/L or about 60 g/L to about 80 g/L. The initial glucose concentration in the culture medium may be about 20 g/L to about 80 g/L, for example, about 30 g/L, about 40 g/L, about 50 g/L, about 60 g/L or about 70 g/L. In other embodiments in which glucose is used as carbon source with maltodextrin or dextrin, the glucose concentration may be about 20 g/L to 60 g/L or about 30 g/L to about 50 g/L.

Any nitrogen source that is digestible can be used in the fermentation process described here. The nitrogen source can be a single source or a mixture of sources. In illustrative embodiments the nitrogen source is (at least partially) selected from the group consisting of soy peptone, soy acid hydrolysate, soy flour hydrolysate, casein hydrolysate, yeast extract, and mixtures thereof. The total initial concentration of the nitrogen source(s) may be any concentration that provides a suitable growth of Streptomyces and production of the desired concentration of gougerotin and may be determined experimentally. Suitable total concentrations in the culture medium may, for example, be in the range of about 10 g/L to about 60 g/L, for example, about 20 g/L, about 30 g/L, about 40 g/L, about 50 g/L. In illustrative embodiments, the nitrogen source may be a mixture of casein hydrolysate and soy flour hydrate or a mixture of yeast extract and soy acid hydrolysate, wherein for example the yeast extract is used in the culture medium in a concentration (or amount) of 10 g/L and the soy acid hydrolysate is used in a concentration/amount of 20 g/L.

The culture medium can further contain a calcium source such as calcium chloride, or calcium carbonate. If present, the culture medium may contain a calcium source such as calcium carbonate in an initial concentration of about 1 g/L to 3 g/L.

In this context, it is noted that concentrations of all ingredients of the culture medium are given as concentration at the beginning of the fermentation (initial concentrations) unless indicated otherwise. The concentrations are based on the post inoculation volume that is used for the fermentation. The initial concentrations as given here can either be maintained during the fermentation by continuous nutrient feeding or, alternatively, the ingredients (carbon source, nitrogen source, amino acid) can be added only at the beginning of the fermentation. However, the pH of the culture medium/fermentation broth is typically continuously monitored and controlled by addition of a suitable acid (such as sulfuric acid or citric acid) and/or of a suitable base (such as sodium hydroxide or ammonia solution or potassium hydroxide). An appropriate pH can be determined empirically. In typical embodiments the pH of the culture medium/fermentation broth is in range of 6.5 to 7.5, for example, 6.8 to 7.0. Also process parameters such as temperature and aeration rate are usually controlled over the course of fermentation process. Since the cultivation of the Streptomyces strain is carried out under aerobic conditions, the fermentation broth is typically aerated with air, oxygen enriched air or if necessary, pure oxygen. The temperature is usually chosen to be within a range of 20° C. to 30° C., however higher temperatures are also contemplated herein. Standard fermentation reagents such as antifoam agents may also be added continuously. The production of the fermentation broth can be carried out using conventional large-scale microbial fermentation processes, such as submerged fermentation, solid state fermentation or liquid surface culture, including the methods described, for example, in U.S. Pat. No. 3,849,398; British Patent No. GB 1 507 193; Toshiko Kanzaki et al., Journal of Antibiotics, Ser. A, Vol. 15, No. 2, June 1961, pages 93 to 97; or Toru Ikeuchi et al., Journal of Antibiotics, (September 1972), pages 548 to 550.

Any gougerotin producing Streptomcyes strain can be used for producing the gougerotin containing fermentation broth disclosed herein. In illustrative embodiments the Streptomcyes strain is a Streptomyces microflavus strain, Streptomcyes puniceus strain or a Streptomyces graminearus strain. The Streptomyces microflavus strain may, for example, be Streptomyces microflavus strain NRRL B-50550 or a phytophagous-miticidal mutant strain derived therefrom. In addition, parent bacterial strains, such as various Streptomycetes (including, but not limited to, Streptomyces microflavus, Streptomyces puniceus and Streptomyces graminearus) and Bacilli, capable of producing gougerotin, even at low levels, may be mutagenized for enhanced gougerotin production. Example 14 describes one way to produce such mutants and resulting fermentation broths containing at least 1 g/L gougerotin.

Selection of specific carbon and nitrogen sources and other nutrients during fermentation may be used to optimize the production of gougerotin. Suitable carbon sources for enhancing gougerotin production are starch, maltodextrin, dextrin, sugars and glucose. In a specific embodiment a combination of glucose and an oligosaccharide is used as the carbon source and/or procures. Suitable nitrogen sources for enhancing gougerotin production are soy protein hydrolysate, casein hydrolysate, soy peptone, yeast extract, and other nitrogen sources that are less nutrient rich. Other suitable nitrogen sources include amino acids and/or precursors to gougerotin such as glycine, glutamic acid, including L-glutamic acid, aspartic acid, including L-aspartic acid, serine, including L-serine, and cytosine. Cytosine may be added as part of a media component that has a high concentration of cytosine, such as a yeast extract having high nucleobase content. Examples of fermentation media capable of producing a fermentation broth having an increased level of gougerotin are provided in Examples 11, 12 and 13.

In another embodiment, the fermentation products (e.g., fermentation broth or fermentation solid) of the present invention have potency of at least 40%, at least 50%, or at least 60%, wherein the potency is measured as follows. Dilute the fermentation product in a water surfactant solution (using the amount of surfactant recommended on the surfactant product label) to obtain a solution that is 5% whole broth (or whole broth equivalent, as described below, if dealing with a fermentation solid derived from whole broth). Apply the diluted solution to the top and bottom surfaces of a leaf (such as the leaf of a lima bean) until both surfaces are wet, but do not apply to run-off. Allow plants to dry and then infest with 10-20 two-spotted spider mites (Tetranychus urticae Koch). Four days after treatment, inspect the treated leaves and count live and dead adult females and deutonmphs on the leaves. Use the Sun-Shepard formula to calculate potency (i.e., corrected mortality). Corrected %=100 (% reduction in the treated plot±% change in untreated population)/(100±% change in untreated population). In this application, potency calculated by the above-described method will be referred to as “Spider Mite Potency.”

In some embodiments the compositions of the present invention are used to treat a wide variety of agricultural and/or horticultural crops, including those grown for seed, produce, landscaping and those grown for seed production. Representative plants that can be treated using the compositions of the present invention include but are not limited to the following: brassica, bulb vegetables, cereal grains, citrus, cotton, cucurbits, fruiting vegetables, leafy vegetables, legumes, oil seed crops, peanut, pome fruit, root vegetables, tuber vegetables, corm vegetables, stone fruit, tobacco, strawberry and other berries, and various ornamentals.

The compositions of the present invention may be administered as a foliar spray, as a soil treatment, and/or as a seed treatment/dressing. When used as a foliar treatment, in one embodiment, about 1/16 to about 5 gallons of whole broth are applied per acre. When used as a soil treatment, in one embodiment, about 1 to about 15 gallons or about 1 to about 5 gallons of whole broth are applied per acre or about 0.1 mg to about 14 mg, or about 0.2 mg to about 10 mg, or about 0.2 mg to about 8 mg fermentation product, such as a freeze dried product, depending on the size of the seeds to be treated and the concentration of colony forming units in the fermentation product. When used for seed treatment about 1/32 to about ¼ gallons of whole broth are applied per acre. For seed treatment, the end-use formulation contains at least 1×10⁸ colony forming units per gram.

In some embodiments, application of the compositions of the present invention to plants, plant parts or plant loci is preceded by identification of a locus in need of treatment.

A fermentation product, such as a whole broth culture or a fermentation solid, including a freeze-dried powder, of the microorganism (e.g., Streptomyces microflavus NRRL B-50550 or a phytophagous-miticidal mutant strain thereof)/mL is diluted and applied to plants foliarly. Application rates are provided in gallons or pounds per acre and can be adjusted proportionally to smaller applications (such as the microplot trials described in the Examples). As described in the Examples, for larger applications, the fermentation product is diluted in 100 gallons of water before application. In one embodiment, about 0.5 gallons to about 15 gallons, about 1 gallon to about 12 gallons or about 1.25 gallons to about 10 gallons whole broth culture (diluted in water and, optionally, a surfactant) are applied to plants foliarly per acre. In another embodiment, about 0.2 lbs to about 8 pounds of freeze-dried powder, about 0.4 lbs to about 7 pounds, or about 0.4 lbs to about 6 lbs (diluted in water and, optionally, a surfactant) are applied to plants foliarly per acre. In a particular instance, the fermentation product has Spider Mite Potency of at least about 40%, at least about 50% or at least about 60%. In another instance, the fermentation product is a fermentation powder (including spray-dried or freeze-dried powder) having about 0.5% to about 15% gougerotin, about 1% to about 12% gougerotin, or about 2% to about 10% gougerotin, where all percentages are weight by weight. In another instance, the fermentation product is a fermentation broth having about 0.01% to about 0.5% gougerotin, weight by weight.

In a particular embodiment, 1.25 pounds of fermentation product, such as freeze-dried powder or spray-dried powder, (diluted in water and, optionally, a surfactant) are applied to plants foliarly per acre. In these embodiments, the end-use formulation is based on a starting fermentation broth containing at least about 1×10⁶ colony forming units per mL, at least about 1×10⁷ colony forming units per mL, at least about 1×10⁸ colony forming units per mL, at least about 1×10⁹ colony forming units per mL, or at least about 1×10¹⁰ colony forming units per mL. In another example, this fermentation product contains at least about 1% by weight gougerotin, at least about 2% by weight gougerotin, at least about 3% by weight gougerotin, at least about 4% by weight gougerotin, at least about 5% by weight gougerotin, at least about 6% by weight gougerotin, at least about 7% by weight gougerotin, or at least about 8% by weight gougerotin.

### Gougerotin Gene Cluster, ORFs, and Proteins Encoded Thereby

The present disclosure provides the nucleic acid sequence of a gougerotin gene cluster located within a genetic locus, the ORFs contained therein, and the proteins encoded thereby. This information enables, for example, the isolation of related nucleic acid molecules encoding homologs of the gougerotin gene cluster and the corresponding ORFs, such as in other Streptomyces spp. This disclosure further enables the production of variants of the proteins (including, but not limited to Gou A, GouB, GouC, GouD, GouE, GouF, GouG, GouH, GouI, GouJ, GouK, GouL, GouM, and/or GouN) encoded by a gougerotin gene cluster or portions thereof, and nucleic acid molecules encoding such variants.

The gougerotin gene cluster included within SEQ ID NO: 43 (nucleotide residues 1-21933), identified from a Streptomyces microflavus strain, includes twenty-four ORFs referred to as ORFs 4248 to 4271. ORFs 4251, 4252, 4253, 4255, 4256, 4257, 4258, 4259, 4261, 4262, 4263, 4264, 4265, and 4271 are thirteen genes gouA, gouB, gouC, gouD, gouE, gouF, gouG, gouH, gouI, gouJ, gouK, gouL, gouM, and gou N, respectively. Note that SEQ ID NOs: 89-100 (identified from a Streptomyces puniceus strain) provide orthologous genes gouB, gouC, gouD, gouE, gouF, gouG, gouH, gouI, gouJ, gouK, gouL, gouM, respectively. (The potential function of these genes and their possible role in gougerotin synthesis is provided in Table 2.

With the provision herein of the sequences of the disclosed gene locus (SEQ ID NO: 43) and the ORFs contained therein, in vitro nucleic acid amplification (including, but not limited to, PCR) may be utilized as a simple method for producing nucleic acid sequences encoding one or more of the gougerotin biosynthetic proteins listed in Table 1, above. The following provides representative techniques for preparing a protein-encoding nucleic acid molecule in this manner.

RNA or DNA is extracted from cells by any one of a variety of methods well known to those of ordinary skill in the art. Sambrook et al. (in Molecular Cloning: A Laboratory Manual, Cold Spring Harbor Laboratory Press, New York, 1989) and Ausubel et al. (in Current Protocols in Molecular Biology, Greene Publ. Assoc. and Wiley-Intersciences, 1992) provide representative descriptions of methods for RNA or DNA isolation. The gougerotin biosynthetic enzymes are expressed, at least, in Streptomyces microflavus. Thus, in some examples, RNA or DNA may be extracted from Streptomyces microflavus cells. Extracted RNA may be used, for example, as a template for performing reverse transcription (RT)-PCR amplification to produce cDNA. Representative methods and conditions for RT-PCR are described by Kawasaki et al. (in PCR Protocols, A Guide to Methods and Applications, Innis et al. (eds.) 21-27 Academic Press, Inc., San Diego, Calif., 1990).

The selection of amplification primers may be made according to the portion(s) of the DNA to be amplified. In one embodiment, primers may be chosen to amplify a segment of DNA (e.g., a specific ORF or set of adjacent ORFs) or, in another embodiment, the entire DNA molecule. Variations in amplification conditions may be required to accommodate primers and amplicons of differing lengths and composition. Such considerations are well known in the art and are discussed for instance in Innis et al. (PCR Protocols, A Guide to Methods and Applications, Academic Press, Inc., San Diego, Calif., 1990). By way of example, the nucleic acid molecules encoding selected gougerotin biosynthetic proteins (such as any one or combination of, gouA through gouN) may be amplified using primers directed to the 5′- and 3′-ends of the prototypical Streptomyces microflavus gouA, gouB, gouC, gouD, gouE, gouF, gouG, gouH, gouI, gouJ, gouK, gouL, gouM, and/or gou N sequences. It will be appreciated that many different primers may be derived from the provided nucleic acid sequences. Re-sequencing of amplification products obtained by any amplification procedure is recommended to facilitate confirmation of the amplified sequence and to provide information on natural variation between a gougerotin and amplified sequence. Oligonucleotides derived from any of the gougerotin sequences may be used in sequencing, for instance, the corresponding gougerotin (or gougerotin-related) amplicon.

In addition, both conventional hybridization and PCR amplification procedures may be employed to clone sequences encoding orthologs of the gougerotin gene cluster, or gougerotin ORFs (for example, one or more of SEQ ID NOs: 1, 3, 5, 7, 9, 11, 13, 15, 17, 19, 21, 23, 25, 27, 29, 31, 33, 35, 37, 39, and 41). Common to both of these techniques is the hybridization of probes or primers that are derived from the gougerotin gene cluster with or without the upstream and downstream flanking regions or gougerotin ORF nucleic acid sequences. Furthermore, the hybridization may occur in the context of Northern blots, Southern blots, or PCR.

Direct PCR amplification may be performed on DNA libraries prepared from the bacterial species in question, or RT-PCR may be performed using RNA extracted from the bacterial cells using standard methods. PCR primers will comprise at least 10 consecutive nucleotides of the gougerotin gene cluster with or without the upstream and downstream flanking regions or gougerotin ORF nucleic acid sequences. One of skill in the art will appreciate that sequence differences between the gougerotin gene cluster or gougerotin ORF nucleic acid sequences and the target nucleic acid to be amplified may result in lower amplification efficiencies. To compensate for this, longer PCR primers or lower annealing temperatures may be used during the amplification cycle. Whenever lower annealing temperatures are used, sequential rounds of amplification using nested primer pairs may be useful to enhance amplification specificity.

Orthologs of the disclosed gougerotin biosynthetic proteins may be present in a number of other members of the Streptomyces genus, in other strains of the Streptomyces microflavus species, and in other gougerotin-producing organisms. With the provision of the nucleic acid sequence of the disclosed gougerotin gene cluster and its ORFs 4251-4253, 4255-4259, 4261-4265, and 4271, as well as flanking and intervening ORFs 4248-4250 and 4266-4270, the cloning by standard methods of protein-encoding DNA (such as, ORFs) and gene clusters that encode gougerotin biosynthetic enzyme orthologs in these other organisms is now enabled. Orthologs of the disclosed gougerotin biosynthetic enzymes and proteins have a biological activity or function as disclosed herein, including for example cytosine synthase (ORF 4258; gouG; SEQ ID NOs: 15 & 16) or CGA synthase (ORF 4261; gouI; SEQ ID NOs: 21 & 22).

Orthologs will generally share at least 65% sequence identity with the nucleic acid sequences encoding the disclosed gougerotin biosynthetic proteins (for example, one or more of SEQ ID NOs: 1, 3, 5, 7, 9, 11, 13, 15, 17, 19, 21, 23, 25, 27, 29, 31, 33, 35, 37, 39, and 41). In specific embodiments, orthologous gougerotin gene clusters or gougerotin ORFs may share at least 70%, at least 75%, at least 80% at least 85%, at least 90%, at least 91%, at least 92%, at least 93%, at least 94%, at least 95%, at least 96%, at least 97%, at least 98%, or at least 99% sequence identity with the disclosed Streptomyces microflavus or Streptomyces puniceus nucleotide or amino acid sequences, as applicable.

For conventional hybridization techniques the hybridization probe is preferably conjugated with a detectable label such as a radioactive label, and the probe is preferably at least 10 nucleotides in length. As is well known in the art, increasing the length of hybridization probes tends to provide enhanced specificity. A labeled probe derived from a gougerotin gene cluster or from gougerotin ORF nucleic acid sequences may be hybridized to a bacterial DNA library and the hybridization signal detected using methods known in the art. The hybridizing colony or plaque (depending on the type of library used) may be purified and the cloned sequence contained in that colony or plaque isolated and characterized.

In specific examples, genomic library construction can be accomplished rapidly using a variety of cosmid or fosmid systems that are commercially available (e.g., Stratagene, Epicentre). Advantageously, these systems minimize instability of the cloned DNA. In such examples, genomic library screening is followed by cosmid or fosmid isolation, grouping into families of overlapping clones and analysis to establish cluster identity. Cosmid end sequencing can be used to obtain preliminary information regarding the relevance of a particular clone based on expected pathway characteristics predicted from the natural product structure and its presumed biosynthetic origin.

Orthologs of a gougerotin gene cluster (+/− upstream or downstream flanking regions) or gougerotin ORF nucleic acid sequences alternatively may be obtained by immunoscreening of an expression library. With the provision herein of the disclosed gene locus (SEQ ID NO: 43), the corresponding proteins can be expressed and purified in a heterologous expression system (e.g., E. coli) and used to raise antibodies (monoclonal or polyclonal) specific for the gougerotin biosynthetic enzymes or proteins, such as GouA, GouB, GouC, GouD, GouE, GouF, GouG, GouH, GouI, GouJ, GouK, GouL, GouM, and/or GouN. Antibodies also may be raised against synthetic peptides derived from the gougerotin amino acid sequences presented herein (SEQ ID NOs: 2, 4, 6, 8, 10, 12, 14, 16, 18, 20, 22, 24, 26, 28, 30, 32, 34, 36, 38, 40, and 42 and/or SEQ ID NOs: 77-88). Methods of raising antibodies are well known in the art and are described generally in Harlow and Lane, Antibodies, A Laboratory Manual, Cold Springs Harbor, 1988. Such antibodies can be used to screen an expression library produced from bacteria. For example, this screening will identify the gougerotin orthologs. The selected DNAs can be confirmed by sequencing and enzyme activity assays.

Oligonucleotides derived from a gougerotin gene cluster (SEQ ID NO: 43) or nucleic acid sequences encoding ORFs of the gene cluster (SEQ ID NOs: 1, 3, 5, 7, 9, 11, 13, 15, 17, 19, 21, 23, 25, 27, 29, 31, 33, 35, 37, 39, and 41), or fragments of these nucleic acid sequences, are encompassed within the scope of the present disclosure. Such oligonucleotides may be used, for example, as probes or primers. In one embodiment, oligonucleotides may comprise a sequence of at least 10 consecutive nucleotides of a gougerotin gene cluster (+/− upstream and downstream flanking regions) or a gougerotin ORF nucleic acid sequence. If these oligonucleotides are used with an in vitro amplification procedure (such as PCR), lengthening the oligonucleotides may enhance amplification specificity. Thus, in other embodiments, oligonucleotide primers comprising at least 15, 20, 25, 30, 35, 40, 45, 50, or more consecutive nucleotides of these sequences may be used. In another example, a primer comprising 30 consecutive nucleotides of a nucleic acid molecule encoding a gougerotin biosynthetic enzyme (such as, for example, SEQ ID NOs: 15 or 21) will anneal to a target sequence, such as a gougerotin gene cluster (+/− upstream and downstream flanking regions) or a gougerotin homolog present in a DNA library from another Streptomyces species (or other gougerotin-producing species), with a higher specificity than a corresponding primer of only 15 nucleotides. In order to obtain greater specificity, probes and primers can be selected that comprise at least 17, 20, 23, 25, 30, 35, 40, 45, 50 or more consecutive nucleotides of the gougerotin gene cluster (+/− upstream and downstream flanking regions) or a gougerotin ORF nucleotide sequence. In particular examples, probes or primers can be at least 100, 250, 500, 600 or 1000 consecutive nucleic acids of a disclosed gougerotin gene cluster (+/− upstream and downstream flanking regions) or a gougerotin ORF sequence.

Oligonucleotides (such as, primers or probes) may be obtained from any region of the disclosed gougerotin gene cluster (+/− upstream and downstream flanking regions) or a gougerotin ORF nucleic acid sequence. By way of example, a gougerotin gene cluster (+/− upstream and downstream flanking regions) or a gougerotin ORF sequence may be apportioned into about halves, thirds or quarters based on sequence length, and the isolated nucleic acid molecules (e.g., oligonucleotides) may be derived from the first or second halves of the molecules, from any of the three thirds, or from any of the four quarters. The nucleic acid sequence of interest also could be divided into smaller regions, e.g., about eighths, sixteenths, twentieths, fiftieths and so forth, with similar effect. Alternatively, it may be divided into regions that encode for conserved domains.

With the provision herein of the gougerotin biosynthetic proteins and corresponding nucleic acid sequences, the creation of variants of these sequences is now enabled. Variant gougerotin biosynthetic enzymes include proteins that differ in amino acid sequence from the disclosed prototype enzymes and still retain the biological activity/function of the prototype proteins as listed in Table 1. Variant enzymes may also be stripped of their activity/function producing biosynthetic precursors to, or novel analogs of, gougerotin.

In one embodiment, variant gougerotin biosynthetic proteins include proteins that differ in amino acid sequence from the disclosed gougerotin biosynthetic protein sequences (e.g., SEQ ID NOs: 2, 4, 6, 8, 10, 12, 14, 16, 18, 20, 22, 24, 26, 28, 30, 32, 34, 36, 38, 40, and 42 and/or SEQ ID NOs: 77-88) but that share at least 65% amino acid sequence identity with such enzyme sequences. In other embodiments, other variants will share at least 70%, at least 75%, at least 80% at least 85%, at least 90%, at least 91%, at least 92%, at least 93%, at least 94%, at least 95%, at least 96%, at least 97%, at least 98%, or at least 99% amino acid sequence identity. Manipulation of the disclosed gougerotin gene cluster (+/− upstream and downstream flanking regions) and gougerotin ORF nucleotide sequences using standard procedures (e.g., site-directed mutagenesis or PCR), can be used to produce such variants. The simplest modifications involve the substitution of one or more amino acids for amino acids having similar biochemical properties. These so-called conservative substitutions may have minimal impact on the activity of the resultant protein.

### Biosynthetic Production of Gougerotin

Biosynthetic methods for creating gougerotin are useful for its efficient production and can be similarly employed for the production of gougerotin and analogs thereof. Thus, cloning and expression of the gougerotin biosynthetic gene cluster or ORFs therefrom in a heterologous host, such as E. coli or other Streptomyces spp., can be used to increase production of gougerotin, gougerotin precursor(s), gougerotin intermediate(s), or an enzyme or protein included within the gene cluster. In addition, genetic recombination and domain-exchange constructs permit the creation of gougerotin structures that would be difficult to make using traditional synthetic methodologies.

In an embodiment, a recombinant expression system is selected from prokaryotic hosts. Bacterial cells are available from numerous sources including public sources known to those skilled in the art, such as the American Type Culture Collection (ATCC; Manassas, Va.). Commercial sources of cells used for recombinant protein expression also provide instructions for usage of such cells.

One representative heterologous host system for expression of a gougerotin gene cluster is Streptomyces sp. In specific examples, Streptomyces spp. have been used as artificial hosts to express natural product biosynthetic gene clusters of very large sizes (see, e.g., Stutzman-Engwall and Hutchinson Proc. Natl. Acad. Sci. USA 86: 3135-3139, 1989; Motamedi and Hutchinson Proc. Natl. Acad. Sci. USA 84: 4445-4449, 1987; Grim et al. Gene 151: 1-10 1994; Kao et al. Science 265: 509-512, 1994: and Hopwood et al. Meth. Enzymol. 153: 116-166, 1987). Streptomyces spp. are useful heterologous host systems because they are easily grown, plasmids and cosmids for the expression and/or integration of biosynthetic gene clusters are well characterized, and they house many of the modifying and auxiliary enzymes required to produce functional pathways (Donadio et al. J. Biotechnol. 99:187-198, 2002). A host cell with fragmenting mycelium may exhibit the advantage of keeping viscosity low; further desirable characteristics of a host cell (in addition to the ability to express large amounts of gougerotin) include rapid growth and growth on simple substrates.

Another representative heterologous host system for expression of a gougerotin gene cluster (or one or more of its ORFs) is E. coli. E. coli is an attractive artificial expression system because it is fast-growing and easy to manipulate genetically. Recent advances in E. coli based expression systems have greatly aided efforts to simultaneously express multiple genes in a single host organism. Multiple ORFs from a complex biosynthetic system can now be expressed simultaneously in E. coli.

The choice of expression system will depend, however, on the features desired for the expressed polypeptides. Any transducible cloning vector can be used as a cloning vector for the nucleic acid constructs presently disclosed. If large clusters are to be expressed, it is preferable that phagemids, cosmids, fosmids, P1s, YACs, BACs, PACs, HACs or similar cloning vectors are used for cloning the nucleotide sequences into the host cell. These vectors are advantageous due to their ability to insert and stably propagate larger fragments of DNA, compared to M13 phage and lambda phage, respectively.

In an embodiment, one or more of the disclosed ORFs and/or variants thereof can be inserted into one or more expression vectors, using methods known to those of skill in the art. Vectors are used to introduce gougerotin biosynthesis genes or a gougerotin gene cluster into host cells. Prokaryotic host cells or other host cells with rigid cell walls may be transformed using any method known in the art, including, for example, calcium phosphate precipitation, or electroporation. Representative prokaryote transformation techniques are described in Dower (Genetic Engineering, Principles and Methods 12:275-296, Plenum Publishing Corp., 1990) and Hanahan et al. (Meth. Enzymol. 204:63, 1991), for example. Vectors include one or more control sequences operably linked to the desired ORF. However, the choice of an expression cassette may depend upon the host system selected and features desired for the expressed polypeptide or natural product. Typically, the expression cassette includes a promoter that is functional in the selected host system and can be constitutive or inducible. In an embodiment, the expression cassette includes a promoter, ribosome binding site, a start codon if necessary, and optionally a region encoding a leader peptide in addition to the desired DNA molecule and stop codon. In addition, a 3′ terminal region (translation and/or transcription terminator) can be included within the cassette. The ORF constituted in the DNA molecule may be solely controlled by the promoter so that transcription and translation occur in the host cell. Promoter-encoding regions are well known and available to those of skill in the art. Examples of promoters can include bacterial promoters (such as those derived from sugar metabolizing enzymes, such as galactose, lactose and maltose), promoter sequences derived from biosynthetic enzymes such as tryptophan, the beta-lactamase promoter system, bacteriophage lambda PL and TF and viral promoters.

The presence of additional regulatory sequences within the expression cassette may be desirable to allow for regulation of expression of the one or more ORFs relative to the growth of the host cell. These regulatory sequences are well known in the art. Examples of regulatory sequences include sequences that turn gene expression on or off in response to chemical or physical stimulus as well as enhancer sequences. In addition to the regulatory sequences, selectable markers can be included to assist in selection of transformed cells. For example, genes that confer antibiotic resistance or sensitivity to the plasmid may be used as selectable markers.

It is contemplated that the gougerotin gene cluster or one or more gougerotin ORFs of interest can be cloned into one or more recombinant vectors as individual cassettes, with separate control elements, or under the control of a single control element (e.g., a promoter). In an embodiment, the ORFs include two or more restriction sites to allow for the easy deletion and insertion of other open reading frames so that hybrid synthetic pathways can be generated. The design and use of such restriction sites is well known in the art and can be carried out by using techniques described above such as PCR or site-directed mutagenesis. Proteins expressed by the transformed cells can be recovered according to standard methods well known to those of skill in the art. For example, proteins can be expressed with a convenient tag to facilitate isolation. Further, the resulting polypeptide can be purified by affinity chromatography by using a ligand that binds to the polypeptide.

It is further contemplated that various gougerotin ORFs, gene cluster, or gougerotin proteins of interest may be produced by utilizing fermentation conditions as previously described for the production of gougerotin. After production, the compounds can be purified and/or analyzed by methods well known to one of skill in the art including, for example, high-pressure liquid chromatography (HPLC).

The present invention also encompasses a method for identifying and/or producing a miticidal and/or fungicidal bacterial product by (i) screening strains of a Streptomyces species, (ii) selecting strains having a nucleotide sequence having at least about 65% sequence identity, at least about 66% sequence identity, at least about 67% sequence identity, at least about 68% sequence identity, at least about 69% sequence identity, at least about 70% sequence identity, at least about 80% sequence identity, at least about 90% sequence identity, at least about 95% sequence identity, at least about 96% sequence identity, at least about 97% sequence identity, at least about 98% sequence identity, or at least about 99% sequence identity to SEQ ID NO. 43 or to the region of the nucleotide sequence of SEQ ID NO:43 that codes for proteins GouA, GouB, GouC, GouD, GouE, GouF, GouG, GouH, GouI, GouJ, GouK, GouL, and/or GouM, and (iii) producing a miticidal fermentation product from the selected strains. In some other embodiments, the selecting step involves selecting those strains having a nucleotide sequence that encodes an amino acid sequence having at least 70% sequence identity to at least one amino acid sequence selected from the group consisting of SEQ ID NO: 2, SEQ ID NO: 4, SEQ ID NO: 6, SEQ ID NO: 10, SEQ ID NO: 12, SEQ ID NO: 14, SEQ ID NO: 16, SEQ ID NO: 18, SEQ ID NO: 22, SEQ ID NO: 24, SEQ ID NO: 26, SEQ ID NO: 28, SEQ ID NO: 30, and SEQ ID NO: 42. In some embodiments strains of the following Streptomyces species are screened: S. microflavus, S. griseus, S. anulatus, S. fimicarius, S. parvus, S. lavendulae, S. alboviridis, S. puniceus, or S. graminearus. In some embodiments, the Streptomyces species that are screened are mutants of a parent Streptomcyes strain. In one aspect, such mutants are generated in the manner described in this application, including the methods described in Example 16, or by other methods known in the art. In some embodiments, the screening step is preceded by a step of generating mutants of a parent Streptomyces strain. Methods for generating mutants are described herein. In some embodiments, the selecting step also involves preparing a fermentation broth of the strain and selecting the strains that also have a Spider Mite Potency of at least about 60%. Such selecting step can occur before or after the selecting step based on sequence identity. Methods for producing fermentation products and for testing for miticidal activity are set forth herein. In one embodiment, the fermentation product of the producing step (step (iii)) has a gougerotin concentration of at least about 1 g/L, at least about 2 g/L, at least about 3 g/L, at least about 4 g/L, at least about 5 g/L, at least about 6 g/L, at least about 7 g/L, at least about 8 g/L, at least about 9 g/L, or at least about 10 g/L. Methods for measuring gougerotin concentration are known by those of skill in the art.

### DEPOSIT INFORMATION

A sample of a Streptomyces microflavus strain of the invention has been deposited with the Agricultural Research Service Culture Collection located at the National Center for Agricultural Utilization Research, Agricultural Research Service, U.S. Department of Agriculture, 1815 North University Street, Peoria, Ill. 61604 under the Budapest Treaty on Aug. 19, 2011 and has been assigned the following depository designation: NRRL B-50550.

A sample of a mutant of Streptomyces microflavus strain NRRL B-50550 (designated herein as Streptomyces microflavus strain M and also known as AQ6121.002) has been deposited with the Agricultural Research Service Culture Collection located at the National Center for Agricultural Utilization Research, Agricultural Research Service, U.S. Department of Agriculture, 1815 North University Street, Peoria, Ill. 61604 under the Budapest Treaty on Sep. 27, 2013. This strain has also been deposited with the American Type Culture Collection located at 10801 University Boulevard Manassas, Va. 20110 USA under the Budapest Treaty on Oct. 8, 2013. This strain has also been deposited with the International Despositary Authority of Canada located at 1015 Arlington Street Winnipeg, Manitoba Canada R3E,3R2 on Oct. 9, 2013 and has been assigned (provisional) Accession No. 091013-02.

A sample of a Streptomyces puniceus strain referred to herein as Streptomyces puniceus strain A (and also known as AQ7439) has been deposited with the American Type Culture Collection located at 10801 University Boulevard Manassas, Va. 20110 USA under the Budapest Treaty on Oct. 8, 2013. This strain has also been deposited with the International Despositary Authority of Canada located at 1015 Arlington Street Winnipeg, Manitoba Canada R3E,3R2 on Oct. 9, 2013 and has been assigned (provisional) Accession No. 091013-01.

The following examples are given for purely illustrative and non-limiting purposes of the present invention.

### EXAMPLES

### Example 1

### Selection of Streptomyces microflavus NRRL B-50550

Strains were taken from an internal collection of strains and initial screening tests were conducted to determine efficacy of potential candidates strain against two-spotted spider mites (“TSSM”), which are a model organism commonly used to screen for general miticidal activity. Microorganisms were selected initially for properties that favor laboratory or artificial cultivation, such as variants that grow rapidly on an agar plate. Culture stocks of the selected strains were grown in suitable media for the respective strain, such as the Medium 1 and Medium 2 described in Example 2. The resulting fermentation products (whole broths) were diluted to a 25% solution using water and 0.03% of the surfactant BREAK-THRU FIRST CHOICE® polyether-polymethylsiloxane-copolymer. Thereafter, 8 mL of the diluted fermentation products were applied to run-off to the top and bottom of lima bean leaves of two plants (the lima bean plants were 1 to 1.5 weeks old). After such treatment, plants were infested on the same day with 50-100 TSSM and left in the greenhouse for five days. On the fifth day plants were assessed for presence of mites and eggs on a scale of 1 to 4. The miticide AVID® (abamectin, Syngenta) was used as positive control. For mites and eggs, 1 indicates 100% mortality, 1.5 indicates 90% to 95% mortality, 2.0 represents 75% to 90% mortality; 2.5 represents 40% to 55% mortality; 3.0 represents 20% to 35% mortality and 4.0 represents 0% to 10% mortality. Besides NRRL B-50550, other Streptomcyes strains and some Bacillus strains were found to be active against mites.

For further selection, amongst other activities, the UV stability and translaminar activity of the screened strains was examined since an acaracide should be stable to UV light and possess translaminar activity in order to be effective in field applications.

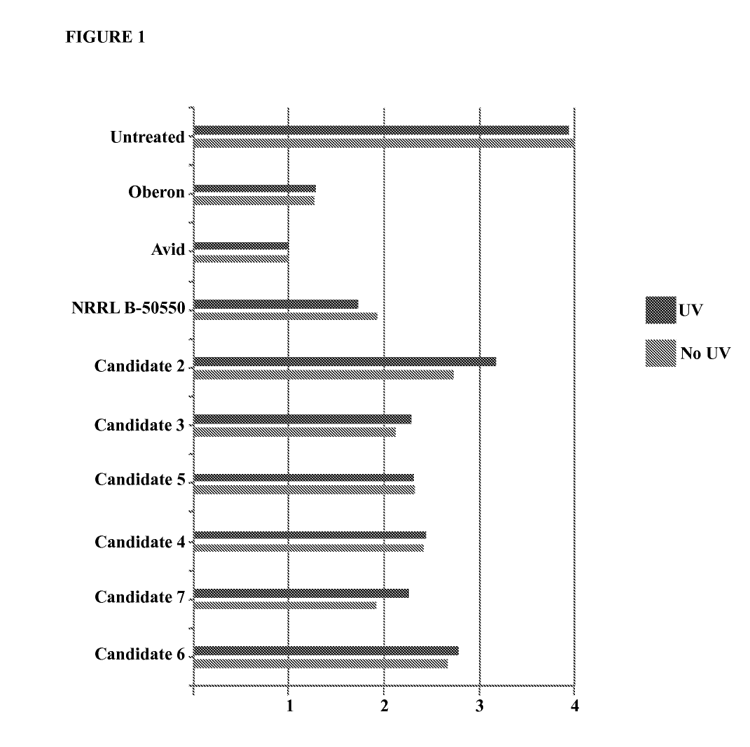

For assessment of the UV stability the above-described 25% dilutions of the fermentation products were sprayed on the upper surface of lima bean plants. After such treatment, plants were infested on the same day with 50-100 TSSM, exposed to UV light for 24 hrs and left in the greenhouse for five days. The mites were confined to the adaxial (upper) surface of the leaves by means of a Vaseline ring which was applied to the leaf and served as an impassable boundary to the mites. On the fifth day plants were assessed for presence of mites and eggs on a scale of 1 to 4, as described above. The miticides AVID° (abamectin, Syngenta) and OBERON° (spiromesifen, Bayer CropScience AG) were used as controls. Results are shown in FIG. 1. The fermentation product of the strain NRRL B-50550 showed the best UV stability of all strains tested.

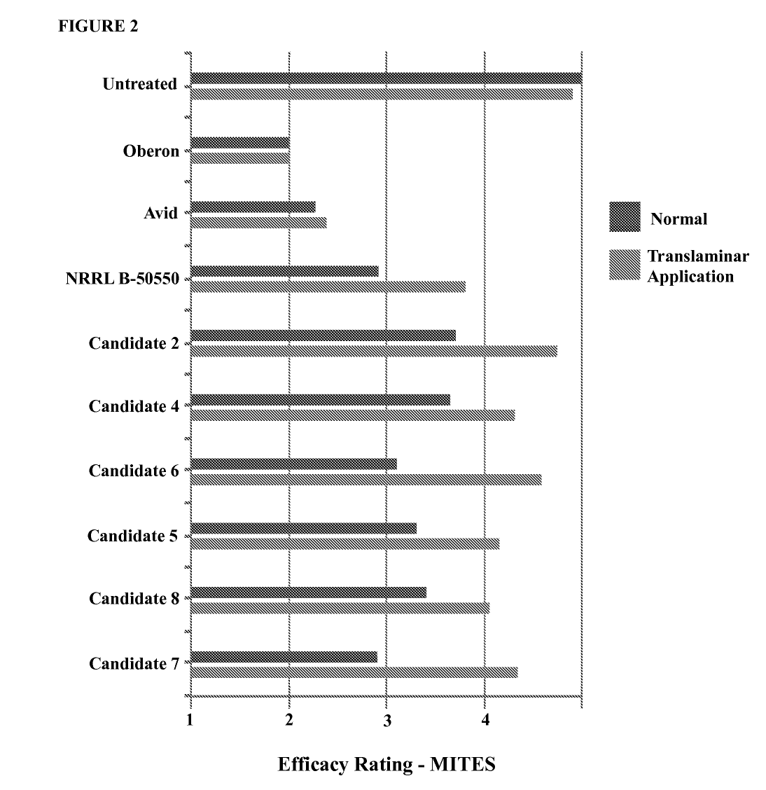

For assessment of the translaminar activity the strains were cultured as described above and the resulting whole broth was diluted using water and 0.35% surfactant and applied to run-off to the lower surface of lima bean leaves on two plants. The upper surface of the treated leaves was infested one day after treatment with 50-100 TSSM, which were placed on the upper surface of the leaves and contained using a Vaseline ring/physical barrier as described above. On the sixth day plants were assessed for presence of mites and eggs on the above-described scale of 1 to 4. The miticides AVID° (abamectin, Syngenta) and OBERON° (spiromesifen, Bayer CropScience AG) were used as controls. Results are shown in FIG. 2. The fermentation product of the strain NRRL B-50550 showed the best translaminar activity of all strains tested.

### Example 2

### Activity Against Spider Mites

Further tests were conducted to more closely determine the efficacy of Streptomyces microflavus NRRL B-50550 against two-spotted spider mites (“TSSM”). Culture stocks of Streptomyces microflavus NRRL B-50550 were grown in 1 L shake flasks in Medium 1 or Medium 2 at 28° C. for 5 days. Medium 1 was composed of 2.0% starch, 1.0% dextrose, 0.5% yeast extract, 0.5% casein hydrolysate and 0.1% CaCO₃. Medium 2 was composed of 2% ProFlo cotton seed meal, 2% malt extract, 0.6% KH₂PO₄ and 0.48% K₂HPO₄. The resulting fermentation products were diluted to a 25% solution using water and 0.03% surfactant BREAK-THRU FIRST CHOICE® (polyether-polymethylsiloxane-copolymer), and 6 mL were applied to run-off to the top and bottom of lima bean leaves of two plants. After such treatment, plants were infested on the same day with 50-100 TSSM and left in the greenhouse for five days. On the sixth day plants were assessed for presence of mites and eggs on a scale of 1 to 4. The miticide AVID® (abamectin, Syngenta) was used as positive control. For mites and eggs, 1 indicates 100% mortality, 1.5 indicates 90% to 95% mortality, 2.0 represents 75% to 90% mortality; 2.5 represents 40% to 55% mortality; 3.0 represents 20% to 35% mortality and 4.0 represents 0% to 10% mortality. Results are shown in Table 3 below. Both fermentation products of Streptomyces microflavus NRRL B-50550 resulted in a mortality of mites of 90% or greater.

TABLE 3

| Fermentation Product | Mites | Eggs |
|---|---|---|
| NRRL B-50550 Medium 1 | 1.25 | 1.00 |
| NRRL B-50550 Medium 2 | 1.50 | 1.50 |
| Positive Control (AVID ® abamectin, EC - 5.7 ppm) | 1.00 | 1.00 |
| Untreated Control | 3.75 | 4.00 |

Field trials against Pacific spider mite in almond, Pacific spider mite in grapes, and two-spotted spider mite in strawberry, confirmed the above greenhouse results. Results of field trials against Pacific spider mite in almonds are reported in Tables 4-6, below. The miticide AGRI-MEK® (abamectin, Syngenta) was used as positive control. Shake flasks containing Medium 1 were inoculated with frozen cultures of NRRL B-50550 and grown 1-2 days at 28-30° C. The resulting fermentation product was used to seed a 20 L bioreactor containing the following media: 6.0% starch, 3.0% dextrose, 1.5% yeast extract and 1.5% casein hydrolysate and 0.3% calcium carbonate. This medium was fermented at between 28° C. for 7 days. The resulting whole broth was used to create a freeze dried powder (“FDP”) that was mixed with an adjuvant, BREAK-THRU FIRST CHOICE® (polyether-polymethylsiloxane-copolymer), at 0.03% and then used in the trial.

TABLE 4
Activity Against Adult Mites

| No. Adult Mites/Leaf | 0 DAT | 3 DAT | 7 DAT | 14 DAT |
|---|---|---|---|---|
| Untreated | 9.3 | 8.8 | 10.5 | 5.8 |
| NRRL B-50550 FDP 0.63 lb/acre | 15.0 | 0.8 | 0.0 | 0.0 |
| NRRL B-50550 FDP1.25 lb/acre | 13.5 | 1.3 | 0.8 | 0.3 |
| NRRL B-50550 FDP 2.5 lb/acre | 15.0 | 0.8 | 0.0 | 0.0 |
| NRRL B-50550 FDP 5 lb/acre | 16.8 | 0.0 | 0.3 | 0.0 |
| Standard (AGRI-MEK ® | 7.0 | 0.0 | 0.0 | 0.0 |
| abamectin 0.15 EC at | | | | |
| 16 fl. oz./acre) | | | | |

TABLE 5
Activity Against Juvenile Mites

| No. Juvenile Mites/Leaf | 0 DAT | 3 DAT | 7 DAT | 14 DAT |
|---|---|---|---|---|
| Untreated | 23.8 | 24.3 | 29.8 | 12.5 |
| NRRL B-50550 FDP 0.63 lb/acre | 43.0 | 3.0 | 1.8 | 0.0 |
| NRRL B-50550 FDP 1.25 lb/acre | 31.5 | 2.0 | 1.3 | 0.0 |
| NRRL B-50550 FDP 2.5 lb/acre | 41.8 | 2.0 | 0.8 | 0.0 |
| NRRL B-50550 FDP 5 lb/acre | 39.3 | 0.8 | 0.3 | 0.0 |
| Standard (AGRI-MEK ® | 37.5 | 0.5 | 1.0 | 0.3 |
| abamectin 0.15 EC at | | | | |
| 16 fl. oz./acre) | | | | |

TABLE 6
Activity against Mite Eggs

| No. Mite Eggs/Leaf | 0 DAT | 3 DAT | 7 DAT | 14 DAT |
|---|---|---|---|---|
| Untreated | 26.8 | 21.0 | 19.8 | 9.5 |
| NRRL B-50550 FDP 0.63 lb/acre | 23.5 | 4.8 | 5.5 | 0.0 |
| NRRL B-50550 FDP 1.25 lb/acre | 16.3 | 3.0 | 2.3 | 0.5 |
| NRRL B-50550 FDP 2.5 lb/acre | 29.0 | 3.3 | 2.8 | 0.0 |
| NRRL B-50550 FDP 5 lb/acre | 33.8 | 5.0 | 3.3 | 0.8 |
| Standard (AGRI-MEK ® | 22.3 | 5.8 | 1.3 | 0.3 |
| abamectin 0.15 EC at | | | | |
| 16 fl. oz./acre) | | | | |

### Example 3

### Field Activity Against Citrus Mite

Field trials were conducted to determine efficacy of NRRL B-50550 against citrus rust mites (Phyllocoptruta oleivora) on Valencia oranges. Shake flasks containing Medium 1 (see Example 2) were inoculated with frozen cultures of NRRL B-50550 and grown 1-2 days at 20-30° C. This was repeated. The resulting fermentation product was used to seed a 20 L bioreactor containing the following media: 6.0% starch, 3.0% dextrose, 1.5% yeast extract, 2.0% soy acid hydrolysate, 0.6% glycine, and 0.2% calcium carbonate. This medium was fermented at between 28° C. for 8 days. The resulting whole broth was used to create a freeze dried powder (“FDP”) used in the following trials. The freeze dried powder was diluted in water and applied at 100 gal/acre at the rates shown in Table 7 below. The miticide ENVIDOR® (spirodiclofen, Bayer CropScience, Germany) was used as positive control. In treatments 1-3, the BREAK-THRU FIRST CHOICE® adjuvant (polyether-polymethylsiloxane-copolymer, see above) was added at 0.66% v/v. The fermentation product applied at a rate of 0.625 lb/A showed a better miticidal activity than ENVIDOR® spirodiclofen applied at a rate of 16-fl oz/A.

TABLE 7

| | | | | No. Mites/ |
|---|---|---|---|---|
| | Treatment | Rate | | cm² Fruit |
| 1. | NRRL B-50550 FDP | 0.625 | lb/A | 0.29 |
| 2. | NRRL B-50550 FDP | 1.25 | lb/A | 1.43 |
| 3. | NRRL B-50550 FDP | 2.5 | lb/A | 0.78 |
| 4. | NRRL B-50550 + 435 Oil | 2.5 lb/A + 5 gal/A | | 0.76 |
| 5. | ENVIDOR ® 2SC (spirodiclofen) | 16 | fl oz/A | 0.41 |

| | | | |
|---|---|---|---|
| 6. | Untreated Check | — | 13.09 |

### Example 4

### Activity Against Other Mites

Studies have shown that NRRL B-50550 is active against various other mites including eriophyid (russet) mites and broad mites. Fermentation broth was prepared as it was for the field trials described in Example 2. The resulting fermentation broth was diluted to various concentrations using water and 0.35% surfactant and 10 mL of the diluted broth applied to run-off to the top and bottom of lima bean leaves on two plants. Plants were infested on the day of treatment and assessed for presence of russet mites on the scale described above 6 days after treatment. A score of four indicated no control and presence of at least 100 russet mites at time of assessment. The miticide AVID® (abamectin) was used as positive control.

TABLE 8

| Treatment | Rating -new leaves | Rating - old leaves |
|---|---|---|
| NRRL B-50550 WB 12.50% | 1.58 | 1.50 |
| NRRL B-50550 WB 6.25% | 1.75 | 1.92 |
| NRRL B-50550 WB 3.12% | 2.42 | 2.67 |
| NRRL B-50550 WB 1.56% | 2.75 | 3.17 |
| Untreated | 4.00 | 4.00 |
| AVID ® (EC) 1% | 1.00 | 1.00 |
| (abamectin) | | |

### Example 5

### Residual Activity

Other studies revealed that NRRL B-50550 has residual activity. Shake flasks containing Medium 1 of Example 2 were inoculated with Luria broth based cultures of NRRL B-50550 (which had been inoculated with a frozen culture of NRRL B-50550) and grown 1-2 days at 28° C. The resulting fermentation product was used to seed a 20 L bioreactor containing the following media: 8.0% dextrose, 1.5% yeast extract, 1.5% casein hydrolysate and 0.1% calcium carbonate. This medium was fermented at between 28° C. for 7-8 days. The resulting fermentation product was diluted to 3.13% solution using water and 0.35% surfactant, and 8 mL of the diluted broth were applied to run-off to the top and bottom of lima bean leaves on two plants. Plants were infested six days after such treatment with 50-100 TSSM and assessed for presence of mites and eggs on the scale described above 12 days after treatment. The miticide AVID® (abamectin) was used as positive control. Results are shown in Table 9 below.

TABLE 9

| Fermentation Product | Mites | Eggs |
|---|---|---|
| NRRL B-50550 WB 3.13% | 1.12 | 1.31 |
| Positive Control (AVID ® - abamectin 0.4 μL/10 mL) | 1.00 | 1.00 |
| Untreated Control | 4.00 | 4.00 |

Beyond the effects on mites initially exposed to treated plants, the effects on mites that might migrate onto treated leaves at later time points was also evaluated. All plants were treated on day zero with either 6.25% or 1.56% whole broth produced in a manner similar to that described in Example 13. Then, mites were added to groups of plants at one-week intervals after treatment. This set of treatments included other miticides for comparison. Mites were added for each of five weeks after treatment. Activity was maintained over the five week period and the rate of activity decrease was similar to the OBERON® (spiromesifen) product and slightly greater than the AVID® product. This study also showed that when the primary leaves of lima bean plants were treated, leaves that emerged later were not protected.

### Example 6

### Translaminar Activity

Studies were conducted to determine whether NRRL B-50550 has translaminar activity. Whole broth was prepared as described in Example 5. The resulting whole broth was diluted using water and 0.35% surfactant, and 10 mL of the diluted broth were applied to run-off to the lower surface of lima bean leaves on two plants. The upper surface of the treated leaves was infested one day after treatment with 50-100 TSSM, which were placed on the upper surface of the leaves and contained using a Vaseline ring/physical barrier placed on the upper surface of the leaves. Plants were assessed for presence of mites and eggs on the scale described above five days after treatment. Results are shown in Table 10 below.

TABLE 10

| Treatment | Mites | Eggs |
|---|---|---|
| NRRL B-50550 WB 12.5% | 1.00 | 1.19 |
| NRRL B-50550 WB 6.25% | 1.51 | 1.73 |
| NRRL B-50550 WB 3.12% | 2.50 | 2.44 |
| NRRL B-50550 WB 1.56% | 2.12 | 2.19 |
| Positive Control AVID ® - abamectin 0.8 μL/10 mL) | 1.46 | 1.30 |
| Untreated Control | 3.50 | 3.62 |

### Example 7

### Ovicidal Activity

NRRL B-50550 was tested for ovicidal activity as follows. Whole broth was prepared as described in Example 5. Two lima bean plants were preinfested with TSSM eggs by allowing adult female mites to oviposit on the leaf surface for 48 hours prior to treatment. Plants were then treated with 8 mL of various dilutions of whole broth. Plants were assessed five days after treatment. The number of live and dead eggs present in each treatment and control are shown in Table 11 below.

TABLE 11

| Treatment | Live Eggs | Dead Eggs |
|---|---|---|
| NRRL B-50550 (6.25%) | 1.00 | 32.75 |
| NRRL B-50550 (3.12%) | 0.50 | 18.25 |
| NRRL B-50550 (1.56%) | 1.00 | 20.50 |
| Positive Control | 1.50 | 75.00 |
| (OBERON ® SC - spiromesifen 4 fl oz/100 gal) | | |
| Untreated Control | 24.00 | 2.00 |

### Example 8

### Drench Activity

Drench activity of NRRL B-50550 was studied using lima beans grown in sand. Whole broth was prepared as described in Example 3. Two applications of 10 mL each of a 12.5% dilution of whole broth were applied to the sand. Plants were watered carefully to prevent leaching of whole broth from the bottom of the pot. Applications were made at four days after planting and at five days after planting. Lower leaves were infested with motile TSSM three days after treatment two. The upper leaf trifoliate was infested nine days after lower leaves were infested. Assessments were made on lower leaves at 4, 5, 8 and 11 days after infestation. Assessments on upper leaves were conducted at two days after infestation. Results, based on the scoring system described in Example 2, are shown in Table 12 below.

TABLE 12

| | | | % Upper |
|---|---|---|---|
| | | | Leaf |
| | | | Surface |
| | Mites | Eggs | Stippled |
| NRRL B-50550 - 1st Assessment | 1.83 | 1.43 | 7.00 |
| [Lower Leaves] | | | |
| NRRL B-50550 - 2^{nd} Assessment | 1.33 | 1.5 | 5.00 |
| [Lower Leaves] | | | |
| NRRL B-50550 - 3^{rd} Assessment | 1.05 | 1.05 | 2.75 |
| [Lower Leaves] | | | |
| NRRL B-50550 - 4^{th} Assessment | 1.83 | 1.38 | 4.5 |
| [Lower Leaves] | | | |
| NRRL B-50550 - 1^{st} Assessment | 1.93 | 1.43 | 4.25 |
| [Upper Leaves] | | | |
| Untreated Control - 1^{st} Assessment | 3.63 | 3.45 | 23.8 |
| [Lower Leaves] | | | |
| Untreated Control -2^{nd} Assessment | 3.88 | 4 | 25 |
| [Lower Leaves] | | | |
| Untreated Control - 3^{rd} Assessment | 4 | 4 | 52.5 |
| [Lower Leaves] | | | |
| Untreated Control - 4^{th} Assessment | 4 | 4 | 80 |
| [Lower Leaves] | | | |
| Untreated Control - 1^{st} Assessment | 4 | 4 | 77.5 |
| [Upper Leaves] | | | |

### Example 9

### Activity Against Fungal Phytopathogens

NRRL B-50550 was tested for activity against various plant fungal pathogens. It was found to be active against both wheat leaf rust and cucumber powdery mildew. Shake flasks containing Medium 1 were inoculated with frozen cultures of NRRL B-50550 and grown 1-2 days at 20-30° C. The resulting fermentation product was used to seed a 20 L bioreactor containing similar media and grown 1-2 days at 28° C. The resulting fermentation product was, in turn, used to seed a 200 L fermentor containing the following media: 7.0% starch, 3.0% dextrose, 1.5% yeast extract, 2.0% soy acid hydrolysate, 0.8% glycine, and 0.2% calcium carbonate. This medium was fermented at between 26° C. for 8 days. Six-day old wheat seedlings were treated with NRRL-50550 whole broth prepared at various dilutions in distilled water with 0.03% adjuvant (BREAK-THRU FIRST CHOICE® polyether-polymethylsiloxane-copolymer) shown in Table 13 below by covering both leaf surfaces with whole broth and allowing to dry. Seedlings were inoculated with a wheat leaf rust suspension one day after such treatment. Plants were rated about a week after treatment using the following scale on a 0-100% control, where 0% is no control and 100% is perfect control.

TABLE 13

| Treatment | Rate | Control |
|---|---|---|
| NRRL B-50550 WB | 20% | 98.7 |
| NRRL B-50550 WB | 5% | 95.0 |
| NRRL B-50550 WB | 1.25% | 50.0 |
| NRRL B-50550 WB | 0.3125% | 0.0 |
| NRRL B-50550 Supernatant | 20% | 95.0 |
| NRRL B-50550 Supernatant | 5% | 66.7 |
| NRRL B-50550 Supernatant | 1.25% | 0.0 |
| NRRL B-50550 Supernatant | 0.3125% | 0.0 |
| NRRL B -50550 Cell Extract | 20% | 50.0 |
| NRRL B-50550 Cell Extract | 5% | 50.0 |
| NRRL B-50550 Cell Extract | 1.25% | 0.0 |
| NRRL B-50550 Cell Extract | 0.3125% | 0.0 |
| Untreated Check | | 0.0 |
| Adjuvant Check | | 0.0 |

In addition, NRRL B-50550 showed activity against cucumber powdery mildew when whole broth was applied on the lower leaf surface and the pathogen was applied on the upper leaf surface.

NRRL B-50550 also showed activity in a curative test against cucumber powdery mildew. Cucumber microplots were inoculated with cucumber powdery mildew at the point when plants had formed a dense canopy over the microplots and natural powdery mildew was just beginning to develop in adjacent plotsreed. Six days post-infection, there was no visible evidence of disease from the inoculation. Freeze-dried powder of NRRL B-50550 was obtained from a fermentation broth prepared in a similar manner to that described in Example 13. Freeze-dried powder was then formulated with inert ingredients (a wetting agent, stabilizer, carrier, flow aid and dispersant) to make a wettable powder. The formulated product comprised 75% by weight freeze-dried powder. Wettable powder was diluted in water and applied at 100 gal/acre at the rates shown in Table 14, below. (Note that 100 gallons per acre translated to a spray volume of 200 mL per microplot.) Ratings were made on the same scale described above.

TABLE 14

| | | |
|---|---|---|
| Plot | Treatment | Rating |

| | | | |
|---|---|---|---|
| NRRL B-50550 75 WP | 3.34 | lb/A/100 gal | 95% |
| NRRL B-50550 75 WP | 1.67 | lb/A/100 gal | 80% |
| NRRL B-50550 75 WP | 1.25 | lb/A/100 gal | 80% |
| NRRL B-50550 75 WP | 0.83 | lb/A/100 gal | 75% |
| Azoxystrobin, QUADRIS | 11 | fl. oz./A/100 gal | 80% |
| Water check | | | 0% |

### Example 10

### Corn Rootworm Activity

Tests were conducted to determine efficacy of NRRL B-50550 against corn rootworm. NRRL B-50550 whole broth was prepared in Medium 1 or Medium 2, as described in Example 2. NRRL B-50550 whole broth was diluted and fed to larvae of western spotted cucumber beetle (Diabrotica undecimpunctata) in a diet-based assay conducted in a microtiter plate. Activity was assessed and rated on a scale of 1 to 4, as described in Example 2. The termiticide/insecticide TERMIDOR® SC (5-amino-1-(2,6-dichloro-4(trifluoromethyl)phenyl)-4-((1,R,S)-(trifluoromethyl)sulfinyl)-1-H-pyrazole-3-carbonitrile, commonly known as fipronil BASF) was used as positive control. Results are shown in Table 15. NRRL B-50550 showed the same insecticidal activity as the insecticide TERMIDOR® SC, which contains the active ingredient fipronil.

TABLE 15

| Treatment | Dosage | Rating |
|---|---|---|
| NRRL B-50550 Media 1 | 100% | 1.0 |
| NRRL B-50550 Media 1 | 25% | 1.0 |
| NRRL B-50550 Media 1 | 6.25% | 1.0 |
| NRRL B-50550 Media 1 | 1.56% | 3.75 |
| NRRL B-50550 Media 2 | 100% | 1.0 |
| NRRL B-50550 Media 2 | 25% | 1.0 |
| NRRL B-50550 Media 2 | 6.25% | 1.0 |
| NRRL B-50550 Media 2 | 1.56% | 4.0 |
| TERMIDOR ® SC 8.3 mg/mL | 100.0% | 1.0 |
| TERMIDOR ® SC | 25.0% | 1.0 |
| TERMIDOR ® SC | 1.56% | 3.75 |
| Untreated | | 4.0 |

### Example 11

### Dose/Response Laboratory Assay

A study was conducted to determine the response of TSSM to different doses of NRRL B-50550. Whole broth was prepared as described in Example 5. The resulting whole broth was diluted to the percentages shown in Table 13 below using water and 0.35% surfactant. Water and 0.35% surfactant were used as the control treatment. In two separate trials, the whole broth solutions and a control treatment were applied to run-off to the lower surface of lima bean leaves, with four replicates per dose. Plants were infested one day after such treatment with 50-100 TSSM, and assessed for the presence of mites and eggs on the scale described above five days after treatment. Results are shown in Table 16 below.

TABLE 16

| Percent Whole Broth | Mite Rating | Mortality |
|---|---|---|
| 0.20 | 3.55 | 15% |
| 0.39 | 3.17 | 25% |
| 0.78 | 2.11 | 70% |
| 1.57 | 1.52 | 90% |
| 3.13 | 1.22 | 95% |

At the lowest concentration tested (0.20% whole broth), significant mortality was observed based on the error bars of the treatment compared to the control treatment. It was observed that part of the effect associated with application of NRRL B-50550 is that it causes mites to leave the plant. Thus, even at sublethal doses NRRL B-50550 may reduce the mite population on a plant.

### Example 12

### Activity Against Abamectin-Resistant Spider Mites

A study was performed to determine the activity of NRRL B-50550 against abamectin-resistant spider mites (Tetranychus urticae strain NL), as compared to wild-type spider mites (Tetranychus urticae strain RW). French bean plants were treated with a wettable powder of a fermentation product of NRRL B-50550 prepared as described in the last paragraph of Example 9, at the rates shown in Table 17 below after dilution. Plants were infested one day prior to treatment with 50-100 of either strain NL or RW, and assessed for the presence of mites seven and fourteen days after treatment. Results are shown in Table 17 below.

TABLE 17

| | | 7 days | 14 days | 7 days | 14 days |
|---|---|---|---|---|---|
| | | Resistant | Resistant | Wild Type | Wild Type |
| Treat- | Dosage | Mites (% | Mites (% | Mites (% | Mites (% |
| ment | (ppm) | control) | control) | control) | control) |
| NRRL | 100 | 95 | 95 | 80 | 90 |
| B-50550 | | | | | |
| 75 WP | | | | | |
| NRRL | 20 | 50 | 50 | 30 | 30 |
| B-50550 | | | | | |
| 75 WP | | | | | |
| NRRL | 4 | 0 | 0 | 0 | 0 |
| B-50550 | | | | | |
| 75 WP | | | | | |
| Abamectin | 20 | 99 | 99 | 100 | 100 |
| Abamectin | 4 | 99 | 80 | 100 | 100 |
| Abamectin | 0.8 | 80 | 0 | 100 | 100 |
| Abamectin | 0.16 | 0 | 0 | 99 | 100 |
| Water | | 0 | 0 | 0 | 0 |

### Example 13

### Fermentation Product Containing Increased Levels of Gougerotin—Use of Glycine

Fermentation was conducted to optimize gougerotin production and miticidal activity of NRRL B-50550. A primary seed culture was prepared as described in Example 1 using a media composed of 10.0 g/L starch, 15.0 g/L glucose, 10.0 g/L yeast extract, 10.0 g/L casein hydrolysate (or 10.0 g/L soy peptone) and 2.0 g/L CaCO₃ in 2 L shake flasks at 20-30° C. When there was abundant mycelial growth in the shake flasks, after about 1-2 days, the contents were transferred to fresh media (same as above, with 0.1% antifoam) and grown in a 400 L fermentor at 20-30° C. When there was abundant mycelial growth, after about 20-30 hours, the contents were transferred to a 3000 L fermentor and grown for 160-200 hours at 20-30° C. in media composed of 80.0 g/L (8.0%) Maltodextrin, 30.0 g/L (3.0%) glucose, 15.0 g/L (1.5%) yeast extract, 20.0 g/L (2.0%) soy acid hydrolysate, 10.0 g/L (1.0%) glycine and 2.0 g/L (0.2%) calcium carbonate and 2.0 ml/L antifoam.

TABLE 18
Yield and Normalized Gougerotin Productivity

| | Harvest | Harvest | Total | Target | Normalized |
|---|---|---|---|---|---|
| | Titer | Weight | Gougerotin | Volume | Volumetric |
| | (mg/g) | (kg) | (kg) | (L) | Titer (g/L) |
| First 3000 L | 1.7 | 3397 | 5.78 | 3000 | 1.9 |
| Fermentation | | | | | |
| Second 3000 L | 1.8 | 3511 | 6.33 | 3000 | 2.1 |
| Fermentation | | | | | |

Using the first 3000 L fermentation as an example, the yield of gougerotin in the fermentor is calculated as follows. 3397 kg×1.7 mg/g Fermentation broth=5774.90 g gougerotin=5.78 kg. The initial weight in the fermentor was 3496 kg (3256 kg Medium+240 kg Seed), which resulted in a final volume more than the target volume 3000 L. Since the target volume 3000 L is the basis for calculating the amount of all ingredients in the production medium, the normalized volumetric productivity is: 5774.9 g/3000 L=1.9 g/L. This gougerotin concentration was similar to the 1.8 g/L achieved in a 20 L fermentation conducted using the same media as described above, with the final fermentation step and media containing glycine (as amino acid).

Throughout this application, gougerotin levels are detected using analytical HPLC chromatography as described in Examples 16 and 19 below.

### Example 14

### Fermentation Product Containing Increased Levels of Gougerotin—Use of Glutamic Acid

Fermentation was conducted to optimize gougerotin production and miticidal activity of NRRL No. B-50550. A primary seed culture was prepared as described in Example 1 using a media composed of 10.0 g/L starch, 15.0 g/L glucose, 10.0 g/L yeast extract, 10.0 g/L casein hydrolysate (or 10.0 g/L soy peptone) and 2.0 g/L CaCO₃ in 1 L shake flasks at 20-30° C. When there was abundant mycelial growth in the shake flasks, after about 1-2 days, the contents were transferred to fresh media (same as above, with 0.1% antifoam) and grown in 1 L shake flasks at 20-30° C. When there was abundant mycelial growth, after about 20-30 hours, the contents were transferred to a 20 L fermentor and grown for 160-200 hours at 20-30° C. in media composed of 60.0 g/L (8.0%) starch, 30.0 g/L (3.0%) dextrose, 15.0 g/L (1.5%) yeast extract, 20.0 g/L (2.0%) soy acid hydrolysate, 12.0 g/L (1.0%) L-glutamic acid and 2.0 g/L (0.2%) calcium carbonate and 2.0 mL/L antifoam.

This gougerotin concentration using L-glutamic acid as amino acid in this fermentation was 1.1 g/L.

### Example 15

### Fermentation Product Containing Increased Levels of Gougerotin—Use of Nucleotides

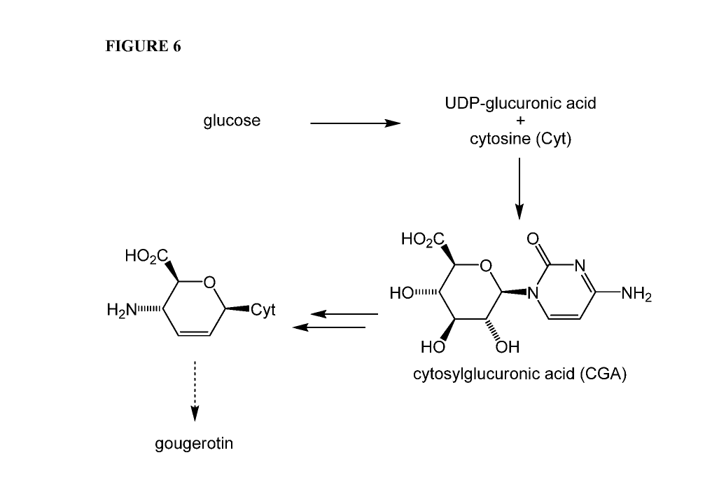

Without wishing to be bound by theory, Applicant postulates that the availability of cytosine is critical to the production of gougerotin, as shown by the hypothetical synthetic pathway of FIG. 6. Thus, with increasing levels of cytosine provided in a culture medium, the amount of gougerotin obtained should also increase. Applicant tested gougerotin production by Streptomyces microflavus B-50550 in media to which cytosine, thymine and/or uracil were added. Specifically, Streptomyces microflavus B-50550 was grown in a media composed of 20.0 g/L maltodextrin, 10.0 g/L glucose, 5.0 g/L yeast extract, 6.0 g/L soy protein acid hydrolysate, 2.0 g/L glycine, 1.0 g/L CaCO₃ and cytosine, uracil and/or thymine, each at a concentration of 0 or 0.50 g/L, in 2 L shake flasks at 20-30° C. for 6 days. Results are shown in Table 19 below.

TABLE 19

| | Cytosine | Uracil | Thymine | Gougerotin at | Gougerotin at |
|---|---|---|---|---|---|
| Run | (g/L) | (g/L) | (g/L) | Day 4 (g/L) | Day 6 (g/L) |
| 1 | 0.50 | 0.50 | 0 | 0.5 | 0.7 |
| 2 | 0.50 | 0 | 0.50 | 0.4 | 0.6 |
| 3 | 0.50 | 0.50 | 0.50 | 0.4 | 0.6 |
| 4 | 0 | 0.50 | 0.50 | 0.4 | 0.5 |
| 5 | 0.50 | 0 | 0 | 0.5 | 0.7 |
| 6 | 0 | 0.50 | 0 | 0.4 | 0.6 |
| 7 | 0 | 0 | 0.50 | 0.3 | 0.4 |
| 8 | 0 | 0 | 0 | 0.4 | 0.4 |

### Example 16

### Gougerotin-Overproducing Mutants

With the goal of increasing gougerotin production and bioactivity, mutants were created from the parent strain Streptomyces microflavus NRRL No. B-50550 through an antibiotic-resistant mutant screening program in which libraries of mutants resistant to individual antibiotics (gentamicin, rifampicin, streptomycin, paromomycin or tobramycin) were produced. See, Okamoto-Hosoya, Y., et al., The Journal of Antibiotics 43(12) December 2000. The parent strain was subjected to mutagenesis using N-methyl-N′-nitro-N-nitrosoguanidine (“NTG”) and then resulting antibiotic resistant mutants selected and screened. A detailed description of creation and screening of mutant libraries from which gougerotin-overproducing strains were selected for further development is described below.

Spore suspensions of Streptomyces microflavus B-50550 were prepared from soy flour maltose (SFM) agar plates containing B-50550 grown for approximately 14 days or to sporulation and stored at −80° C. in 20% glycerol. NTG, dissolved in suitable buffer, was added to the spore suspensions in an amount suitable to obtain 50% kill (0.5 mg/mL at pH 8.5 slowly shaken for 1 hour at 37° C.). NTG-treated spore suspensions were then plated onto GYM (glucose 4 g/L, yeast extract 4 g/L, malt extract 10 g/L, and agar 12 g/L) supplemented with the following concentrations of antibiotics. See Table 20 below.

TABLE 20

| ANTIBIOTIC | 1x | | 2x | | 5x | | 10x | 20x | |
|---|---|---|---|---|---|---|---|---|---|
| Streptomycin SO₄ | 10 | mg/L | 20 | mg/L | 50 | mg/L | 100 mg/L | 200 | mg/L |
| Rifampicin (Fresh) | 3.5 | mg/L | 7 | mg/L | 17.5 | mg/L | 35 mg/L | 70 | mg/L |
| Paromomycin SO₄ | 1 | mg/L | 2 | mg/L | 5 | mg/L | 10 mg/L | 20 | mg/L |
| Tobramycin SO₄ | 4.5 | mg/L | 9 | mg/L | 22.5 | mg/L | 45 mg/L | 90 | mg/L |
| Gentamycin SO₄ | 5.5 | mg/L | 11 | mg/L | 27.5 | mg/L | 55 mg/L | 110 | mg/L |

See Kieser, T., et al., Practical Streptomyces Genetics, Ch. 5 John Ines Centre Norwich Research Park, England (2000), pp. 99-107. Approximately 350 individual antibiotic-resistant colonies were isolated, purified, and screened as described below.

Each isolate removed from GYM antibiotic plates was re-plated onto SFM agar plates. Agar plugs containing antibiotic-resistant bacteria were used to inoculate 24-well blocks containing 2.5 mL of seed media. Bacteria in these inoculated blocks were grown for 3 days and the resulting culture broth used to inoculate 24-well blocks containing production media. Bacteria in production blocks were grown for seven days at 28° C. Each well in the seed blocks contained Trypticase Soy Broth (TSB) (Per liter of DI H₂O: 17 g Bacto Tryptone (Pancreatic Digest of Casein), 3 g Bacto Soytone (Pancreatic Digest of Soybean Meal), 2.5 g Dextrose, 5 g NaCl, 2.5 g Dipotassium Phosphate) and in the production blocks contained Medium 2 of Example 2 (Proflo 20 g/L, malt extract 20 g/L, KH₂PO₄ monobasic 6 g/L, K₂HPO₄ dibasic 4.8 g/L).

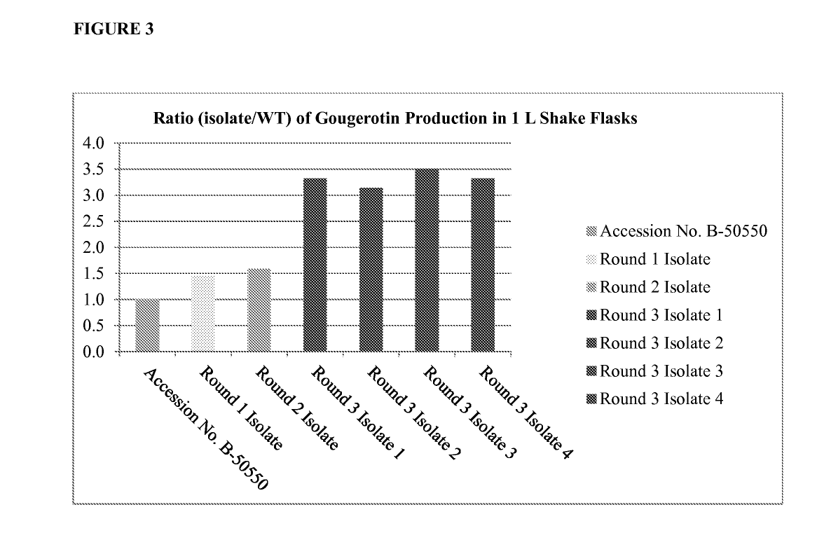

The whole broth from each well of the production block was tested for gougerotin production as follows using analytical HPLC chromatography. 2.4 mL water was added to each well of the production block. Blocks were vortexed and centrifuged. 0.8 mL supernatant was transferred to an extraction block containing 4 mL of water per well. 3.2 mL water was added to the cell pellet in each well of the production block and the block vortexed and centrifuged again. This 3.2 mL of wash water was then added to the appropriate well of each extraction block. The aqueous extracts in the extraction block were then assayed for gougerotin content using analytical HPLC chromatography. Specifically, a sample was injected onto a Cogent Diamond hydride column (100 A, 4 μm, 150×4 6 mm) fitted with a Diamond Hydride guard column. The column was eluted with a 30 minute Acetonitrile/NH₄OAC gradient (see below). The flow rate was 1 mL/min Gougerotin was detected at 254 nm. Gougerotin elutes as a single peak with an approximate retention time of 19 minutes. Top over-producing mutants were confirmed by re-growing in both 24 well blocks and 250 mL flasks to confirm gougerotin levels. Once confirmed some isolates were then subjected to at least one more round of mutagenesis and antibiotic-resistance screening. Each subsequent round of mutagenesis coupled with antibiotic-screening was performed using the remaining antibiotics to which an isolate derived in the previous round had not developed resistance. Small (1.2×) increases in gougerotin production were found after a single round of screening, and subsequent rounds lead to greater increases from isolates generated from the same original low level overproducer, which produced about 0.3 mg/g gougerotin when cultured on a small scale using basic media in these studies. See FIG. 3.

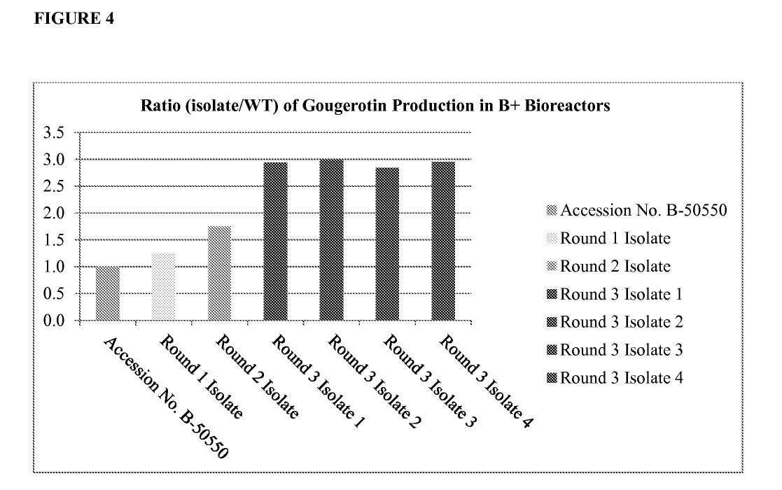

Selected mutants with higher gougerotin production and ability to sporulate on SFM agar plates were grown in 1 L baffled shake flasks and subsequently scaled up to 5 L Sartorius B-plus bioreactors and/or 20 L bioreactors containing Medium 2. See FIG. 4.

The strain designated as Round 3 Isolate 4 in FIGS. 3 and 4 was selected for scale-up according to the process described in Example 13. This strain produced a fermentation broth containing 3.8 mg/g of gougerotin.

### Example 17

### Conversion Rate: Whole Broth to Freeze-Dried Powder

Table 21 shows the conversion rate between whole broth to freeze-dried powder for several lots of whole broth of B-50550 prepared as described in Example 13. These calculations assume that whole broth is converted completely to freeze-dried powder and a density of whole broth of 1 g/mL. (Note that density of fermentation broths before any downstream processing is about 1 g/ml.) The “average %” is the average percentage by weight of freeze dried powder obtained from a certain lot of whole broth.

TABLE 21

| | | | lbs dry | | |
|---|---|---|---|---|---|
| | | | weight | | |
| Lot of | | | freeze-dried | | |
| Whole | | Kg dry | powder | | |
| Broth | Aver- | weight per | (“FDP”) | Gougerotin | Gougerotin |
| (“WB”) | age % | gallon | per gallon | (mg/g) WB | (mg/g) FDP |
| A | 5.93% | 224.47422 | 0.49488135 | 1.7 | 28.7 |
| B | 7.08% | 268.00632 | 0.59085328 | 1.5 | 21.2 |

### Example 18

### Other Streptomyces Strains—Fermentation and Methods for Mite Control

Several strains of Streptomyces were cultivated using similar conditions to those described in Example 13. All strains had a gougerotin biosynthetic gene cluster encoding an amino acid sequence having at least about 90% sequence identity to GouA-M or GouB-M proteins of Streptomyces microflavus strain NRRL B-50550 (e.g., SEQ ID NO: 2, SEQ ID NO: 4, SEQ ID NO: 6, SEQ ID NO: 10, SEQ ID NO: 12, SEQ ID NO: 14, SEQ ID NO: 16, SEQ ID NO: 18, SEQ ID NO: 22, SEQ ID NO: 24, SEQ ID NO: 26, SEQ ID NO: 28, and SEQ ID NO: 30). Strain designations and gougerotin concentrations of fermentation broth prepared according to the method described in Example 13 (but on a smaller scale) are shown in Table 22 below. (For concentration in g/L, assume density of fermentation broth of about 1 g/ml before any downstream processing.)

TABLE 22

| | Gougerotin |
|---|---|
| Strain | Concentration (mg/g) |
| Streptomyces microflavus Strain B | 0.1 |
| Streptomyces puniceus Strain A | 1.0 |
| Streptomyces puniceus Strain B | 0.3 |

A separate experiment was conducted in which the above strains were grown in fermentation media with and without glycine. Addition of glycine doubled gougerotin production for Streptomyces puniceus Strain A but had little effect on gougerotin production for Streptomyces microflavus Strain B or Streptomyces puniceus Strain B.

Fermentation broth of Streptomyces puniceus Strain A was screened using the two spotted spider mite (TSSM) lab assay described above in Example 2 using the above-described whole broth (having about 1.0 mg/g gougerotin) diluted with water and surfactant. Results for Streptomyces puniceus Strain A and Streptomyces microflavus strain NRRL B-50550 are show in Table 23 below.

TABLE 23

| Strain | Percent Whole Broth | Mite Rating |
|---|---|---|
| S. puniceus Strain A | 6.25 | 1.16 |
| S. puniceus Strain A | 3.125 | 1.32 |
| S. puniceus Strain A | 1.5625 | 1.49 |
| NRRL B-50550 | 2.84 | 1.12 |
| NRRL B-50550 | 1.42 | 1.42 |
| NRRL B-50550 | 0.71 | 1.40 |
| Untreated Control | | 3.65 |

### Example 19

### Knocking Out Gougerotin Gene Cluster in NRRL B-50550 to Confirm its Function

Studies were conducted to confirm that the putative gene cluster is responsible for gougerotin expression. Three constructs containing the aminotransferase gene (ORF 4258), similar to the cytosinine synthase of blasticidin, the cytosylglucuronic acid synthase gene (ORF 4261), and a dehydrogenase/hydroxyisobutyrate (ORF 4253), which might be involved in the production of UDP-glucuronic acid plus 300 nucleotides upstream of the coding region were generated from NRRL B-50550 genomic DNA. Without wishing to be bound by theory, Applicant postulates that the aminotransferase gene (ORF 4258) and the cytosylglucuronic acid synthase gene (ORF 4261) are required relatively early in the gougoritin biosynthetic pathway. Because ORF 4258 and ORF 4261 are close to one another in the genome, and also because they are located in the middle of the gene cluster, the dehydrogenase gene (ORF 4253) might be involved in the production of UDP-glucuronic acid. Applicant postulates that this enzyme should also be required early in the pathway.

Bacterial strains and vectors used are shown in Table 24. Primers containing restriction enzyme sites for subcloning the DNA fragments into plasmid vector are provided as SEQ ID NOs: 44-75.

TABLE 24
Bacterial Strains & Vectors

| Name | Usage |
|---|---|
| DH5α | Plasmid amplification |
| ET12356/pUZ8002 | Conjugation helper strain |
| Streptomyces AQ6121 | Host to be knocking out |
| PUC118 | Vector used for cloning |
| pKC1139 | Shuttle Vector used for the cassette build |

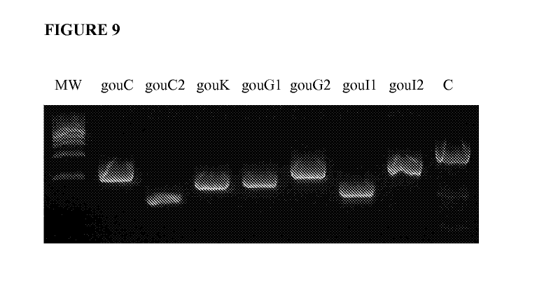

To confirm that the gougerotin gene cluster sequence is correct, seven pairs of primers were designed for PCR and sequence confirmation (SEQ ID NOs: 44-57). DNA extraction of PCR products followed the Qiagen genomic DNA extraction kit protocol. Thermal cycling parameters for genomic DNA and different primer pairs was: 95° C. for 15 minutes, followed by 35 cycles of 95° C. for 1 minute, 58° C. for 1 minute, and 72° C. for 1 minute, and then 72° C. for 10 minutes, with storage at 4° C. The PCR products were resolved by electrophoresis on agarose gels (see FIG. 9), and were also sent for sequence confirmation. The sizes of the PCR products and the sequence results confirmed that the gougerotin gene cluster sequence is correct, and so primers were designed to perform knockout experiments.

### Cassette Construction for Crossover

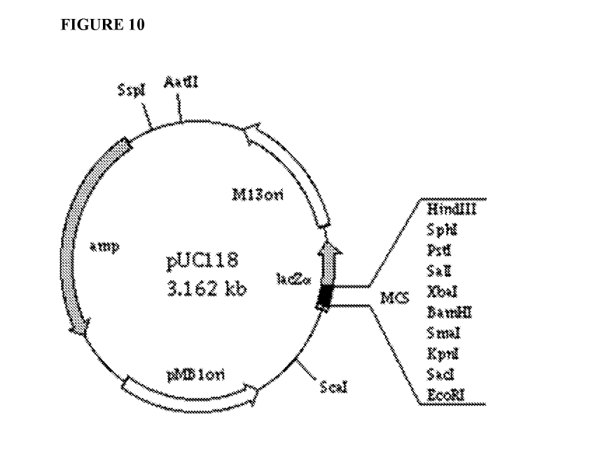

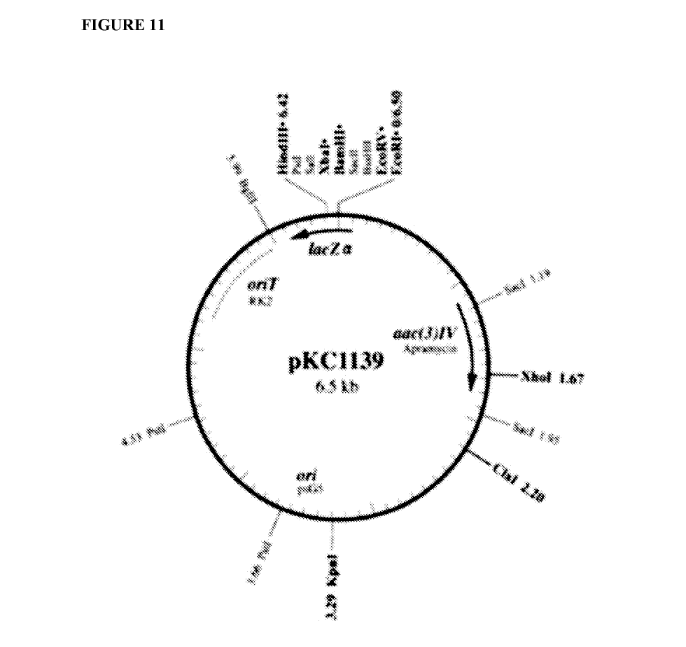

To knock out specific genes, upstream and downstream primers containing specific restriction enzyme sites were designed (see SEQ ID NOs: 60-75). For the gene upstream, forward primers used EcoRI sites (GAATTC) and reverse primers used KpnI sites (GGTACC). For the gene downstream, forward primers used XbaI sites (TCTAGA) and reverse primers used HindIII (AAGCTT) sites. In the middle, a kanamycin resistance gene was added as a selection marker. All constructs were cloned into pUC118 vector (FIG. 10). The cassette containing the kanamycin resistance and knockout gene, up and downstream, was confirmed by sequencing upstream and downstream sequence. The cassette was digested with HindIII and EcoRI, and cloned into pKC1139 shuttle vector (FIG. 11) with kanamycin as selection marker pKC1139::CᵤₚKI_{down}; pKC1139:CᵤₚKW_{down} pKC1139:IᵤₚKI_{down}, pKC1139WᵤₚKW_{down}. After restriction enzyme analysis, PCR, and sequence verification, the cluster was eletroporated into E. coli ET12567 (pUZ8002). Transformants were selected by selection in the presence of apramycin and kanamycin, and confirmed by PCR for the up and down stream primers.

To ensure disruption of the genes, an experiment was designed to perform single-crossover homologous recombination. About 1 kb of HindIII/EcoRI fragment was amplified from genomic DNA and inserted into the HindIII/EcoRI site of pKC1139 to yield pKC1139:C, pKC1139:G, and pKC1139: I.

### Conjugation

The donor for this experiment was a strain of E. coli (ET12567/pUZ8002) containing the knockout cassette on the pKC1139 shuttle vector. Following a modified protocol for plasmid transfer through bacterial conjugation, explained below, the cassette was successfully introduced into NRRL B-50550.

Escherichia coli (strain ET12567) containing plasmid pUZ8002 w/pkc1139:: IᵤₚKI_{down} was streaked onto Luria broth (LB) agar plates and incubated overnight at either 30° C. or 37° C. to obtain single colonies. At least two 50 mL tubes containing 10 mL LB supplemented with 25 μg/mL chloramphenicol Cm, 25 μg/mL kanamycin, and 100 μg/mL apramycin (LB_{Cm25K-Kan25-Apr100}) were inoculated with single colonies. Colonies were allowed to grow overnight (20-24 hours) in a 37° C. shaking incubator. Overnight cultures were diluted 1:100 into 50 mL LB_{Apr100}, then allowed to grow in a 37° C. shaking incubator to an OD₆₀₀ of 0.4-0.6, typically requiring 4-5 hours. Cells were then pelleted at approximately 5000 RCF and 4° C. for 15-20 min. The resulting supernatant was decanted and discarded. Pellets were racked to resuspend and washed twice with LB to remove residual antibiotic. While the pelleted E. coli cells were being washed, sufficient glycerol stock spore prep tubes were thawed to provide cells for each recipient strain/condition to be tested. As streptomyces spores are small and extremely difficult to count, a visually dense preparation was used. Also while washing cells, agar plates were selected and set to dry in a laminar flow hood. For each conjugation, 500 μL spore preparation was mixed with 500 μL 2×YT broth in sterile 2.0 mL microfuge tubes, then heat shocked at 50° C. for approximately 20 minutes (experimentally, heat shock times ranging from 10 minutes to one hour yielded no detectable difference in viability). YT broth is a richer medium than Luria Broth (containing twice as much yeast extract as LB and about 60% more peptone than LB). Mixtures were then cooled to room temperature, after which 500 μL of the pelleted E. coli cells were added to each tube and then mixed thoroughly. Cells were centrifuged at 5000 RCF and room temperature for 5 minutes. Supernatant was decanted. The pelleted cells were resuspended and plated onto the agar plates. Cells were spread using 4-10 twelve-mm glass beads or a Lazy L spreader. Plates were incubated overnight at 30° C. (16-20 hours). For each plate, 5 mg kanamycin and 0.5 mg nalidixic acid (from NaOH stock) was prepared in 1 mL water, then added to the plate with a Lazy L spreader to distribute the solution evenly, which required a few minutes of repeated spreading and air-drying. Plates were then further incubated at 30° C. After 4-6 days of incubation, white kanamycin-resistant colonies were selected for PCR confirmation and gougerotin production assay.

### PCR Confirmation

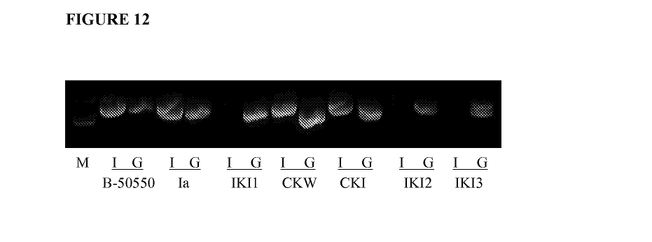

White kanamycin-resistant colonies selected for PCR confirmation were cultured in tryptic soy broth (TSB) medium with kanamycin antibiotic, A ZYGEM kit (from ZyGEM Corporation Ltd. (NZ)) was used for DNA extraction, following the manufacturer's protocol, using 88 μL of culture, 10 μL 10× green buffer, 1 μL prepGEM, and 1 μL lysozyme, with incubation at 37° C. for 15 min, 75° C. for 15 min and 95° C. for 5 mins. Then, PCR was performed with the appropriate primers, and the following cycling parameters: 95° C. for 15 min, followed by 35 cycles of 95° C. for 1 min, 58° C. for 1 min, and 72° C. for 1 min, then 72° C. for 10 min, with storage at 4° C. PCR products were resolved via electrophoresis on a 1% agarose gel (FIG. 12).

pKC1139:1 is a gouI fragment inserted into the pKC1139 shuttle vector, which then integrates into the chromosome by single homologous crossover. This approach resulted in an integrated copy of vector flanked by two mutant alleles of the gene. The PCR results still showed gouI and gouG bands (FIG. 12). The pKC1139:IKI PCR of double crossover did not show gouI PCR product (FIG. 12). While pKC1139:CKW, PCR of gouG product showed smaller molecular weight band, this could be due to partial deletion of the gene.

### Gougerotin Production

Gougerotin production was measured using analytical HPLC chromatography. Briefly, test samples (1.0 g) are transferred to a centrifuge tube and extracted with 3 mL of water. The components are mixed by vortex and ultra-sonication then separated using centrifugation. The supernatant is decanted into a clean flask. This procedure is repeated one additional time, with the supernatant being combined with the previously separated supernatant. The aqueous extract is made to a final volume of 10 mL and assayed for gougerotin content using analytical HPLC chromatography.

The diluted sample is filtered and analyzed by HPLC using a Cogent Diamond hydride column (100 A, 4 μm, 150×4.6 mm) fitted with a Diamond Hydride guard column. The column is eluted with a 30 minute Acetonitrile/NH₄OAC gradient (see below). Flow rate is 1 mL/min Detection of the desired metabolite is made at 254 nm Gougerotin elutes as a single peak with an approximate retention time of 17-19 minutes. Wild-type NRRL B-50550 can produce 0.5 mg/g gougerotin, while if the gouI gene is inactivated, gougerotin production was absent (see Table 25). The single crossover inactivation of gouI and gouG also showed no gougerotin production. Inactivation of the entire gougerotin gene cluster also led to an absence of gougerotin production.

TABLE 25
Gougerotin Production

| | Gougerotin |
|---|---|
| Sample | (mg/g) |
| LKW2 | 0 |
| FKFa | 0 |
| FKF1 | 0 |
| FKF2 | 0 |
| FKF7 | 0 |
| Fb | 0 |
| H4 | 0 |
| B-50550 | 0.5 |

Unless defined otherwise, all technical and scientific terms herein have the same meaning as commonly understood by one of ordinary skill in the art to which this invention belongs. Although any methods and materials, similar or equivalent to those described herein, can be used in the practice or testing of the present invention, the preferred methods and materials are described herein. All publications, patents, and patent publications cited are incorporated by reference herein in their entirety for all purposes.

The publications discussed herein are provided solely for their disclosure prior to the filing date of the present application. Nothing herein is to be construed as an admission that the present invention is not entitled to antedate such publication by virtue of prior invention.

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth and as follows in the scope of the appended claims.

We claim:

1. A composition comprising a biologically pure culture of a phytophagous-miticidal and/or fungicidal Streptomyces microflavus strain NRRL B-50550 or a phytophagous-miticidal and/or fungicidal mutant strain derived therefrom.

2. The composition of claim 1, wherein the mutant strain has translaminar activity.

3. The composition of claim 1, wherein the mutant strain has ovicidal activity.

4. The composition of claim 1, wherein the mutant strain has residual activity.

5. The composition of claim 1, wherein the mutant strain has fungicidal activity.

6. The composition of claim 5, wherein the mutant strain has activity against mildew.

7. The composition of claim 1, wherein the mutant strain has insecticidal activity.

8. The composition of claim 7, wherein the mutant strain has activity against corn rootworm.

9. The composition of claim 1 comprising at least about 1×10⁶ CFU of the strain/mL culture.

10. The composition of claim 1 further comprising a formulation ingredient.

11. The composition of claim 10 wherein the formulation ingredient is a wetting agent.

12. The composition of claim 1 having Spider Mite Potency of at least about 50%.

13. The composition of claim 12 having Spider Mite Potency of at least about 60%.

14. A composition comprising a fermentation product of a miticidal and/or fungicidal Streptomyces microflavus strain NRRL B-50550 or a phytophagous-miticidal and/or fungicidal mutant strain derived therefrom.

15. The composition of claim 14, wherein the fermentation product further comprises a formulation ingredient.

16. The composition of claim 15, wherein the formulation ingredient is a wetting agent.

17. The composition of claim 14 having Spider Mite Potency of at least about 50%.

18. A method of treating a plant to control a plant disease or pest, wherein the method comprises applying the Streptomyces microflavus strain NRRL B-50550 or a phytophagous-miticidal and/or mutant strain derived therefrom, to the plant, to a part of the plant and/or to a locus of the plant.

19. The method of claim 18, wherein the Streptomyces microflavus strain NRRL B-50550 or a phytophagous-miticidal and/or fungicidal mutant strain derived therefrom is applied in a composition comprising the Streptomyces microflavus strain NRRL B-50550 or a phytophagous-miticidal mutant strain derived therefrom.

20. The method of claim 19, wherein the composition is a fermentation product of the Streptomyces microflavus strain NRRL B-50550 or a phytophagous-miticidal mutant strain derived therefrom.

21. The method of claim 19, wherein the method comprises applying the composition to foliar plant parts.

22. The method of claim 19, wherein the pest to be controlled is selected from mite and Diabrotica.

23. The method of claim 22, wherein the mite is selected from the group consisting of clover mite, brown mite, hazelnut spider mite, asparagus spider mite, brown wheat mite, legume mite, oxalis mite, boxwood mite, Texas citrus mite, Oriental red mite, citrus red mite, European red mite, yellow spider mite, fig spider mite, Lewis spider mite, six-spotted spider mite, Willamette mite Yuma spider mite, web-spinning mite, pineapple mite, citrus green mite, honey-locust spider mite, tea red spider mite, southern red mite, avocado brown mite, spruce spider mite, avocado red mite, Banks grass mite, carmine spider mite, desert spider mite, vegetable spider mite, tumid spider mite, strawberry spider mite, two-spotted spider mite, McDaniel mite, Pacific spider mite, hawthorn spider mite, four-spotted spider mite, Schoenei spider mite, Chilean false spider mite, citrus flat mite, privet mite, flat scarlet mite, white-tailed mite, pineapple tarsonemid mite, West Indian sugar cane mite, bulb scale mite, cyclamen mite, broad mite, winter grain mite, red-legged earth mite, filbert big-bud mite, grape erineum mite, pear blister leaf mite, apple leaf edgeroller mite, peach mosaic vector mite, alder bead gall mite, Perian walnut leaf gall mite, pecan leaf edgeroll mite, fig bud mite, olive bud mite, citrus bud mite, litchi erineum mite, wheat curl mite, coconut flower and nut mite, sugar cane blister mite, buffalo grass mite, bermuda grass mite, carrot bud mite, sweet potato leaf gall mite, pomegranate leaf curl mite, ash sprangle gall mite, maple bladder gall mite, alder erineum mite, redberry mite, cotton blister mite, blueberry bud mite, pink tea rust mite, ribbed tea mite, grey citrus mite, sweet potato rust mite, horse chestnut rust mite, citrus rust mite, apple rust mite, grape rust mite, pear rust mite, flat needle sheath pine mite, wild rose bud and fruit mite, dryberry mite, mango rust mite, azalea rust mite, plum rust mite, peach silver mite, apple rust mite, tomato russet mite, pink citrus rust mite, cereal rust mite, rice rust mite and combinations thereof.

24. The method of claim 22, wherein the diabrotica is selected from the group consisting of Banded cucumber beetle (Diabrotica balteata), Northern corn rootworm (Diabrotica barberi), Southern corn rootworm (Diabrotica undecimpunctata howardi), Western cucumber beetle (Diabrotica undecimpunctata tenella), Western spotted cucumber beetle (Diabrotica undecimpunctata undecimpunctata), Western corn rootworm (Diabrotica virgifera virgifera), Mexican corn rootworm (Diabrotica virgifera zeae) and combinations thereof.

25. The method of claim 20, wherein the fermentation product is a freeze-dried powder or a spray-dried powder and wherein the fermentation product is applied at a rate of about 0.625 pounds/acre to about 5 pounds/acre.

26. The method of claim 25 wherein the fermentation product comprises at least about 2% gougerotin by weight.

27. The method of claim 26 wherein the fermentation product comprises at least about 4% gougerotin by weight.

28. The method of claim 23 wherein the mite is an abamectin-resistant mite.

29. The method of claim 19, wherein the plant disease is caused by a fungus.

30. The method of claim 29, wherein the plant disease is mildew or a rust disease.

31. The method of claim 30 wherein the mildew is powdery mildew or downy mildew.

32. The method of claim 30 wherein the rust disease is selected from the group consisting of wheat leaf rust leaf rust caused by Puccinia triticina, leaf rust of barley caused by Puccinia hordei, leaf rust of rye caused by Puccinia recondita, brown leaf rust, crown rust, and stem rust.

33. A fermentation broth of a gougerotin-producing Streptomyces strain, wherein the fermentation broth comprises at least about 1 g/L gougerotin.
